(19) United States
(12) Patent Application Publication
(10) Pub. No.: US 2003/0014379 A1
(43) Pub. Date: Jan. 16, 2003

(54) ADAPTIVE AND RELIABLE SYSTEM AND METHOD FOR OPERATIONS MANAGEMENT

(76) Inventors: ISAAC SAIAS, LOS ALAMOS, NM (US); VINCE DARLEY, SANTA FE, NM (US); STUART A. KAUFFMAN, SANTA FE, NM (US); FRED FEDERSPIEL, SANTA FE, NM (US); JUDITH COHN, SANTA FE, NM (US); BENNETT LEVITAN, PLACITAS, NM (US); ROBERT MACDONALD, SANTA FE, NM (US); WILLIAM MACREADY, SANTA FE, NM (US); CARL TOLLANDER, SANTA FE, NM (US)

Correspondence Address: PENNIE & EDMONDS LLP, 1667 K STREET NW, SUITE 1000, WASHINGTON, DC, 20006

(21) Appl. No.: 09/345,441

(22) Filed: Jul. 1, 1999

(51) Int. Cl. G06F 17/60

(52) U.S. Cl. 706/45

(57) ABSTRACT

The present invention presents a comprehensive system and method for operations management which has the reliability and adaptability to handle failures and changes respectively within the economic environment. The present invention presents a framework of features which include technology graphs, landscape representations and automated markets to achieve the requisite reliability and adaptability.

### FIELD OF THE INVENTION

The present invention relates generally to a reliable and adaptive system and method for operations management. More specifically, the present invention dynamically performs job shop scheduling, supply chain management and organization structure design using technology graphs, landscape representations and automated markets.

### BACKGROUND

An environment includes entities and resources as well as the relations among them. An exemplary environment includes an economy. An economy includes economic agents, goods, and services as well as the relations among them. Economic agents such as firms can produce goods and services in an economy. Operations management includes all aspects of the production of goods and services including supply chain management, job shop scheduling, flow shop management, the design of organization structure, etc.

Firms produce complex goods and services using a chain of activities which can generically be called a process. The activities within the process may be internal to a single firm or span many firms. A firm's supply chain management system strategically controls the supply of materials required by the processes from the supply of renewable resources through manufacture, assembly, and finally to the end customers. See generally, Operations Management, Slack et al., Pitman Publishing, London, 1995. (“Operations Management”).

Other types of entities similarly perform service using processes. As a non-limiting example, military organizations perform logistics within a changing environment to achieve goals such as establishing a beachhead or taking control of a hill in a battlefield.

The activities of the process may be internal to a single firm or span many firms. For those activities which span many firms, the firm's supply chain management system must perform a variety of tasks to control the supply of materials required by the activities within the process. For example, the supply chain management system must negotiate prices, set delivery dates, specify the required quantity of the materials, specify the required quality of the material, etc.

Similarly, the activities of the process may be within one site of a firm or span many sites within a firm. For those activities which span many sites, the firm's supply chain management system must determine the number of sites, the location of the sites with respect to the spacial distribution of customers, and the assignment of activities to sites. This allocation problem is a generalization of the quadratic assignment problem (“QAP”).

For the activities of the process within a site of a firm, the firm's job shop scheduling system assigns activities to machines. Specifically, in the job shop scheduling problem (“JSP”), each machine at the firm performs a set of jobs, each consisting of a certain ordered sequence of transformations from a defined set of transformations, so that there is at most one job running at any instance of time on any machine. The firm's job shop scheduling system attempts to minimize the total completion time called the makespan.

Manufacturing Resource Planning (“MRP”) software systems track the number of parts in a database, monitor inventory levels, and automatically notify the firm when inventory levels run low. MRP software systems also forecast consumer demand. MRP software systems perform production floor scheduling in order to meet the forecasted consumer demand.

Firms must also design an organization structure. The structure for an organization includes a management hierarchy and a distribution of decision making authority to the people within the organization. The structure of a firm effects the propagation of information throughout the firm.

Previous research for supply chain management has studied the effects of demand on the production rate at earlier or upstream operations along the supply chain. Additional research has classified the different relationships which exist in supply chains. This research has classified supply chain relationships as: integrated hierarchy, semi-hierarchy, co-contracting, coordinated contracting, coordinated revenue links, long term trading commitments and short term trading commitments. See Operations Management, Chapter 14.

Previous research for MRP has produced algorithms to compute material volume requirements and to compute timing requirements for those materials using Gantt charts. Other MRP algorithms such as the Optimized Production (OPT) schedule production systems to the pace dictated by the most heavily loaded resources which are identified as bottle-necks. See Operations Management, Chapter 14.

Additional research has attempted to automate the exchange of goods and services among buyers and sellers. For example, U.S. Pat. No. 5,689,652 discloses a method for matching buy and sell orders of financial instruments such as equity securities, futures, derivatives, options, bonds and currencies based upon a satisfaction profile using a crossing network. The satisfaction profiles define the degree of satisfaction associated with trading a particular instrument at varying prices and quantities. The method for matching buy and sell orders inputs satisfaction profiles from buyers and sellers to a central processing location, computes a cross-product of the satisfaction profiles to produce a set of mutual satisfaction profiles, scores the mutual satisfaction profiles, and executes the trades having the highest scores.

U.S. Pat. No. 5,136,501 discloses a matching system for trading financial instruments in which bids are automatically matched against offers for given trading instruments for automatically providing matching transactions in order to complete trades using a host computer. Likewise, U.S. Pat. No. 5,727,165 presents an improved matching system for trading instruments in which the occurrence of automatically confirmed trades is dependent on receipt of match acknowledgment messages by a host computer from all counter parties to the matching trade.

However, previous research on operations management as not adequately accounted for the effect of failures or changes in the economic environment on the operation of the firm. For example, machines and sites could fail or supplies of material could be delayed or interrupted. Accordingly, the firm's supply chain management, job shop scheduling and organization structure must be robust and reliable to account for the effect of failures on the operation of the firm.

Similarly, the economic environment changes with the introduction of new goods and services, new production technologies, new legislation and the extinction of older goods and services. Similarly, changes in the supply and demand for materials also effects the economic environment. For example, the contingent value to buyer and seller of goods or services, the cost of producing the next kilowatt of power for a power generating plant, and the value of the next kilowatt of power to a purchaser effect the economic environment. Accordingly, the firm's supply chain management, job shop scheduling and organization structure must be flexible and adaptive to account for the effect of changes to the firm's economic environment.

Moreover, previous research for automating the exchange of financial instruments have disadvantages. Most important, these methods have a limited application as they do not apply to the general exchange of goods and services among economic agents. Instead, they are focused towards financial transactions. Next, the trades for each of these systems must be processed at a central computing location. Next, these systems do not have real-time support for trader preferences which vary with time.

Accordingly, there exists a need for a comprehensive system and method for operations management which has the reliability and adaptability to handle failures and changes respectively within the environment.

### SUMMARY OF THE INVENTION

The present invention presents a comprehensive system and method for operations management which has the reliability and adaptability to handle failures and changes respectively within the environment. The present invention presents a framework of features which include technology graphs, landscape representations and automated markets to achieve its reliability and adaptability.

It is an aspect of the present invention to present a method for performing operations management in an environment of entities and resources comprising the steps of:

determining at least one relation among at least two of the resources;

performing at least one transformation corresponding to said at least one relation to produce at least one new resource; and

constructing at least one graph representation of said at least one relation and said at least one transformation.

It is a further aspect of the present invention to present a method for exchanging a plurality of resources among a plurality of entities comprising the steps of:

defining a plurality of properties for the resources;

finding at least one match among said properties of the resources to identify a plurality of candidate exchanges; and

selecting at least one exchange from said plurality of candidate exchanges.

It is an aspect of the present invention to present a method for performing operations management for an economic agent acting within an economy of economic agents, goods and services comprising the steps of:

defining a configuration space with L discrete input parameters and an output space with at least one output parameter, wherein L is a natural number and values of said L discrete input parameters define a plurality of input value strings;

defining at least one neighborhood relation for said configuration space as the distance between said input value strings;

generating a plurality of value string pairs for aid at least one input parameter and said at least one output parameter;

generating a fitness landscape representation of he economy of economic agents, goods and services, said generating step comprising the steps of:

defining a covariance function with a plurality of hyper-parameters, said hyper-parameters comprising a degree of correlation along each dimension of said configuration space; and

learning values of said hyper-parameters from said plurality of value string pairs; and

searching for at least one good operations management solution over said landscape representation.

It is a further aspect of the current invention to present a method for performing operations management for an economic agent acting within an economy of economic agents, goods and services comprising the steps of:

creating a discrete landscape representation of the economic agent acting within the economy;

determining a sparse representation of said discrete landscape to identify at least one salient feature of said discrete landscape comprising the steps of:

initializing a basis for said sparse representation;

defining an energy function comprising at least one error term to measure the error of said sparse representation and comprising at least one sparseness term to measure the degree of sparseness of said sparse representation; and

modifying said basis by minimizing said energy function such that said sparse representation has a minimal error and a maximal degree of sparseness; and

selecting at least one optimization algorithm from a set of optimization algorithms by matching said salient features to said set of optimization algorithms; and

executing said selected optimization algorithm to identify at least one good operations management solution over said landscape representation.

It is a further aspect of the current invention to present a method for performing operations management for an economic agent acting within an economy of economic agents, goods and services comprising the steps of:

creating a landscape representation of the economic agent acting within the economy;

characterizing said landscape representation;

determining at least one factor effecting said characterization of said landscape representation;

adjusting said at least one factor to facilitate an identification of at least one acceptable operations management solution over said landscape representation; and

identifying said at least one acceptable operations management solution.

It is a further aspect of the invention to present a method for performing multi-objective optimization comprising the steps of:

creating an n dimensional energy function having a domain and a codomain to define a landscape representation wherein n is a natural number;

sampling said n dimensional energy function at a plurality of points x ε X from the domain to determine a corresponding plurality of sampled energy values from the codomain;

grouping said plurality of sampled energy values into c intervals Iᵢ, i=0 . . . c−1 wherein c is a natural number;

estimating at least one probability density functions P_{I}_{₁} corresponding to said c intervals Iₗ, i=0 . . . c−1 from said plurality of sampled energy values; and

searching for at least one low energy solution having a value from the codomain below a predetermined threshold by extrapolating from said estimated probability density functions P_{I}_{₁}.

It is a further aspect of the invention to present a method for interacting with a computer to perform multi-objective optimization comprising the steps of:

executing an application which includes at least one design entry command to define a plurality of variables and a plurality of objectives and at least one design output command to produce and to display at least one solution;

issuing said at least one design entry command from the application to cause the application to display at least one design window including a plurality of design entry controls;

manipulating said design entry controls on said design window to define said plurality of variables and said plurality of objectives; and

issuing said at least one design output command from the application to cause the application to produce and to display said at least one solution.

### BRIEF DESCRIPTION OF THE DRAWINGS

FIG. 1 provides a diagram showing a framework for the major components of the system and method for operations management.

FIG. 2 displays a diagram showing a composite model of a firm's processes and organizational structure including the relation between the firm's processes and organizational structure.

FIG. 3 shows an exemplary aggregation hierarchy 300 comprising assembly classes and component classes.

FIG. 4a displays a diagram showing the enterprise model.

FIG. 4b displays a diagram of the network explorer model.

FIG. 4c provides one example of a resource with affordances propagating through a resource bus object.

FIG. 5 shows an exemplary technology graph.

FIG. 6 provides a dataflow diagram 600 representing an overview of a method for synthesizing the technology graph.

FIG. 7 provides a flow diagram 700 for locating and selecting poly-functional intermediate objects for a set of terminal objects 701 having a cardinality greater than or equal to two.

FIG. 8 displays a flow diagram of an algorithm to perform landscape synthesis.

FIG. 9 displays a flow diagram of an algorithm to determine the bases vₗ for landscapes.

FIG. 10 shows the flow diagram of an overview of a first technique to identify a firm's regime.

FIG. 11 shows the flow diagram of an algorithm 1100 to move a firm's fitness landscape to a favorable category by adjusting the constraints on the firm's operations management.

FIG. 12a displays a flow graph of an algorithm which uses the Hausdorf dimension to characterize a fitness landscape.

FIG. 12b displays the flow graph representation of an optimization method which converts the optimization problem to density estimation and extrapolation.

FIG. 13a provides a diagram showing the major components of the system for matching service requests with service offers.

FIG. 13b provides a dataflow diagram representing the method for matching service requests with service offers.

FIG. 14 is a flow diagram for a method of using the interface 120 to United Sherpa 100 to perform optimization.

FIG. 15 shows a first sample design entry window.

FIG. 16 shows a first sample solutions display.

FIG. 17 shows a second sample design entry window.

FIG. 18 shows a second sample solutions display.

FIG. 19 shows a sample window for entering constraints.

FIG. 20 shows a first sample design output window having controls for a one-dimensional histogram.

FIG. 21 shows a third sample solutions display window of a one-dimensional histogram.

FIG. 22 shows a second sample design output window having controls for a scatterplot.

FIG. 23 shows a fourth sample solutions display window of a scatterplot.

FIG. 24 shows a third sample design output window having controls for a parallel coordinate plot.

FIG. 25 shows a fifth sample solutions display of a parallel coordinate plot.

FIG. 26 shows a fourth sample design output window having controls for a subset scatterplot.

FIG. 27 shows a sixth sample solutions display of a subset scatterplot.

FIG. 28 shows a simultaneous display of several design entry window and solutions display during execution of the present invention.

FIG. 29 discloses a representative computer system 2910 in conjunction with which the embodiments of the present invention may be implemented.

### DETAILED DESCRIPTION OF THE PREFERRED EMBODIMENT

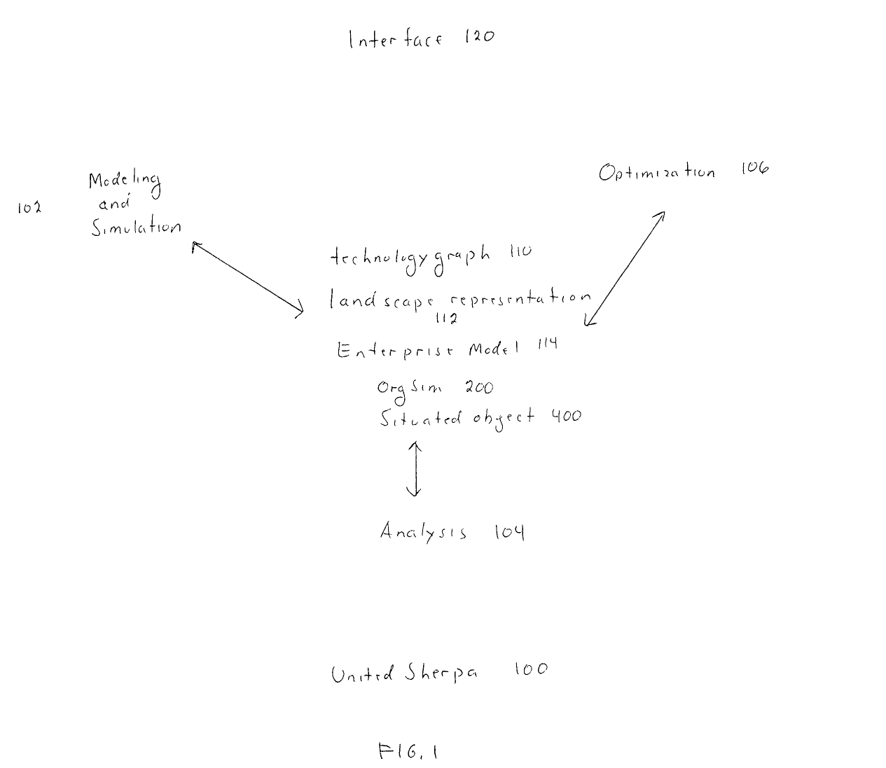

FIG. 1 provides a diagram showing a framework for the major components of the system and method for operations management called United Sherpa 100. The major components of United Sherpa 100 include modeling and simulation 102, analysis 104, and optimization 106. United Sherpa 100 further includes an interface 120. The major components of United Sherpa 100 operate together to perform various aspects of operations management including the production of goods and services including supply chain management, job shop scheduling, flow shop management, the design of organization structure, the identification of new goods and services, the evaluation of goods and services, etc. To accomplish these tasks, the components of United Sherpa 100 create and operate on different data representations including technology graphs 110, landscape representations 112 and the enterprise model 114. An Enterprise model 114 is a model of entities acting within an environment of resources and other entities.

Without limitation, many of the following embodiments of the invention, United Sherpa 100, are described in the illustrative context of the production of goods and services by economic entities acting within an economic environment. However, it will be apparent to persons of ordinary skill in the art that the aspects of the embodiments of the invention are also applicable in any context involving the operation of an entity within an environment of resources and other entities such as the performance of logistics by military organizations acting within a changing battlefield or the evaluation and exchange of financial instruments. These aspects which are applicable in a wide range of contexts include modeling and simulation, analysis, and optimization using technology graphs, landscape representations and automated markets to perform operations management having the reliability and adaptability to handle failures and changes respectively within the economic environment.

Modeling and Simulation

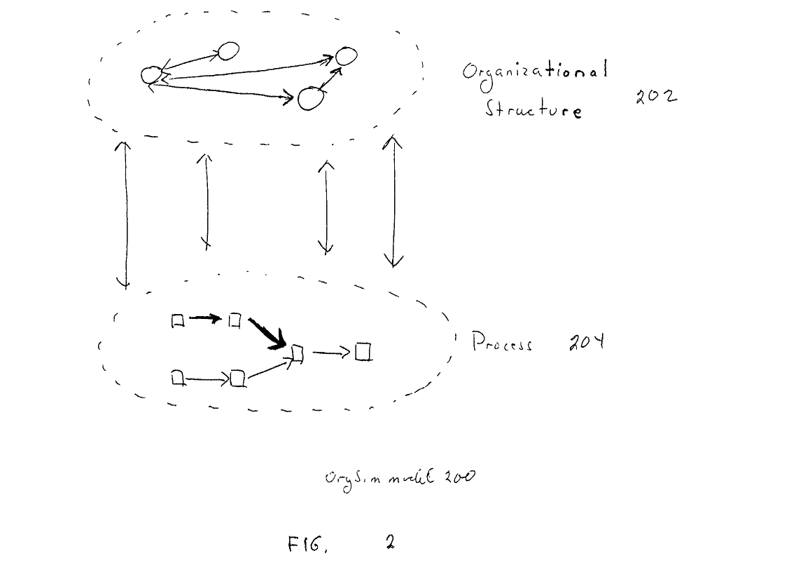

The modeling component 102 of United Sherpa 100 creates the enterprise model 114. An aspect of the modeling component 102 called OrgSim creates organizational structure model 202 and a process model 204 for a firm as shown by an exemplary OrgSim model in FIG. 2. OrgSim represents each decision making unit of a firm with an object.

Without limitation, the following embodiments of the invention, United Sherpa 100, are described in the illustrative context of a solution using object oriented design and graph theory. However, it will be apparent to persons of ordinary skill in the art that other design techniques such as a structured procedural paradigm or an agent-based design could be used to embody the aspects of the present invention which include modeling and simulation, analysis, and optimization using technology graphs, landscape representations and automated markets to perform operations management having the reliability and adaptability to handle failures and changes respectively within the economic environment. Agent-based design is described in, Go to the ant: Engineering Principles from Natural Multi-Agent Systems, H. Van Dyke Parunak, Annals of Operations research 75(1997) 69-101, the contents of which are herein incorporated by reference.

As is known to persons of ordinary skill in the art, objects are distinguishable entities and have attributes and behavior. See Object Oriented Modeling and Design, Rumbaugh, J., Prentice hall, Inc. (1991), Chapter 1. Further, objects having the same attributes and behavior are grouped into a class. In other words, objects are instances of classes. Each class represents a type of decision making unit. The representation of real world entities with objects is described in co-pending U.S. patent application Ser. No. 09/080,040, System and Method for the Synthesis of an Economic Web and the Identification of New Market Niches, the contents of which are herein incorporated by reference.

Decision making units in the organizational structure model 202 represent entities ranging from a single person to a department or division of a firm. In other words, the organizational structure model includes an aggregation hierarchy. As is known in the art, aggregation is a “part-whole” relationship among classes based on a hierarchical relationship in which classes representing components are associated with a class representing an entire assembly. See Object Oriented Modeling and Design, Chapter 3. The aggregation hierarchy of the organizational structure comprise assembly classes and component classes. An aggregation relationship relates an assembly class to one component class. Accordingly, an assembly class having many component classes has many aggregation relationships.

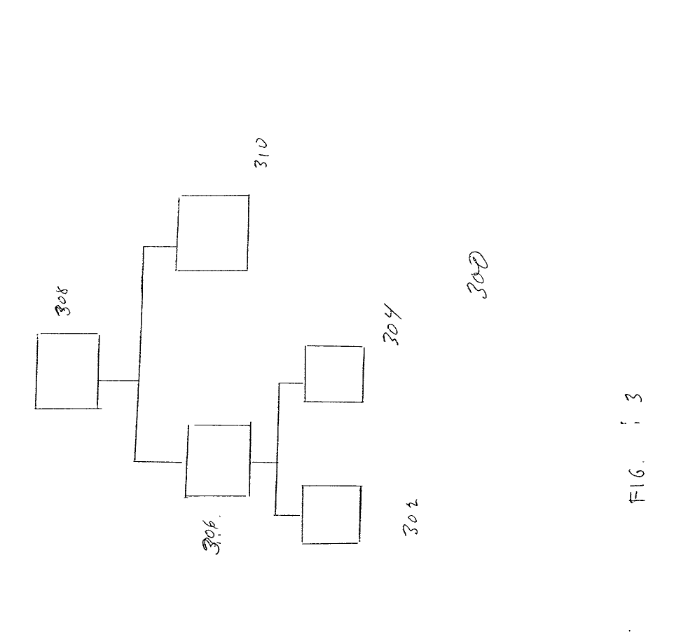

FIG. 3 shows an exemplary aggregation hierarchy 300 comprising assembly classes and component classes. The engineering department 302 is an assembly class of the engineer component class 304 and the manager component class 306. Similarly, the division class 308 is an assembly class of the engineering department component class 302 and the legal department component class 310. Accordingly, this aggregation hierarchy 300 represents a “part-whole” relationship between the various components of a firm.

Moreover, OrgSim can model decision making units at varying degrees of abstraction. For example, OrgSim can represent decision making units as detailed as an individual employee with a particular amount of industrial and educational experience or as abstract asa standard operating procedure. Using this abstract modeling ability, OrgSim can represent a wide range of organizations. Next, OrgSim 102 can also represent the flow of information among the objects in the model representing decision making units. First, OrgSim 102 can represent the structure of the communication network among the decision making units. Second, OrgSim 102 can model the temporal aspect of the information flow among the decision making units. For instance, OrgSim 102 can represent the propagation of information from one decision making unit to another in the firm as instantaneous communication. In contrast, OrgSim 102 can also represent the propagation of information from one decision making unit to another in the firm as communication requiring a finite amount of time.

These modeling aspects enable OrgSim 102 to simulate the effects of organizational structure and delay on the performance of a firm. For example, OrgSim 102 can compare the performance of an organization having a deep, hierarchical structure to the performance of an organization having a flat structure. OrgSim 102 also determines different factors which effect the quality and efficiency of decision making within an organization such as line of sight, authority, timeliness, information contagion, and capacity constraints. Line of sight determines the effects of a proposed decision throughout an organization in both the downstream and upstream directions. Authority determines whether a decision making unit such as an engineer should make a decision or should forward the responsibility to make a decision to a superior. Timeliness determines the effect of a delay which results when a decision making unit forwards the responsibility to make a decision to a superior instead of immediately making the decision and acting on the decision. Information contagion measures the effect on the quality of decision making when the responsibility for making a decision moves in the organization from the unit which will feel the result of the decision. Capacity constraints measures the effect on delay when the responsibility for making a decision moves toward an overworked decision making unit of the organization.

Through simulation, Orgsim 102 determines the effect of these conflicting factors on the quality of decision making of an organization. For example, OrgSim 102 can determine the effect of the experience level of an economic agent on the decision making of an organization. Further, OrgSim 102 can determine the effect of granting more decision making authority to the units in the lower levels of an organization's hierarchy. Granting decision making authority in this fashion may improve the quality of decision making in an organization because it will decrease the amount of information contagion. Granting decision making authority in this fashion may also avoid the detrimental effects of capacity constraints if the units in the top levels of the organization are overworked. However, granting decision making authority in this fashion may decrease the quality of decision making because units in the lower levels of an organization's hierarchy have less line of sight than units at the higher levels.

OrgSim represents each good, service and economic entity associated with a firm's processes with an object in the process model 204. Renewable resources, intermediate goods and services, finished goods and services, and machines are types of goods and services in the economy. Machines are goods or services which perform sequences of transformations on an input bundle of goods and services to produce an output bundle of goods and services. Accordingly, intermediate goods and services are produced when machines execute their transformations on an input bundle of goods and services. Finished goods and services are the end products which are produced for the consumer.

OrgSim includes an interface to enable a user to define the decision making units, the structure of the communication network among the decision making units, the temporal aspect of the information flow among the decision making units, etc. Preferably, the user interface is a graphical user interface.

Preferably, OrgSim provides support for multiple users, interactive modeling of organizational structure and processes, human representation of decision making units and key activities within a process. Specifically, people, instead of programmed objects, can act as decision making units. Support for these additional features conveys at least two important advantages. First, the OrgSim model 200 will yield more accurate results as people enter the simulation to make the modeling more realistic. Second, the OrgSim model 200 further enables hypothetical or what if analysis. Specifically, users could obtain simulation results for various hypothetical or what if organizational structure to detect unforeseen effects such as political influences among the decision making units which a purely computer-based simulation would miss.

Preferably, OrgSim also includes an interface to existing project management models such as Primavera and Microsoft Project and to existing process models such as iThink.

Without limitation, the following embodiments of the Enterprise model 114 are described in the illustrative context of a solution using situated object webs. However, it will be apparent to persons of ordinary skill in the art that other design techniques could be used to embody the aspects of the Enterprise model 114 which include determining relations among the resources in the economy, determining values for the relations, selecting relations having higher values and performing transformations corresponding to the relations to produce new resources in the economy.

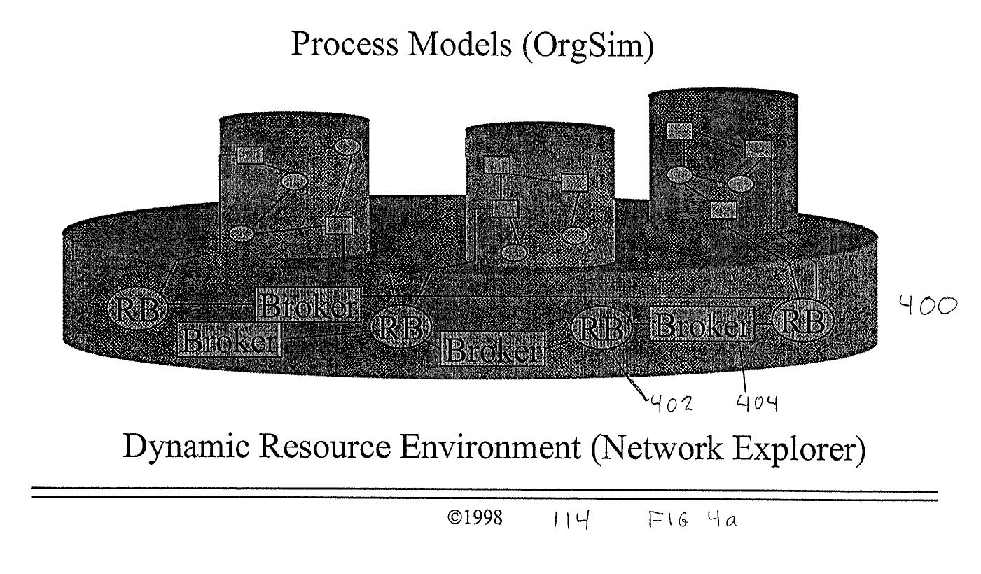

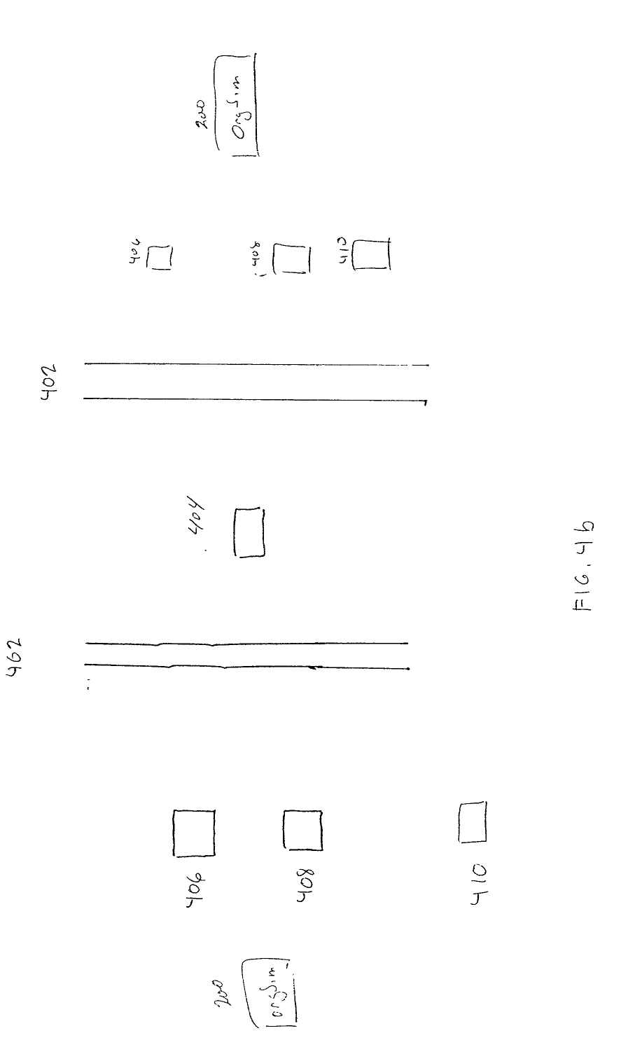

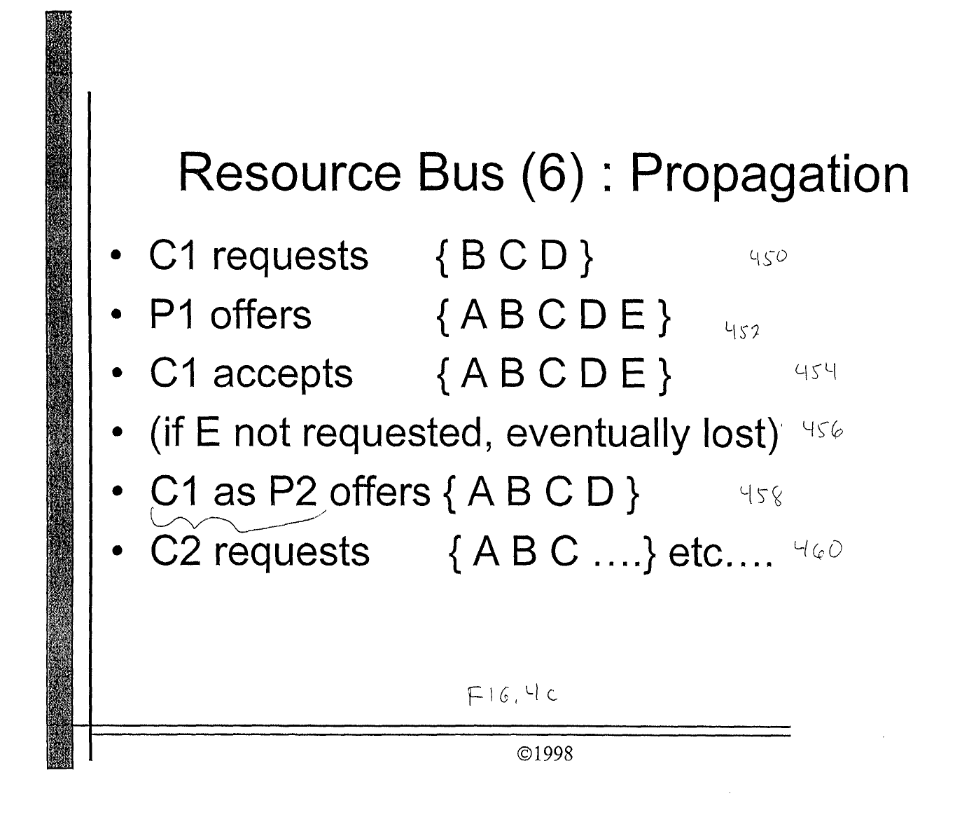

The Enterprise model 114 further includes situated object webs 400 as shown in FIG. 4a. Situated object webs 400 represent overlapping networks of resource dependencies as resources progress through dynamic supply chains. Situated object webs 400 include a resource bus 402. A resource bus 402 is a producer/consumer network of local markets. Preferably, broker agents 404 mediate among the local markets of the resource bus 402.

FIG. 4b shows a detailed illustration of the architecture of the situated object web 400 and the OrgSim model 200. The situated object web 400 includes a RBConsumer object 406. The RBConsumer object 406 posts a resource request to one of the ResourceBus objects 402. The RBConsumer object 406 has a role portion defining the desired roles of the requested resource. Preferably, the RBConsumer object 406 also has a contract portion defining the desired contractual terms for the requested resource. Exemplary contract terms include quantity and delivery constraints. An OrgSim model 200 offers a resource by instantiating an RBProducer object 408. A RBProducer object 408 offers a resource to one of the ResourceBus objects 402. The RBProducer object 408 has a role portion defining the roles of the offered resource. Preferably, the RBProducer object 408 also has a contract portion defining the desired contractual terms for the requested resource.

The ParticipantSupport 310 objects control one or more RBConsumer 302 and RBProducer 308 objects. A ParticipantSupport 310 object can be a member of any number of ResourceBus 304 objects. ParticipantSupport 310 objects join or leave ResourceBus 304 objects. Moreover, ParticipantSupport 310 objects can add RBProducer 308 objects and RBConsumer 302 object to any ResourceBus 304 objects of which it is a member.

Preferably, affordance sets model the roles of resources and the contractual terms. An affordance is an enabler of an activity for a suitably equipped entity in a suitable context. A suitably equipped entity is an economic agent which requests a resource, adds value to the resource, and offers the resulting product into a supply chain. A suitable context is the “inner complements” of other affordances which comprise the resource. Affordances participate in other affordances. Further, an affordance can contain sets of other affordances which are specializations of the affordance. Preferably, the situated object web 400 represents affordances with symbols sets. The symbols set representation scheme is advantageous because it is not position dependent.

Affordances have associated values. For example, a value of an affordance specified by an RBConsumer object 406 for a requested resource for an OrgSim model 200 represents the amount of importance of the affordance to the OrgSim model 200. In other words, the RBConsumer objects 406 specify the amount of importance the affordances or roles of a requested resource to the requesting OrgSim model 400.

The ResourceBus 402 objects relay requested resources and offered resources between RBConsumer objects 406 and RBProducer objects 408. The ResourceBus 402 identifies compatible pairs of requested resources with the offered resources by matching the desired affordances of the requested resource with the affordances of the offered resources. Preferably, the ResourceBus 402 also considers the importance of the affordances when matching the affordances of the requested resources with affordances of the offered resource. The ResourceBus 402 performs a fuzzy equivalency operation to determine the goodness of a match between a requested resource and an offered resource. The goodness of match between a requested resource and an offered resource is determined by performing a summation over the set of roles or affordances wherein the summation is weighted by the importance associated with the affordances and roles. Preferably, the values of the affordances are normalized to the interval [0,1]. Preferably, the goodness of a match is also normalized to the interval [0,1]. Higher values for the goodness of a match indicate more precise matches. Next, more precise matches enhance the economic value of the exchange. A subsequent section titled “Automated Markets”, contains additional techniques for finding optimal matches between requested resources and offered resources.

Preferably, the ResourceBus 402 uses an exemplar-prototype copy mechanism to satisfy resource requests with available resources. The ResourceBus 402 provides a copy of an exemplar resource object to a RBConsumer object 406 requesting a resource. The ResourceBus 402 locates the exemplar resource object in accordance with the importance assigned to the affordances by the RBConsumer object 406. Accordingly, the exemplar prototype copy mechanism adds diversity to the resources in the situated web model 400. The copy of the exemplar resource used by the resource bus 402 adds diversity to the resources propagating through the situated object web 400.

For example, if a consumer object requests a complementary object representing a #10, Phillips head, finishing screw, the situated object model returns an object which could be brass plated and self-tapping with a pan-shaped head. Thus, as long as a subset of the attributes match the requested attributes, the remaining attributes of the object can have arbitrary values. Thus, the objects produced by this scheme have copy errors. The introduction of copy errors leads to diversity in goods and services.

The situated object web 400 further includes BrokerAgent objects 404. BrokerAgent objects 404 mediate between ResourceBus 304 objects. BrokerAgent 306 objects will relay resource requests and availabilities between ResourceBus 304 objects if those requests and availabilities cannot be satisfied on the originating ResourceBus 304 object. A BrokerAgent object 404 monitors traffic in at least two ResourceBus objects 402 for orphan resources. Orphan resources are defined as surplus resources offered by RBProducer objects 408 and unmet resource requests from RBConsumer objects 406. Preferably, BrokerAgent objects 404 add transaction costs to matched pairs of requested resources and offered resources. A BrokerAgent object 404 competes among other BrokerAgent objects 404 to provide service to RBConsumer objects 406 and RBProducer objects 408.

As RBProducer objects 408 fulfill resource requests from RBConsumer objects 406 on the ResourceBus 402, resources and their affordances propagate through the situated web model 400. Further, the values of affordances and the values of the resources containing the affordances change as resources propagate through the situated web model 400. The value of an affordance increases as it is requested by more RBConsumer objects 406. Conversely, the value of an affordance decreases if it is not requested by a RBConsumer object 406. Affordances which are not requested for a sufficiently long time are removed from a resource.

FIG. 4c provides an example of a resource with affordances propagating through a resource bus object 402. In time step 450, a RBConsumer object 406, C1 requests a set of affordances, {B, C, D}. In time step 452, an RBProducer object 408, P1, offers a resource with a set of affordances, {A, B, C, D, E}. In time step 454, RBConsumer object C1 is paired with RBProducer object P1 on a ResourceBus object 402. In other words, RBConsumer object C1 accepts the offered resource with affordances {A, B, C, D, E}. In step 456, affordance E is lost from the set of affordances {A, B, C, D, E} because affordance E was not requested for a predetermined time period and accordingly, was eventually lost. In step 458, C1, acting as a RBProducer object 408, P2 offers the resource with the set of affordances, {A, B, C, D}. In step 460, another RBConsumer object 406, C2 requests a set of affordances, {A, B, C} which creates a possible match with the resource offered by P2 and causes the resource to continue to propagate through a resource bus 402.

Execution of the situated object web 400 as described immediately above creates a model of a firm's processes called a technology graph 110. The next section provides a detailed description of the technology graph 110.

United Sherpa 100 also includes an interface to existing Manufacturing Resource Planning (“MRP”) software systems. MRP systems track the number of parts in a database, monitor inventory levels, and automatically notify the firm when inventory levels run low. The MRP software systems also forecast consumer demand. MRP software systems perform production floor scheduling in order to meet the forecasted consumer demand. Exemplary MRP software systems are available from Manugistics, I2 and SAP.

However, the object oriented approach of the present invention has advantages over MRP or other conventional business modeling tools because the object oriented approach provides a more direct representation of the goods, services, and economic agents which are involved in a firm's processes. Conventional business tools typically build numerical models which describe business operations exclusively in terms of numerical quantities. For example, conventional business tools have numerical models representing how the inventory of material resources vary with time. In contrast, the modeling component 102 of the present invention represents each good, service, and economic agent with an object.

In contrast to numerical models, the object oriented approach of the present invention is also amenable to what if analysis. For example, the modeling component 102 of the present invention can represent the percolating effects of a major snow storm on a particular distribution center by limiting the transportation capacity of the object representing the distribution center. Execution of the simulation aspect of OrgSim 102 on the object model with the modified distribution center object yields greater appreciation of the systematic effects of the interactions among the objects which are involved in a process.

As indicated by the previous discussion of FIGS. 2-4c, the modeling and simulation component 102 of United Sherpa 100 provides a mechanism to situate a dynamically changing world of domain objects by explicitly supporting their emergence. The modeling and simulation component 102 develops metrics to show the emergence and propagation of value for entire resources and affordances of the resource. The modeling and simulation component 102 of United Sherpa 100 represents the resources and economic entities of an economy as situated objects because they depend on the contingencies of other resources and economic entities in the economy which produce them. The situated object web 400 constitutes an adaptive supply chain that changes connectivity as the demand for different situated objects change.

OrgSim 102 also includes an interface to existing models of a firm's processes such as iThink or existing project management models such as Primavera and Microsoft Project.

Technology Graph

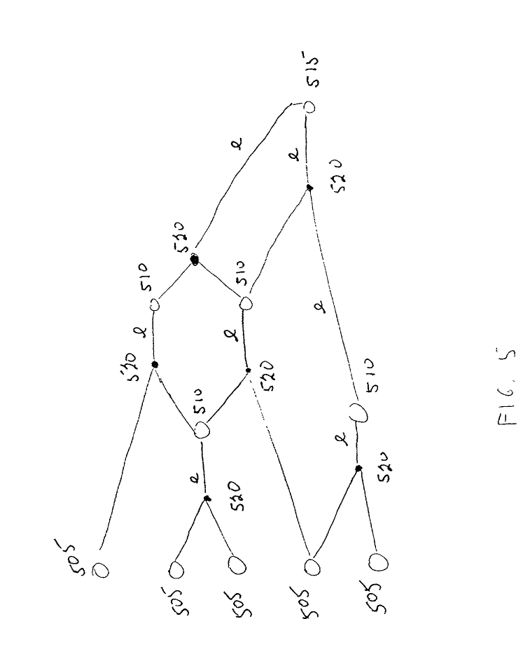

FIG. 5 shows an exemplary technology graph. A technology graph is a model of a firm's processes. More specifically, a technology graph is a multigraph representation of a firm's processes. As previously explained, a firm's processes produce complex goods and services. As is known to persons of ordinary skill in the art, a multigraph is a pair (V,E) where V is a set of vertices, E is a set of hyperedges, and E is a subset of P(V), the power set of V. See Graph Theory, Bela Bollobas, Springer-Verlag, New York, 1979, (“Graph Theory”) Chapter 1. The power set of V is the set of subsets of V. See Introduction to Discrete Structures, Preparata and Yeh, Addison-Wesley Publishing Company, Inc. (1973)(“Introduction to Discrete Structures”), pg 216.

In the technology graph (V,E) of a firm's processes, each vertex v of the set of vertices V represents an object. More formally, there exists a one-to-one correspondence between the set of objects representing the goods, services, and economic agents and the set of vertices V in the technology graph (V,E) of the firm's processes. A function denoted by g: O−>V from the set of objects O representing the goods, services, and economic agents to the set of vertices V in the corresponding multigraph (V,E) assigns the vertex v to an object o (g(o)=v).

In the technology graph (V,E) of a firm's processes, each hyperedge e of the set of hyperedges E represents a transformation as shown by FIG. 5. The outputs of the hyperedge e are defined as the intermediate goods and services 510 or the finished goods and services 515 produced by execution of the transformation represented by the hyperedge e. The outputs of the hyperedge e also include the waste products of the transformation. The inputs of the hyperedge e represent the complementary objects used in the production of the outputs of the hyperedge. Complementary objects are goods or services which are used jointly to produce other goods or services.

Resources 505, intermediate goods and services 510, finished goods and services 515, and machines 520 are types of goods and services in the economy. Machines 520 are goods or services which perform ordered sequences of transformations on an input bundle of goods and services to produce an output bundle of goods and services. Accordingly, intermediate goods and services 510 are produced when machines 520 execute their transformations on an input bundle of goods and services. A machine 520 which mediates transformations is represented in the technology graph H=(V, E) as an input to a hyperedge e. In an alternate embodiment, a machine 520 which mediates transformations is represented as an object which acts on the hyperedge e to execute the transformation. Finished goods and services 515 are the end products which are produced for the consumer.

The objects and transformations among the objects in the technology graph H=(V, E) constitute a generative grammar. As is known by persons of ordinary skill in the art, context-free grammars represent transformations or productions on symbol strings. Each production specifies a substitute symbol string for a given symbol string. The technology graph H=(V, E) extends the principles of context-free grammars from symbol strings and transformations among symbol strings to objects and transformations among objects. The expressiveness of the technology graph H=(V, E) is higher than that of context-free grammars as hypergraphs can represent multidimensional relationships directly. The technology graph H (V, E) also expresses a context sensitive grammar.

Each transformation in the technology graph H=(V, E) may specify a substitute hypergraph for a given hypergraph. Accordingly if a subgraph within a hypergraph matches a given hypergraph in a transformation, the subgraph is removed and replace by the substitute hypergraph. The resulting hypergraph is derived from the original hypergraph.

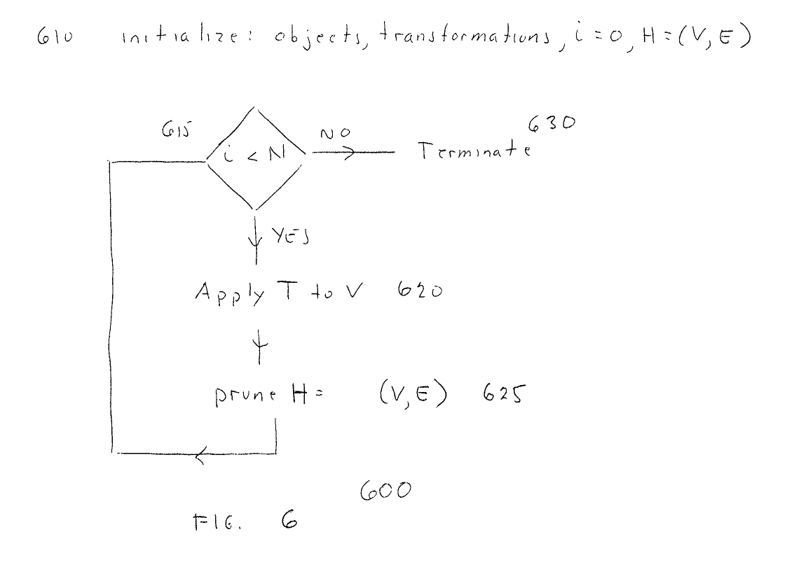

FIG. 6 provides a dataflow diagram 600 representing an overview of a method for synthesizing the technology graph. As is known to persons of ordinary skill in the art, a dataflow diagram is a graph whose nodes are processes and whose arcs are dataflows. See Object Oriented Modeling and Design, Rumbaugh, J., Prentice Hall, Inc. (1991), Chapter 1.

In step 610, the technology graph synthesis method performs the initialization step. The technology graph synthesis method initializes the set of vertices V of the technology graph H=(V, E) to a founder set of objects. The founder set contains the most primitive objects. Thus, the 35 founder set could represent renewable resources. The founder set can have from zero to a finite number of objects. The method also initializes a set of transformations, T, with a finite number of predetermined transformations in step 610. Finally, the method initializes an iterate identifier, i, to 0 in step 610.

In step 615, the method determines whether the iterate identifier is less than a maximum iterate value, I. If the iterate identifier is not less than the maximum iterate value, I, the method terminates at step 630. If the iterate identifier is less than the maximum iterate value, I, then control proceeds to step 620.

In step 620, the technology graph synthesis method applies the set of transformations, T, to the set of vertices V. In the first iteration of the loop of the flow diagram of FIG. 6, step 620 applies the set of transformations, T, to the objects in the founder set. First, step 620 applies each transformation in the set of transformations, T, to each object in the founder set. Next, step 620 applies each transformation in the set of transformations, T, to all pairs of objects in the founder set. Step 620 similarly continues by applying each transformation in the set of transformations, T, to each higher order subset of objects in the founder set. Execution of step 620 in iteration, i, yields the i th technology adjacent possible set of objects. Execution of step 620 in iteration, i, also yields a modified technology graph H=(V, E). The modified technology graph H=(V, E) contains additional vertices corresponding to the i th technology adjacent possible set of objects and additional hyperedges e corresponding to the transformations applied in the i th iteration of the loop of the flow graph of FIG. 6.

In one embodiment, the method maintains all vertices created by execution of step 620 in the technology graph H=(V, E). In an alternate embodiment, step 625 prunes all vertices representing duplicate elements of the ith technology adjacent possible set of objects from the technology graph H=(V, E). Accordingly, in the first embodiment of step 625, every object constructed at each iteration of the method is kept in the technology graph H=(V, E). Execution of the technology graph synthesis method 600 using the first embodiment of step 625 produces a full technology graph H=(V, E). In the alternate embodiment, only objects which were not elements in the founder set and which were not created in previous iterations of the loop of the flow diagram of FIG. 6 are added to the technology graph H=(V, E). Execution of the technology graph synthesis method 600 using the alternate embodiment with the pruning of step 625 produces a minimal technology graph H=(V, E). After execution of step 625, control returns to step 615.

In subsequent iterations of the loop of the flow graph of FIG. 6, step 620 applies the set of transformations, T, to the objects in the set of vertices V of the technology graph H=(V, E) produced by the execution of the previous iteration of the loop.

The set of transformations T can be held fixed throughout the execution of the technology graph synthesis method 600. Alternatively, new transformations could be added to the set of transformations and old transformations could be removed. For example, objects representing machines could also be included in the founder set of objects. Next, the set of transformations T could be applied to the objects representing machines just as they are applied to the other objects in the technology graph H=(V, E). Consequently, the set of transformations T could be limited to the transformations which are mediated by those machine objects represented by vertices of the technology graph H=(V, E).

Technology Graph Applications

The paths in the technology graph H=(V, E) which begin at vertices corresponding to objects in the founder set and end at vertices corresponding to finished goods represent the processes for producing the finished goods from the objects in the founder set. A path Pₗ of a hypergraph H=(V, E) is defined as an alternating sequence of vertices and edges vₗ₁, eₗ₁, vₗ₂, eₗ₂, vₗ₃, eₗ₃, Vₗ₄, eₗ₄ . . . such that every pair of consecutive vertices in Pᵢ are connected by the hyperedge e appearing between them along Pₗ. As previously discussed, the vertices of the technology graph represent renewable resources, intermediate objects and finished objects and the hyperedges of the technology graph represent transformations. Accordingly, a path Pᵢ in the technology graph H=(V, E) from a founder set to a finished good identifies the renewable resources, the intermediate objects, the finished objects, the transformations and the machines mediating the transformations of the process. Thus, a process is also referred to as a construction pathway.

The technology graph H=(V, E) also contains information defining a first robust constructability measure of a terminal object representing a finished good or service. The first robust constructability measure for a terminal object is defined as the number of processes or construction pathways ending at the terminal object. Process redundancy for a terminal object exists when the number of processes or construction pathways in a technology graph exceeds one. Failures such as an interruption in the supply of a renewable resource or the failure of a machine cause blocks along construction pathways. Greater numbers of processes or construction pathways to a terminal object indicate a greater probability that a failure causing blocks can be overcome by following an alternate construction pathway to avoid the blocks. Accordingly, higher values of the first robust constructability measure for a terminal object indicate higher levels of reliability for the processes which produce the finished good or service represented by the terminal object. Further, the technology graph extends the traditional notion of the makespan.

The technology graph H=(V, E) also contains information defining a second robust constructability measure of a terminal object representing a finished good or service. The second robust constructability measure for a terminal object is defined as the rate at which the number of processes or construction pathways ending at the terminal object increases with the makespan of the process. For example, suppose a terminal object can be constructed with a makespan of N time steps with no process redundancy. Since there is no process redundancy, a block along the only construction pathway will prevent production of the terminal object until the cause of the block is corrected. The relaxation of the required makespan to N+M time steps will increase the number of construction pathways ending at the terminal object. Accordingly, failures causing blocks can be overcome by following an alternate construction pathway to the terminal object. In other words, while the minimum possible makespan increased by M time steps, the resulting greater numbers of processes or construction pathways to the terminal object led to greater reliability. Thus, the present invention extends the notion of a makespan to include the concept of robust constructability.

The technology graph H=(V, E) contains additional robust constructability measures of a class or family of terminal objects representing different finished goods or services. As previously discussed, objects having common attributes and behavior are grouped into a class. See Object Oriented Modeling and Design, Chapter 1. In the technology graph H=(V, E), each class represents a set of objects having common attributes and behavior. Exemplary attributes and behavior which are used to group terminal objects into classes include, without limitation, structural and functional features. Structural and functional features include attributes and behavior such as “needs a”, “is a”, “performs a”, “has a”, etc.

The additional robust constructability measures involve vertices which exist within the construction pathways of two or more terminal objects. These objects represented by these vertices are called poly-functional intermediate objects because two or more terminal objects can be constructed from them. For example, consider two terminal objects representing a house and a house with a chimney. The poly-functional intermediate objects are the objects represented by vertices which exists within a construction pathway of the house and within a construction pathway of the house with the chimney. Thus, if a consumer requests a chimney in a house after a firm has constructed the house without a chimney, the firm can add the chimney to the house by backtracking along the construction pathway of the house to a poly-functional intermediate object and proceeding from the poly-functional intermediate object along a construction pathway of the house with a chimney.

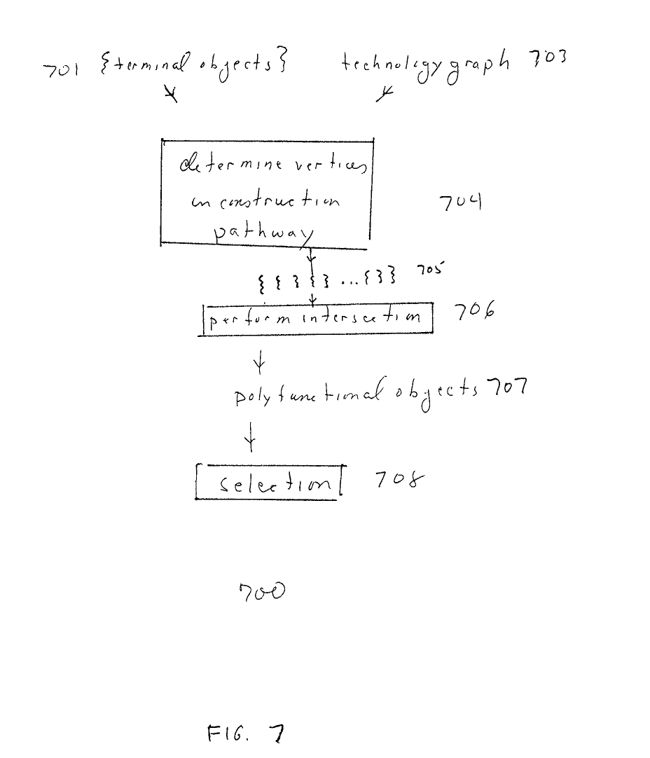

FIG. 7 provides a flow diagram 700 for locating and selecting poly-functional intermediate objects for a set of terminal objects 701 having a cardinality greater than or equal to two. In step 704, the method determines the vertices which exist within the construction pathways of each terminal object in the set of terminal objects 701 in the technology graph H=(V, E). Execution of step 704 yields a set of vertices 705 for each terminal object in the set of terminal objects 701. Accordingly, the number of sets of vertices 705 resulting from execution of step 704 is equal to the cardinality of the set of terminal objects 701. In step 706, the method performs the intersection operation on the sets of vertices 705. Execution of step 706 yields the vertices which exist within the construction pathways of every terminal object in the set of terminal objects 701. In other words, execution of step 706 yields the poly-functional intermediate objects 707 of the set of terminal objects 701.

In step 708, the method performs a selection operation on the poly-functional intermediate objects 707. Preferably, step 708 selects the poly-functional intermediate object 707 with the smallest fractional construction pathway distance. The fractional construction pathway distance of a given poly-functional intermediate object is defined as the ratio of two numbers. The numerator of the ratio is the sum of the smallest distances from the given poly-functional intermediate object to each terminal object in the set of terminal objects 701. The denominator of the ratio is the sum of the numerator and the sum of the smallest distances from each object in the founder set to the given poly-functional intermediate object. The distance between two vertices along a construction pathway in the technology graph H=(V, E) is defined as the number of hyperedges e on the construction pathway between the two vertices. The smallest distance between two vertices in the technology graph H=(V, E) is the number of hyperedges e on the shortest construction pathway.

Alternatively, step 708 considers the process redundancy in addition to the fractional construction pathway distance in the selection of the poly-functional intermediate objects 707. This alternative selection technique first locates the poly-functional intermediate object 707 having the smallest fractional construction pathway distance. Next, the alternative technique traverses the construction pathways from the poly-functional intermediate object 707 having the smallest fractional construction pathway distance toward the founder set until it reaches a poly-functional intermediate object 707 having a sufficiently high value of process redundancy. A sufficiently high value of process redundancy can be predetermined by the firm.

The method of FIG. 7 for locating and selecting poly-functional intermediate objects for a set of terminal objects 501 can also be executed on different subsets of the power set of the set of terminal objects 701 to locate and select poly-functional intermediate objects for different subsets of the set of terminal objects.

As indicated by the preceding discussion, the present invention identifies and selects the poly-functional object which leads to process redundancy to achieve reliability and adaptability. Specifically, a firm should ensure that there is an adequate inventory of the selected poly-functional object to enable the firm to adapt to failures and changes in the economic environment.

Fitness Landscape

The Analysis Tools 106 of United Sherpa 100 shown in FIG. 1 create a fitness landscape representation of the operations management problem. As is known to persons of ordinary skill in the art, a fitness landscape characterizes a space of configurations in terms of a set of input parameters, defines a neighborhood relation among the members of the configuration space and defines a figure of merit or fitness for each member of the configuration space.

More formally, a landscape is defined over a discrete search space of objects X and has two properties:

(1) Objects x ε X have a neighbor relation specified by a graph G. The nodes in G are the objects in G with the edges in G connecting neighboring nodes. G is most conveniently represented by its adjacency matrix.

(2) A mapping f: X→R gives the cost of every object x ε X. For purposes of simplicity, the cost is assumed to be real but more generally may be any metric space.

Without limitation, the following embodiments of the landscape synthesis and analysis features of the analysis component 104 of the present invention are described in the illustrative context of fitness landscapes which are defined over bit strings of length n, i.e. X={0, 1}ⁿ. However, it is apparent to persons of ordinary skill in the art that the landscape synthesis and analysis features of the present invention are also applicable to landscapes which are defined by a mixture of discrete and continuous parameters. The fitness of a landscape is any mapping of bit strings to real numbers. For example, the fitness of a bit string x f(z) is equal to the number of 1's in x.

For example, without limitation, a fitness landscape can represent the job shop scheduling problem. As previously discussed, in the job shop scheduling problem, each machine at the firm performs a set of jobs. Each job consists of a certain ordered sequence of transformations from a defined set of transformations, so that there is at most one job running at any instance of time on any machine. The job shop scheduling problem consists of assigning jobs to machines to minimize the makespan. The set of all possible workable or non-workable schedules defines the configuration space for the job shop scheduling problem. The neighborhood relation can be defined as a permutation of the assignment of jobs to machines. Specifically, one way to define the neighborhood relation is to exchange the assignment of a pair of jobs to a pair of machines. For example if jobs a and b are assigned to machines 1 and 2 respectively in a job shop schedule then a neighboring job shop schedule is defined by assigning jobs a and b to machines 2 and 1 respectively. The fitness of each job shop schedule is defined as its makespan.

The Analysis component 104 performs tasks for United Sherpa 100 to address many of the problems associated with finding optimal, reliable and flexible solutions for operations management. First, it is difficult to predict the effect of changes in one or more of the input parameters on the outcome or fitness as the outcome may depend on the input parameters in a complex manner. For example, it might be difficult to predict the effect of adding a machine to a job shop, moving a manufacturing facility or contracting with another supplier on the reliability and flexibility of a firm's operations. The fitness landscape characterizes the effect of changes of the input parameters on the outcomes by defining a neighborhood relation.

Next, for most problems, only a small fraction of the fitnesses of the configuration space can be determined through actual observations or simulation because of the large size of the configuration space. The Analysis Component 104 of United Sherpa 100 addresses this difficulty by providing a method which predicts the outcomes for input parameter values which are neither observed nor simulated. In other words, the Analysis Component 104 provides a method for learning the landscape from a relatively small amount of observation and simulation.

Next, simulation and observation are not deterministic. In other words, the simulation or observation of the same input parameter values may yield different outcomes. This problem may be attributed to limitations associated with the selection of input parameters, errors associated with the setting of input parameters and errors associated with the observation of input parameters and outcomes because of noise. The analysis component 104 of United Sherpa 100 addresses this difficulty by assigning an error bar to its predictions.

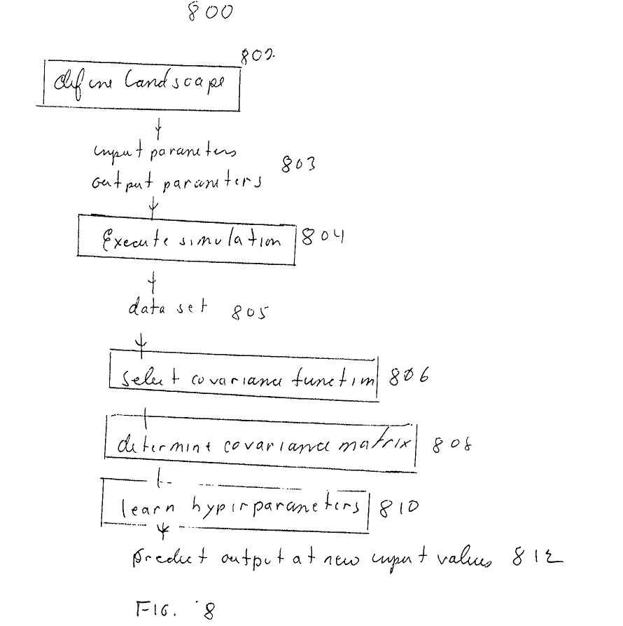

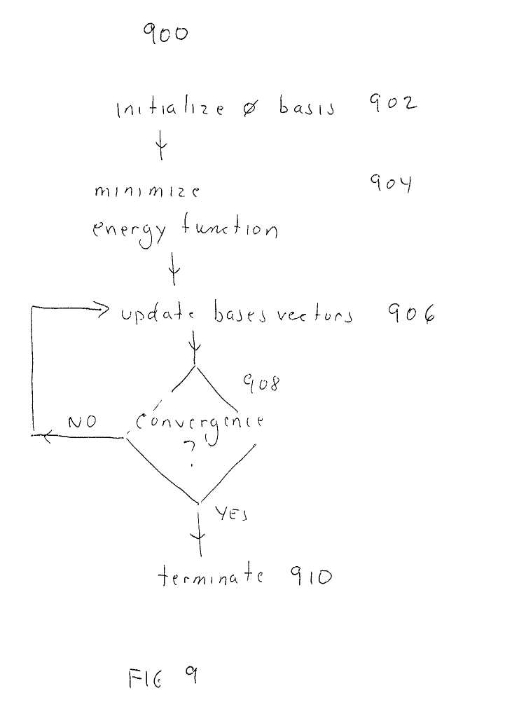

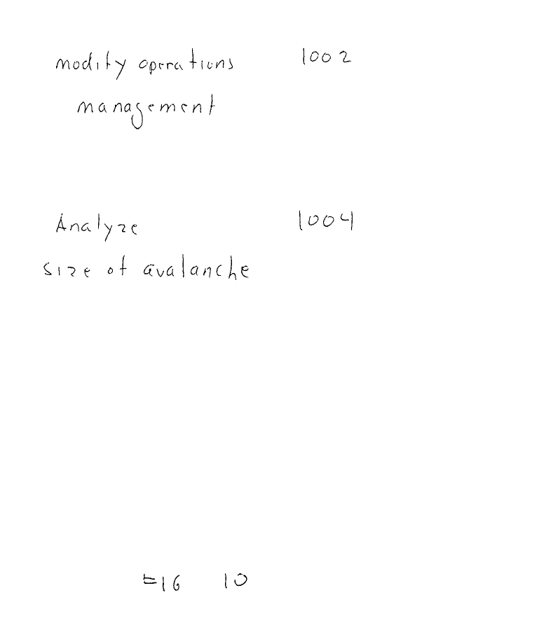

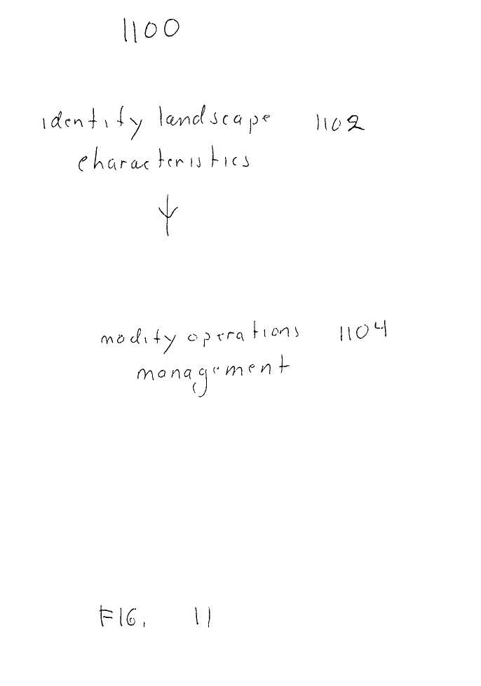

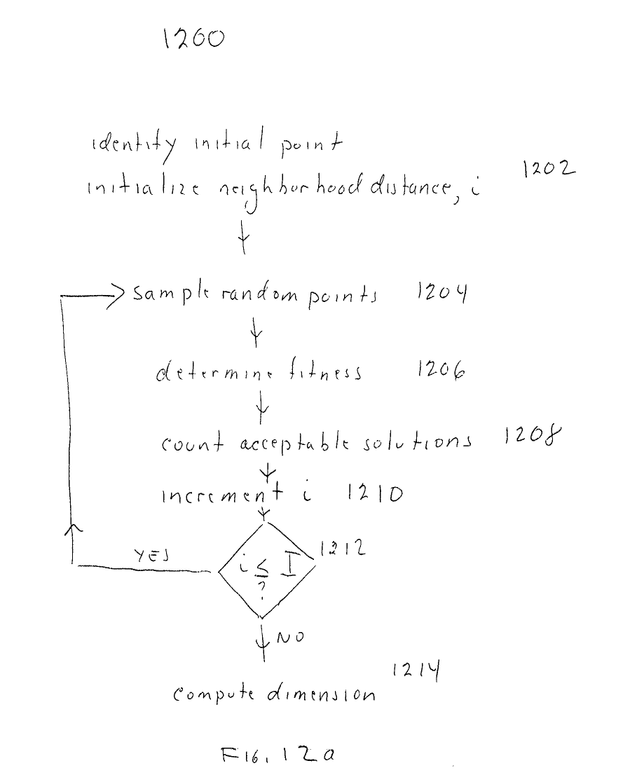

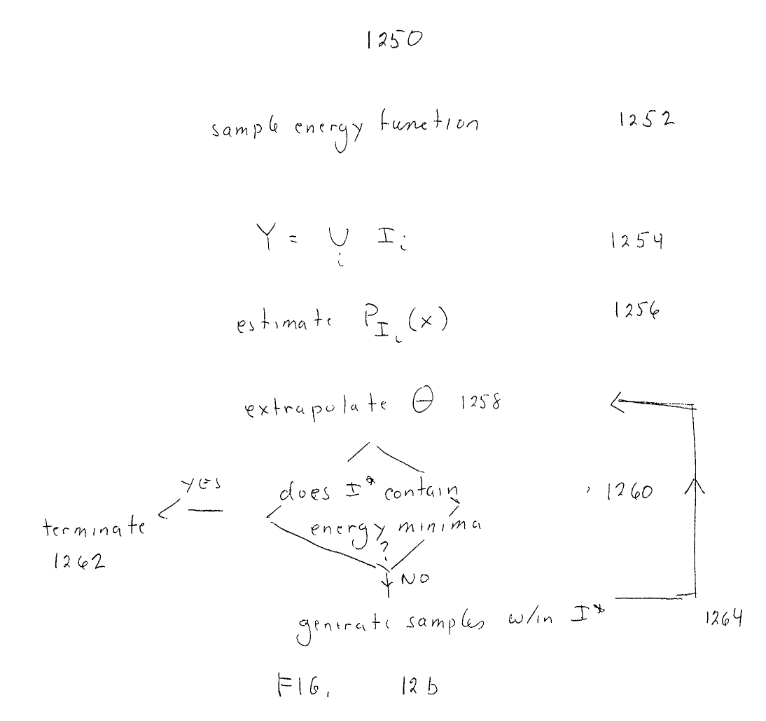

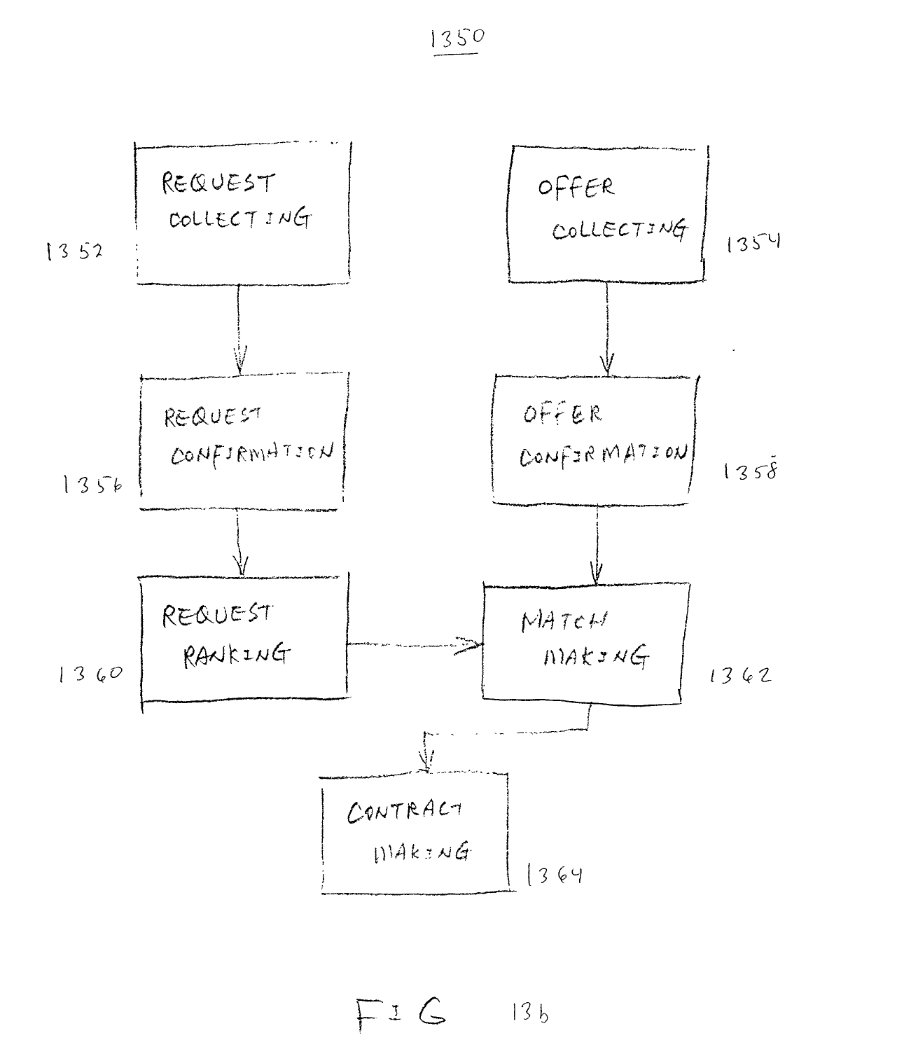

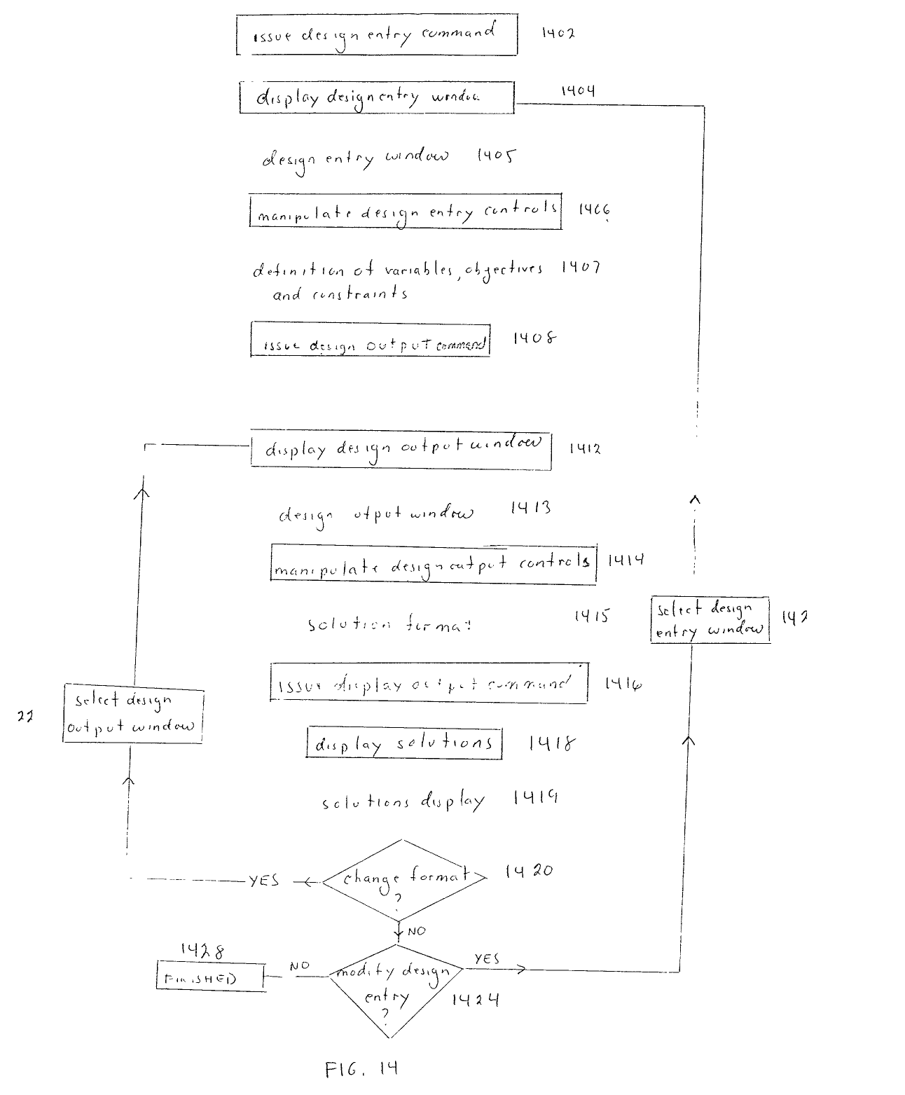

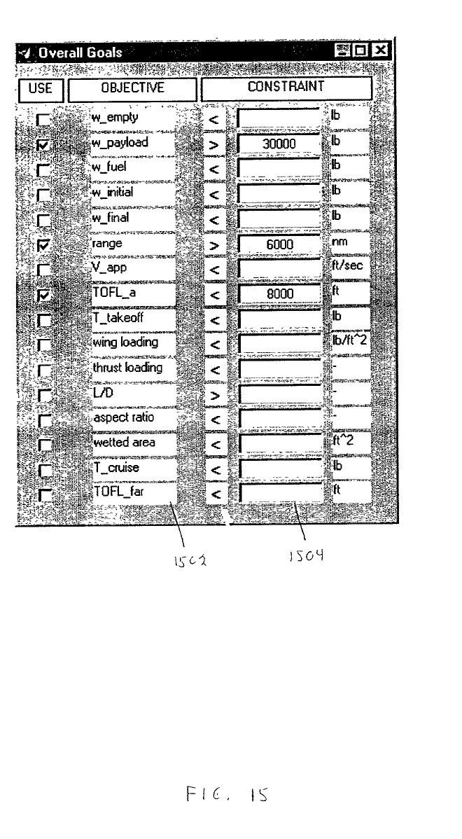

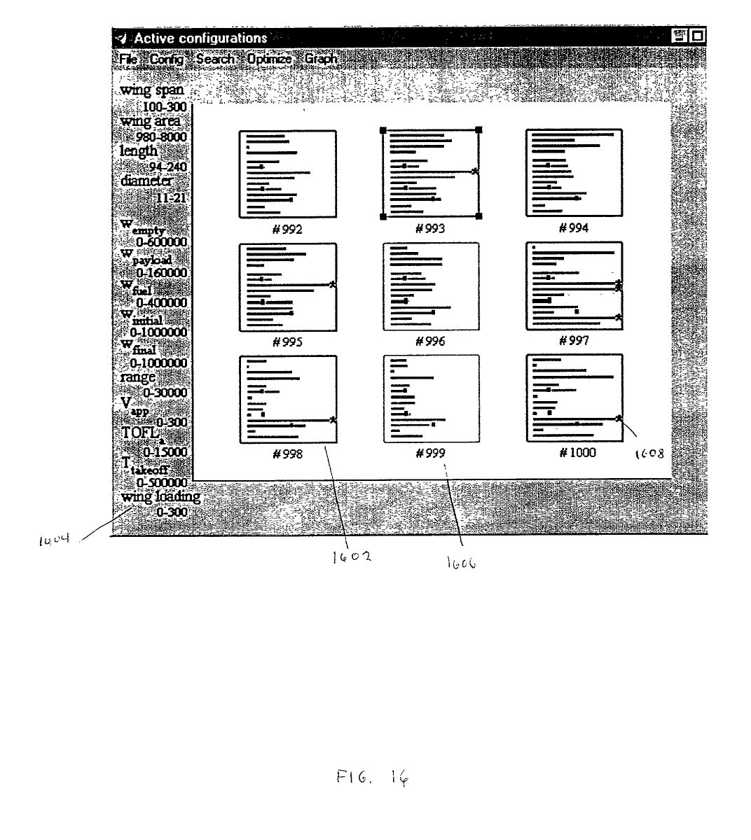

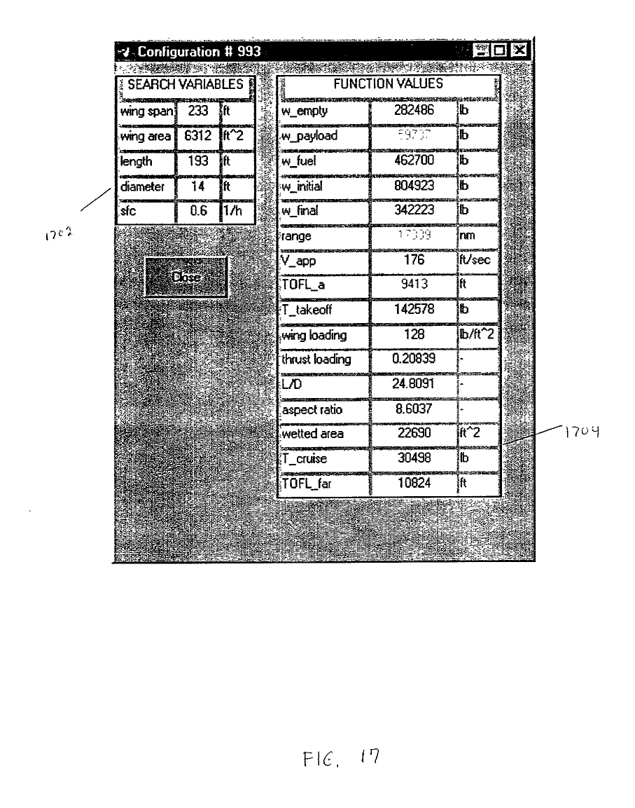

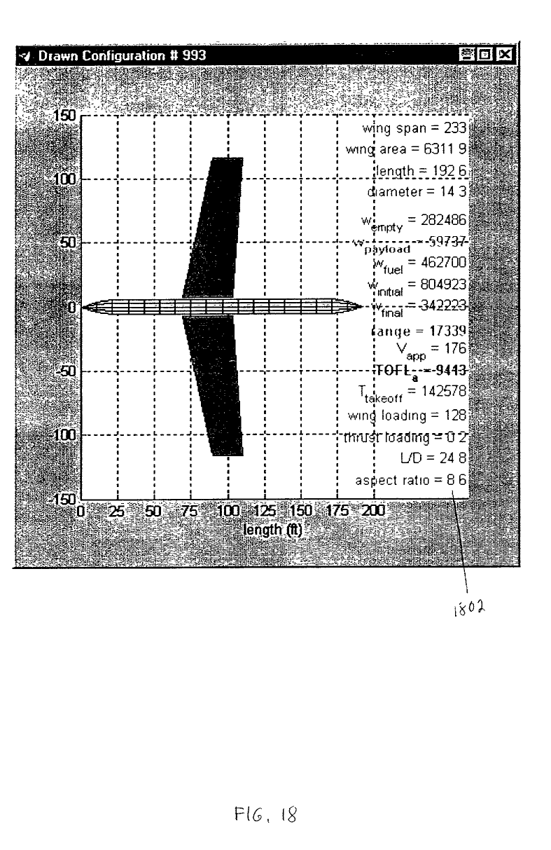

The Analysis component 104 of United Sherpa 100 performs landscape synthesis 800 using the algorithm illustrated by the flow diagram of FIG. 8. In step 802, the landscape synthesis method defines the input parameters and the neighborhood relation for the fitness landscape. The input parameters are discrete rather than continuous because of the nature of the configuration space associated with operations management. Morever, discrete input parameters could also be used to represent the values of a continuous variable as either below a plurality of predetermined threshold values or above the predetermined threshold values. For example, the input parameters could be binary variables having values that are represented by a string of N binary digits (bits). Preferably, step 802 defines the neighborhood relation such that the distance between input parameter values is the Hamming distance. If x^{(l)} and x^{(j)} represent a string of binary digits, then the Hamming distance is the number of binary digit positions in which x⁽ⁱ⁾ and x^{(j)} differ. The Hamming distance measure ranges from 0 when x^{(l)}=x^{(j)} to N when x^{(l)} and x^{(j)} differ in every position for bit strings of length N. For example, the Hamming distance between the bit strings of length five, 00110 and 10101, is three since these bit strings differ at positions 1, 4, and 5. Similarly, the Hamming distance between bit strings of length five, 02121 and 02201, is also three since these bit strings differ at positions 3, 4,and 5. For strings composed of symbols taken from an alphabet of size A, there are (A−1)*L immediate neighbors at distance one.

In step 804, the landscape synthesis method performs simulation on a domain of input parameters to produce corresponding output parameter values and stores the input/output values in a data set: D={x⁽¹⁾, y⁽¹⁾, . . . , x^{(d)}, y^{(d)}}. If the simulation is not deterministic, step 804 performs multiple simulation runs to produce multiple sets of corresponding output parameter values. Next, step 804 computes the average value for each output parameter to produce the corresponding output parameter values and stores the input/output value pairs in a data set: D={x⁽¹⁾, y⁽¹⁾, . . . , x^{(d)}, y^{(d)}}. This technique decreases the effect of noise and obtains more accurate output parameter values. Preferably, OrgSim 102 performs the simulation of step 804.

In step 806, the method chooses the covariance function C(x^{(l)}, x^{(j)}, Θ) which is appropriate for the neighbor relation selected in step 802. The correlation ρ in output values at x^{(l)}and x^{(j)}, assuming the average output is zero and the variance of outputs is 1, is the expected value for the product of the outputs at these two points: E(y(x₁)y(X₂)). The correlation for many landscapes decays exponentially with distance as ρ(s)=ρ′, where −1≦ρ≦1 is the correlation in outcomes between neighboring strings (i.e. strings having a Hamming distance of 1). See P. F. Stadler, Towards a theory of Landscape, in Complex Systems and Binary Networks. Eds: R Lopez-Pena. R. Capovilla, R Garcia-Pelayo. H Waelbroeck, and F. Zertuche, Springer-Verlag Berlin, 1995. Assuming that this correlation depends only on the Hamming distance between the strings x^{(l)} and x^{(j)}, step 806 defines a covariance matrix for discrete landscapes as

C(x^{(l)}, x^{(j)}, Θ)=Θ₁Cₛ(x^{(l)}, x^{(j)})+Θ₂+δ_{i, j}Θ₃ (1)

wherein

$${C}_{s} ( {x}^{( i )} , {x}^{( j )} ) = {\prod }_{1 \leq k \leq N} {ϱ}_{k}^{{x}_{k}^{( i )} ⩓ {x}_{κ}^{( j )}}$$

Cₛ(x⁽ⁱ⁾, x^{(j)} is the stationary part of the covariance matrix. The parameters Θ=(Θ₁, Θ₂, Θ₃) and the parameters ρ₁ through ρ_{N} describing the covariance function are called hyper-parameters. These hyper-parameters identify and characterize different possible families of functions. The hyper-parameters ρ₁ through ρ_{N} are variables having values between negative one and positive one inclusive. The hyper-parameters ρ₁ through ρ_{N} are interpreted as the degree of correlation in the landscape present along each of the N dimensions. Next, xₖ^{(l)}=0,1 is the k^{th} bit of x^{(l)}. The Λ operator in the exponent has a value of one if the symbols at position k differ. Otherwise, the Λ operator has a value of zero.

In step 808, the landscape synthesis method forms the d×d covariance matrix, C_{α}(Θ), whose (i, j) element is given by C(x^{(l)}, x^{(j)}, Θ). For example, the covariance matrix for a data set of input/output values produced by simulation with inputs, x⁽¹⁾=010, x⁽²⁾=101, and x⁽³⁾=110 is

$${C}_{d} ( Θ ) = [ \begin{matrix}{Θ}_{1} + {Θ}_{2} + {Θ}_{3} & {Θ}_{1} {ρ}_{1} {ρ}_{2} {ρ}_{3} + {Θ}_{2} & {Θ}_{1} {ρ}_{1} + {Θ}_{2} \\ {Θ}_{1} {ρ}_{1} {ρ}_{2} {ρ}_{3} + {Θ}_{2} & {Θ}_{1} + {Θ}_{2} + {Θ}_{3} & {Θ}_{1} {ρ}_{2} {ρ}_{3} + {Θ}_{2} \\ {Θ}_{1} {ρ}_{1} + {Θ}_{2} & {Θ}_{1} {ρ}_{2} {ρ}_{3} + {Θ}_{2} & {Θ}_{1} + {Θ}_{2} + {Θ}_{3}\end{matrix} ] . \qquad ( 2 )$$

The covariance matrix C_{d}(Θ) determined in step 808 must satisfy two requirements. First, the covariance matrix C_{d}(Θ) must be symmetric. Second, the covariance matrix C_{d}(Θ) must be positive semi-definite. The covariance matrix C_{d}(Θ) is symmetric because of the symmetry of the Λ operator.

The covariance matrix C_{d}(Θ) is also positive semi-definite. The contribution from Θ₃ is diagonal and adds Θ₃I to C. Moreover, the contribution from Θ₃ is the same for all matrix elements and can be written as Θ₃ 11^{t} where 1 is the vector of all ones. These matrices are positive definite and positive semi-definite respectively. Since the sum of positive semi-definite matrices is positive semi-definite we can prove that C_{d}(Θ) is positive semi-definite by showing that the matrix └C_{l,j}^{s}┘=Cₛ(x^{(l)}, x^{(j)}) is positive semi-definite.

Assuming the discrete variables x are binary variables b, note that Cₛ(x^{(l)}, x^{(j)})=└C_{l,j}^{s}┘ wherein

$${c}_{i , j}^{s} = {\prod }_{k} {ρ}^{{b}_{k}^{( i )} ⩓ {b}_{k}^{( j )}} ≡ {\prod }_{k} {c}_{i , j}^{s} ( k ) .$$

where c_{l,j}^{s}(k)=ρ^{b}^{ₖ}^{^{(l)}}^{Λb}^{^{(j)}}. If we define the matrix └C_{l,j}^{s}(k)┘ then the matrix Cₛ can be written as the Hadamard or element-wise product, o, of the Cₖ:

Cₛ=OₖCₖ.

Now it is well known that the Hadamard product of positive semi-definite matrices is itself positive semi-definite as indicated by the Schur product theorem. Thus if we can show that Cₖ is positive semi-definite then the proof is complete.

Note first that the matrix elements C_{l,j}^{s}(k) are either 1 if bₖ⁽ⁱ⁾=bₖ^{(j)} or ρ if bₖ^{(l)}≠bₖ^{(j)} so we can express C_{l,j}^{s}(k) as

C_{l,j}^{s}(k)=1+(ρ−1) (bₖ⁽ⁱ⁾+bₖ^{(j)}−2bₖ^{(k)}bₖ^{(j)}).

Thus we can write the matrix Cₖ as

Cₖ=11^{t}+(ρ−1)(bₖ1^{t}+1bₖ^{t}−2bₖbₖ^{t}) (3)

where 1 is the vector of 1s and bₖ is the binary vector └bₖ^{(l)}, . . . , bₖ^{(N)}┘^{t}. To prove that Cₖ is positive semi-definite we must show that x^{t}Cₖx≧0 for all x. Let us consider this matrix product in light of Eq. (3):

$$\begin{matrix}{x}^{t} {C}_{k} x = ( {x}^{t} 1 ) ( {1}^{t} x ) + ( ρ - 1 ) ( ( {x}^{t} {b}_{k} ) ( {1}^{t} x ) + \\ ( {x}^{t} 1 ) ( {b}_{k}^{t} x ) - 2 ( {x}^{t} {b}_{k} ) ( {b}_{k}^{t} x ) ) \\ = {( {x}^{t} 1 )}^{2} + 2 ( ρ - 1 ) {x}^{t} {b}_{k} ( {x}^{t} 1 - {x}^{t} {b}_{k} ) \\ = {( {x}^{t} 1 )}^{2} + 2 ( ρ - 1 ) {x}^{t} {b}_{k} {x}^{t} {\tilde{b}}_{k}\end{matrix} \qquad ( 4 )$$

where \tilde{b}ₖ=1−bₖ is another binary vector. To complete the proof we must show that Eq. (4) is non-negative for |ρ|≦1.

Noting that 1=bₖ+\tilde{b}ₖ Eq. (4) can be rewritten as

x^{t}Cₖx=(x^{t}bₖ)²+2ρx^{t}bₖx^{t}\tilde{b}ₖ+(x^{t}\tilde{b}ₖ)².

Diagonalizing this quadratic form we find that

$${x}^{t} {C}_{k} x = \frac{1 + ρ}{2} {( {x}^{t} {b}_{k} + {x}^{t} {\tilde{b}}_{k} )}^{2} + \frac{1 - ρ}{2} {( {x}^{t} {b}_{k} - {x}^{t} {\tilde{b}}_{k} )}^{2}$$

which is clearly non-negative as long as |ρ|≦1.

In an alternate embodiment, the covariance function is extended to include input dependent noise, Θ₃(x) and input dependent correlations ρₗ(x).

In step 810, the landscape synthesis method determines the values of the hyper-parameters, Θ=(Θ₁, Θ₂, Θ₃) to enable the characterization of the landscape in terms of the values of the hyper-parameters. Preferably, the method selects the values of the hyper-parameters which expresses the probability of making the observations in the data set: D={x⁽¹⁾, y⁽¹⁾, . . . , x^{(d)}, y^{(d)}} given the covariance function C(x^{(l)}, x^{(j)}, Θ) for the different values of the hyper-parameters, Θ=(Θ₁, Θ₂, Θ₃). Preferably, the method determines the values of the hyper-parameters which maximize the logarithm of the likelihood function, log L(Θ)=−½logdet C_{d}(Θ)−½y C_{d}⁻¹(Θ) using the conjugate gradient method. However, as is known in the art, the method can use any standard optimization technique to maximize the logarithm of the likelihood function. As is known in the art, the gradient of the logarithm of the likelihood function can be determined analytically. See M. N. Gibbs. Bayesian Gaussian Process for Regression and Classification, (“Bayesian Gaussian Process for Regression and Classification”), Ph.D University of Cambridge, 1997.

Since the determination of the values of the hyper-parameters, Θ=(Θ₁, Θ₂, Θ₃), which maximize the log likelihood function can be problematic if the log likelihood surface has many local extrema, an alternate embodiment determines the values of the hyper-parameters, Θ=(Θ₁, Θ₂, Θ₃) which maximize the posterior probability distribution of the hyper-parameters Θ=(Θ₁, Θ₂, Θ₃) given the observed data D={x⁽¹⁾, y⁽¹⁾, . . . , x^{(d)}, y^{(d)}}. The logarithm of the posterior probability distribution of the hyper-parameters Θ=(Θ₁, Θ₂, Θ₃) is: logL(Θ)+logP(Θ), where P(Θ) is a prior probability distribution of the hyper-parameters Θ=(Θ₁, Θ₂, Θ₃). The inclusion of the prior probability distribution into the expression for the logarithm of the posterior probability distribution of the hyper-parameters Θ=(Θ₁, Θ₂, Θ₃) smooths the landscape to simplify the optimization problem.

Preferably, P(Θ), the prior probability distribution of the hyper-parameters Θ=(Θ₁, Θ₂, Θ₃) is a modified beta distribution. Since the hyper-parameters Θ=(Θ₁, Θ₂, Θ₃) are being determined with a maximum posterior estimate, the prior probability distribution over the ρ hyper-parameters are constrained to lie within the range from −1 to 1. The modified beta distribution satisfies this constraint. As is known in the art, other distributions could be used to represent the prior probability distribution, P(Θ), as long as the distribution satisfies this constraint.

Next, step 812 predicts the outcome for each new value for the input parameters, x^{(d+1)} using the previously determined covariance function C(x^{(l),x}^{(j)},Θ) and previously determined values for the hyper-parameters Θ=(Θ₁, Θ₂, Θ₃). The probability of the outcomes has a Gaussian distribution with expected value you and variance σ²_{y}_{^{(d+1)}} given by:

Y^{(d+1)}(Θ)=y′C_{d+1}⁻¹(Θ*)k (5)

σ_{y}_{_{(d+1)}}²=K−k′C_{d-1}⁻¹(Θ*)k (6)

In the preceding two equations, y is a d-vector of previously observed outputs given by y′=(y¹, . . . , y^{d}), k is a d-vector of covariances with the new input point and is given by k′=(C (x⁽¹⁾, x^{(d+1)}; Θ), . . . , C(x^{(d+1)}; Θ)) ) k is a scalar given by k=C(x^{(d-1)}, x^{(d+1)}; Θ) and C_{d+1}(Θ) is the (d+1)×(d+1) matrix given by:

$${C}_{d + 1} ( Θ ) = ⌊ \begin{matrix}{C}_{d} ( Θ ) & k \\ {k}^{′} & κ\end{matrix} ⌋ \qquad ( 7 )$$

C_{d+1}⁻¹(Θ) is the matrix inverse of C_{d+1}(Θ) and can be determined analytically from standard matrix results. As is known in the art, the matrix calculations in Equations 5 and 6 are straightforward and can be accomplished in O(d³) time. In addition, faster but approximate matrix inversion techniques can be used to speed calculations to times of O(d²). See Bayesian Gaussian Process for Regression and Classification.

The following example shows the results obtained by executing the landscape synthesis method 800 on an NK model of a fitness landscape. In the NK model, N refers to the number of components in a system. Each component in the system makes a fitness contribution which depends upon that component and upon K other components among the N. In other words, K reflects the amount of cross-coupling among the system components as explained in The Origins of Order, Kauffman, S., Oxford University Press (1993), (“The Origins of Order”), Chapter 2, the contents of which are herein incorporated by reference. 40 random bit strings of length 10 were generated and their outcomes (or y values) determined by the NK model with N=10 and K=1. Noise having a Zero mean and a standard deviation of 0.01 was added to the model.

Execution of the discrete fitness landscape synthesis method 800 on the NK model described above determined the following values for the hyper-parameters: ρ₁=0.768, ρ₂=0.782, ρ₃=0.806, ρ₄=0.794, ρ₅=0.761, ρ₆=0.766, ρ₇=0.775, ρ₈0.751, ρ₉=0.765, ρ₁₀=0.769, Θ₁=0.252, Θ₂=0.227, and Θ₃=0.011. Theoretical results for the NK model described above indicate that all the p values should be identical. Accordingly, the p values determined by the discrete fitness landscape synthesis method 800 were consistent with the theoretical results as the ρ values determined by the method are very similar to each other. Further, the discrete fitness landscape synthesis method 800 accurately estimated the noise level Θ, present in the landscape. Finally, the discrete fitness landscape synthesis method 800 accurately constructed a fitness landscape of the NK model as indicated by the comparison of the outcomes predicted by the method 800 and their associated standard deviation values for unseen input strings with the actual outcomes without the added noise in the table below. As shown by the table, the outcomes predicted by the method 800 appeared on the same side of 0.5 as the actual values for 13 of the 15 input strings.

| x | predicted (standard deviation) | actual |
|---|---|---|
| 1100000011 | 0.439 (0.290) | 0.410 |
| 1011011001 | 0.441 (0.324) | 0.434 |
| 0100111101 | 0.514 (0.365) | 0.526 |
| 0111111010 | 0.525 (0.293) | 0.563 |
| 0101101100 | 0.522 (0.268) | 0.510 |
| 0001001001 | 0.454 (0.320) | 0.372 |
| 0010101001 | 0.428 (0.317) | 0.439 |
| 1000001111 | 0.516 (0.302) | 0.514 |
| 1100010011 | 0.499 (0.291) | 0.448 |
| 0111000000 | 0.502 (0.308) | 0.478 |
| 1111100111 | 0.475 (0.257) | 0.476 |
| 0000000000 | 0.530 (0.269) | 0.531 |
| 1101110010 | 0.572 (0.306) | 0.572 |
| 1011101000 | 0.456 (0.314) | 0.444 |
| 0001101000 | 0.507 (0.315) | 0.480 |

The determination of the hyper-parameters Θ=(Θ₁, Θ₂, Θ₃) for the covariance function C(x⁽¹⁾,x^{(j)},Θ) is valuable in itself because the hyper-parameters supply easily interpretable information such as noise levels, the range of correlation, the scale of fluctuation, etc. about the landscape. Thus, the discrete fitness landscape synthesis method 800 characterizes the landscape with the hyper-parameters Θ=(Θ₁, Θ₂, Θ₃)

The analysis component 104 of United Sherpa also performs landscape synthesis for multiple objectives.

We assume a data set D consisting of vector output value τ={t⁽¹⁾, . . . , t^{(D)}} at the corresponding points {x⁽¹⁾, . . . , x^{(D)}}. Following the standard Gaussian Processes approach we define a covariance function which parameterizes a family of landscape. In the vector output case the covariance function is no longer a scalar but rather an M×M matrix of covariance between the M outputs, i.e.

C(x, x′)=E(y(x)y^{t}(x′)).

Before parameterizing matrix covariances functions suitable for regression on vector outputs we derive formulas which predict the y value at a previously unseen x.

The task at hand is to predict the outputs y^{(D+1)} at a new input point x^{(D+1)}. We start from the standard launching point for Gaussian Processes modified for matrix-valued covariances:

$$P ( {y}^{( D + 1 )} \vert D , {x}^{( D + 1 )} ) = \frac{{Z}_{D}}{{Z}_{D + 1}} exp ⌊ - \frac{1}{2} ( [ {τ}^{t} , {t}_{D + 1}^{t} ] {C}_{D + 1}^{- 1} ⌊ \begin{matrix}τ \\ {t}_{D + 1}\end{matrix} ⌋ - {τ}^{t} {C}_{D}^{- 1} τ ) ⌋ . \qquad ( 8 )$$

We recall that τ is a vector of length M×D given by τ=Σₗ₌₁^{D}eᵢ\mathring{X}f^{(l)} and that C_{D+1} is an [M×(D+1)]×[M×(D+1)] matrix given by C_{D+1}=Σ_{i, j=1}^{D}E_{l,j}\mathring{X}C(x^{(l), x}^{(j)}). The D-vector, eₗ, is a unit vector in the ith direction and the D×D matrix E_{l,j} has all zero elements except for element i,j which is one. The \mathring{X} operator is the standard tensor product defined for an m×n matrix A=[A_{l,j}] and a p×q matrix B=[B_{l,j}] by

$$A ⊗ B = [ \begin{matrix}{A}_{1 , 1} B & ⋯ & {A}_{1 , n} B \\ ⋮ & ⋰ & ⋮ \\ {A}_{n , 1} B & ⋯ & {A}_{m , n} B\end{matrix} ]$$

To determine the probability distribution for t_{D+1} we need to invert the matrix C_{D+1}. We begin by writing

$${C}_{D + 1} = [ \begin{matrix}{C}_{D} & K \\ {K}^{t} & κ\end{matrix} ]$$

where K is the (M×D)×M matrix K=Σₗ₌₁^{D}eₗ\mathring{X}C(xₗ, x_{D+1}) and K is the M×M matrix K=C(x_{D+1}, x_{D+1}). The inverse of C_{D+1} is given by

$${C}_{D + 1}^{- 1} = [ \begin{matrix}{( {C}_{D} - K {κ}^{- 1} {K}^{t} )}^{- 1} & {C}_{D}^{- 1} {K ( {K}^{t} {C}_{D}^{- 1} K - κ )}^{- 1} \\ {( {K}^{t} {C}_{D}^{- 1} K - κ )}^{- 1} {K}^{t} {C}_{D}^{- 1} & {( κ - {K}^{t} {C}_{D}^{- 1} K )}^{- 1}\end{matrix} ] .$$

It is convenient for our purposes to use the matrix inversion lemma to rewrite the 1,1 matrix element of the inverse so that

$${C}_{D + 1}^{- 1} = [ \begin{matrix}{C}_{D}^{- 1} - {C}_{D}^{- 1} {K ( {K}^{t} {C}_{D}^{- 1} K - κ )}^{- 1} {K}^{t} {C}_{D}^{- 1} & {C}_{D}^{- 1} {K ( {K}^{t} {C}_{D}^{- 1} K - κ )}^{- 1} \\ {( {K}^{t} {C}_{D}^{- 1} K - κ )}^{- 1} {K}^{t} {C}_{D}^{- 1} & {( κ - {K}^{t} {C}_{D}^{- 1} K )}^{- 1}\end{matrix} ] .$$

This result can now be used to simplify the argument in the exponential of Eq. (8) to

$$[ {τ}^{t} , {t}_{D + 1}^{t} ] {C}_{D + 1}^{- 1} ⌊ \begin{matrix}τ \\ {t}_{D + 1}\end{matrix} ⌋ - {τ}^{t} {C}_{D}^{- 1} τ = {{t}_{D + 1}^{t} ( κ - {K}^{t} {C}_{D}^{- 1} K )}^{- 1} {t}_{D + 1} - {τ}^{t} {C}_{D}^{- 1} {K ( κ - {K}^{t} {C}_{D}^{- 1} K )}^{- 1} {t}_{D + 1} - {{t}_{D + 1}^{t} ( κ - {K}^{t} {C}_{D}^{- 1} K )}^{- 1} {K}^{t} {C}_{D}^{- 1} τ + cst$$

where cst is a term independent of t_{D+1}. Completing the square on the above equation and substituting into Eq. (8) we find

$$P ( {t}_{D + 1} \vert D , {x}_{D + 1} , C ( Θ ) ) \sim exp ⌊ - \frac{1}{2} {( {t}_{D + 1} - {K}^{t} {C}_{D}^{- 1} τ )}^{t} {( κ - {K}^{t} {C}_{D}^{- 1} K )}^{- 1} ( {t}_{D + 1} - {K}^{t} {C}_{D}^{- 1} τ ) ⌋ .$$

Thus the predicted values, \hat{t}_{D+1}, for t_{D+1}, and the estimated matrix of errors (covariances), \hat{Z}, are

\hat{t}_{D+1}=K^{t}C_{D}⁻¹τ

\mathring{Σ}×=K−K^{t}C_{D}⁻¹K

where we recall the definition τ=Σₗ₌₁^{D}eₗ\mathring{X}t⁽ⁱ⁾, K=Σᵢ₌₁^{D}eₗ\mathring{X}C(x^{(l)}, x^{(D+1)}) and K=C(x^{(D+1)}, x^{(D+1})). These results are the natural extension of the analogous results for scalar valued outputs.

With these results all the standard techniques (e.g. determination of or integration over hyperparameters) for scalar output GP can naturally be extended to the case of vector outputs.

With these results, we now need to parameterize a useful family of M×M covariance functions of M objectives. The most natural covariance matrix function to pick is the matrix generalization of the scalar representations. For example, for multiple landscapes defined over bitstrings we might use

$$C ( {b}^{( i )} , {b}^{( j )} ; Θ ) = {Θ}_{1} ( α , β ) {\prod }_{1 \leq k \leq N} {ρ}_{k}^{{b}_{k}^{( i )} ⩓ {b}_{k}^{( j )}} ( α , β ) + {Θ}_{2} ( α , β ) + {δ}_{i , j} {Θ}_{3} ( α , β ) .$$

where the Greek indices label all possible

$$( \begin{matrix}M \\ 2\end{matrix} )$$

pairs of landscapes. Viewed as an M×M matrix for a fixed pair of input points the matrix C represents the covariances across the different objectives. Thus, it must be positive semi-definite. Let C_{b}_{^{(l)}},_{b}_{^{(j)}} be the M×M matrix of covariances of fitness. Then we can write

C_{b}_{^{(l)}},_{b}_{^{(j)}}=Θ₁∘P_{b}_{^{(l)}}+Θ₂+δ_{l,j}Θ₃

where Θ₁, Θ₂, and Θ₃ are M×M matrices of parameters, P_{b}_{^{(l)}},_{b}_{^{(j)}}=Πₖρₖ^{b}^{ₖ}^{^{(l)Λb}}^{ₖ}^{^{(j)}} (α,β and ∘ is the Hadamard or element-wise product of matrices. Since each ρₖ(α,β)ε[−1, +1] the matrix P_{b}_{^{(l)}},_{b}_{^{(j)}} is positive semi-definite. It is well known that the Hadamard product of positive semi-definite matrices is also positive semi-definite (Schur product theorem). Thus, C_{b}_{^{(l),}}_{b}_{^{(j)}} will be positive semi-definite as long as the matrices Θ₁, Θ₂, and Θ₃ are positive semi-definite.

To implement GP over landscapes we can maximize the log likelihood function directly to determine a maximum likelihood estimate of 0 and use this 8 for prediction. However, the log likelihood function is usually multi-modal and gradient ascent on the log likelihood is easily trapped on local maxima. Consequently, it is usually better to add a regularizing term through a prior P(Θ). We supply some tunable prior distributions that can be used for this purpose.

The parameters in the covariance function Θ₁, Θ₂, and Θ₃ are all constrained to be positive. We consider two distributions over positive variables that are appropriate to use as priors over these variables.

A common distribution used to parameterize positive variables is the gamma distribution.

$$P ( Θ \vert α , β ) = \frac{{Θ}^{α - 1} exp [ - Θ / β ]}{Γ ( α ) {β}^{α}}$$

The hyperparameters α and β control the position and shape of the distribution. In terms of the mean m and and variance υ of the distribution

α=m²/v and β=v/m.

For numerical stability in maximizing the posterior probability it is convenient to write this distribution in terms of variables which range over the entire real line. Consequently, we set Θ=exp [θ] and determine the distribution over θ as

$$\tilde{P} ( θ \vert α , β ) = \frac{exp [ αθ ] exp [ - exp [ θ ] / β ]}{Γ ( α ) {β}^{α}}$$

Since we wish to maximize the logarithm of the posterior probability we note for completeness that

$$log [ \tilde{P} ( θ \vert α , β ) ] = - log [ Γ ( α ) ] - α log β + α x - \frac{exp [ θ ]}{β} .$$

Another useful prior over positively constrained hyperparameters is the inverse gamma distribution. The inverse gamma distribution is

$$P ( θ \vert α , β ) = \frac{{Θ}^{- ( α + 1 )} exp [ - 1 / ( Θβ ) ]}{Γ ( α ) {β}^{α}} .$$

The α and β parameters given in terms of the mean and variance are:

$$α = 2 + \frac{{m}^{2}}{v} and β = \frac{v / m}{v + {m}^{2}} .$$

Transforming to coordinates θ=log Θ which range over the entire real line we then have

$$\tilde{P} ( θ \vert α , β ) = \frac{exp [ - α θ ] exp [ - exp [ - θ ] / β ]}{Γ ( α ) {β}^{α}}$$

The logarithm of the prior probability in this case is

$$log [ \tilde{P} ( θ \vert α , β ) ] = - log [ Γ ( α ) ] - αlogβ - αθ - \frac{exp [ - θ ]}{β} .$$

The ρ parameters are constrained to lie in |ρ|<1. Most often ρ is positive so we consider this special case before presenting a general prior.

For positively constrained landscapes (so that 0≦ρ<1) like those generated by the NK model an appropriate prior over the ρ variables is a beta distribution:

$$P ( Θ \vert α , β ) = \frac{Γ ( α + β )}{Γ ( α ) Γ ( β )} {( {Θ}^{α - 1} ( 1 - Θ ) )}^{β - 1} .$$

The α and β parameters are determined in this case as

$$α = - \frac{m ( v + {m}^{2} - m )}{v} and β = \frac{( v + {m}^{2} - m ) ( m - 1 )}{v}$$

Again we transform coordinates so that the real line is mapped to the unit interval. In this case we write Θ as a sigmoid function of θ: Θ=(1+exp[−θ])⁻¹ so that the distribution over θ is

$$\tilde{P} ( θ \vert α , β ) = \frac{Γ ( α + β )}{Γ ( α ) Γ ( β )} \frac{exp [ - βθ ]}{{( 1 + exp [ - θ ] )}^{α + β}}$$

The log prior probability in this case is

$$log [ \tilde{P} ( θ \vert α , β ) ] = log ⌊ \frac{Γ ( α + β ) ]}{Γ ( α ) Γ ( β )} ⌋ - βθ - ( α + β ) log [ 1 + exp [ - θ ] ]$$

When we need to include the possibility of negative ρ we can modify the Beta distribution to cover the interval Θε[−1, 1] so that

$$P ( θ \vert α , β ) = \frac{Γ ( α + β )}{{2}^{α + β - 1} Γ ( α ) Γ ( β )} {( 1 + Θ )}^{α - 1} {( 1 - Θ )}^{β - 1}$$

The mean and variance of this distribution are m=(α−β)/(α+β) and v=4αβ/((α+β)²(α+β+1)) so that

$$α = \frac{1 + m}{2} ( \frac{1 - {m}^{2}}{v} - 1 ) and β = \frac{1 - m}{2} ( \frac{1 - {m}^{2}}{v} - 1 )$$

It is also useful to convert to a variable θ which assumes values over the entire real line. This can be accomplished by defining d through Θ=tanh θ. The θ distribution is then

$$\tilde{P} ( θ \vert α , β ) = \frac{Γ ( α + β )}{{2}^{α + β - 1} Γ ( α ) Γ ( β )} {( 1 + tan h θ )}^{α} {( 1 - tan h θ )}^{β}$$

with α and β given as above. The log prior probability in this case is

$$log [ \tilde{P} ( θ \vert α , β ) ] = log ⌊ \frac{Γ ( α + β )}{{2}^{α + β - 1} Γ ( α ) Γ ( β )} ⌋ + αlog [ 1 + tan h θ ] + β log [ 1 - tan h θ ] .$$

The Analysis component 104 of United Sherpa 100 includes additional techniques to provide a more informative characterization of the structure of landscapes. These additional techniques characterize a fitness landscape or a family of fitness landscapes by determining the sparse bases for them. The sparse bases techniques offer a number of benefits including 1) compression, 2) characterization, 3) categorization, 4) smoothing, and 5) multiresolution.

The sparse bases techniques of the present invention compress the information in a landscape into a manageable size. In order to make use of landscapes, there must be a way to represent them with a concise description.

Even for a landscape defined over bit strings of length n=20 there are over 10⁶ pieces of information needed to completely specify the landscape. Moreover, a complete description of the landscape is usually exponential in the parameters of the landscape. For example, the information necessary to describe a n=30 landscape is 1000 times larger than the already large n=20 landscape. Accordingly, landscapes must be represented by a concise, compressed description to serve as a useful technique for operations management.

The sparse bases techniques also characterize landscapes to identify the salient features of a class of landscapes. This characterization is useful because the optimization algorithms within the optimization component 106 of United Sherpa 100 are specifically designed to exploit the salient features of the class of landscapes.

United Sherpa 100 also uses the compressed descriptions of landscapes to form categories of landscapes. To find good solutions to a new optimization problem, the analysis component 104 of United Sherpa 100 creates a landscape representation of the problem as previously discussed. Next, the analysis component 104 determines the sparse base representation of the landscape. Next, the analysis component 104 identifies the class of landscapes which is most similar to the new landscape. Finally, after identifying the landscape's class, the optimization component 106 can execute that class's corresponding algorithms to find good solutions to the new optimization problem.

The sparse bases techniques also allow smoothing of landscapes which are polluted with noise such as intrinsic noise and noise introduced by measurement. Specifically, the analysis component 104 achieves smoothing by changing all coefficients which fall below a predetermined threshold to zero. While smoothing loses information, it has the benefit of removing details which do not have global structure such as noise.

The sparse bases techniques also achieve a multi-resolution description. In other words, the bases extracted for the landscape describe the structure of the landscape in many ways for use by the optimization component 106 of United Sherpa 100.

To determine sparse representations of landscapes the analysis component 104 uses a set F of n landscapes from which to construct a set of basis vectors φⱼ (x) so that any landscape fₗ ε F can be represented as:

$${f}_{1} ( x ) = {\sum }_{j} {a}_{j}^{( i )} {φ}_{j} ( x )$$

The basis φ={φⱼ} may be complete or overcomplete and it is not assumed the basis vectors are orthogonal. Let a={aⱼ^{(l)} , . . . , aⱼ⁽ⁿ⁾} denote the set of expansion coefficients for each of the n landscapes. For the basis to be sparse any fₗ ε F can be represented reasonably accurately with few basis vectors, i.e. most of the aⱼ⁽ⁱ⁾ are zero. The analysis component 104 of United Sherpa 100 includes two approaches for determining the bases φ={φⱼ} for landscapes.

In the first approach, the analysis component 104 of United Sherpa 100 applies principal components analysis to discrete landscapes. In this approach, the analysis component 104 begins by constructing the | X | x | X | correlation matrix R of outcomes at input points across the family of landscapes F. The positive definite covariance matrix R is defined with elements:

$${R}_{j , k} ≡ R ( {x}_{j} , {x}_{k} ) ≡ ( {f}_{i} ( {x}_{j} ) {f}_{i} ( {x}_{k} ) ) ≡ \frac{1}{n} {\sum }_{i = 1}^{n} {f}_{i} ( {x}_{j} ) {f}_{i} ( {x}_{k} )$$

To form the complete and orthogonal basis φ, the analysis component 104 diagonalizes R such that:

$$R ( x , {x}^{′} ) = {\sum }_{r = 1}^{{2}^{N}} {λ}_{r} {φ}_{r} ( x ) {φ}_{r} ( {x}^{′} )$$

The complete and orthogonal basis φ is called the principle component basis. The small number of φ vectors having the largest eigenvalues suffice to capture most of the features of R. In other words, n<<|X| so f defines a small subspace of R^{x}.

Many algorithms are known in the art to diagonalize a matrix to find the eigenvalues. Preferably, for large matrices, the analysis component 104 uses faster techniques such as the Lanczos methods to find the largest eigenvalues. The reconstruction of the landscapes using the principal component basis has the minimum squared reconstruction error.

After the analysis component 104 diagonalizes R, any function fₗ ε f can then be expanded in the n basis vectors which span this subspace having at most n dimensions as:

$${f}_{i} ( \vec{s} ) = {\sum }_{r = 1}^{n} {a}_{r}^{( i )} φ ( \vec{s} ) with {a}_{r}^{( i )} = \frac{{\sum }_{\vec{s}} {φ}_{r} ( \vec{s} ) {f}_{i} ( \vec{s} )}{{\sum }_{\vec{s}} {φ}_{r} ( \vec{s} ) {φ}_{r} ( \vec{s} )}$$

Preferably, the basis is ordered in decreasing order of the eigenvalues. From a computational viewpoint, finding these n basis vectors is considerably simpler than diagonalizing the entire |χ|x|χ| correlation matrix R_{x,x′}.

The principal component analysis representation of f offers a number of advantages. First, it is uncorrelated in the sense that

$$⟨ {a}_{r}^{( i )} {a}_{q}^{( i )} ⟩ = \frac{1}{n} {\sum }_{i = 1}^{n} {a}_{r}^{( i )} {a}_{q}^{( i )} = {λ}_{r} {δ}_{r , q}$$

Moreover the principal component analysis reconstruction using m<n basis vectors fₗ^{rec}(\vec{s})=Σᵣ₌₁^{m} aᵣ⁽ⁱ⁾φ(\vec{s}) has the minimum squared error Σ_{\vec{s}}(fₗ(\vec{s})−fᵢ^{rec}(\vec{s}))². The final advantage is that the principal component analysis basis is compact or sparse. Specifically, the principal component analysis basis has a much lower dimension since m<<|X|.

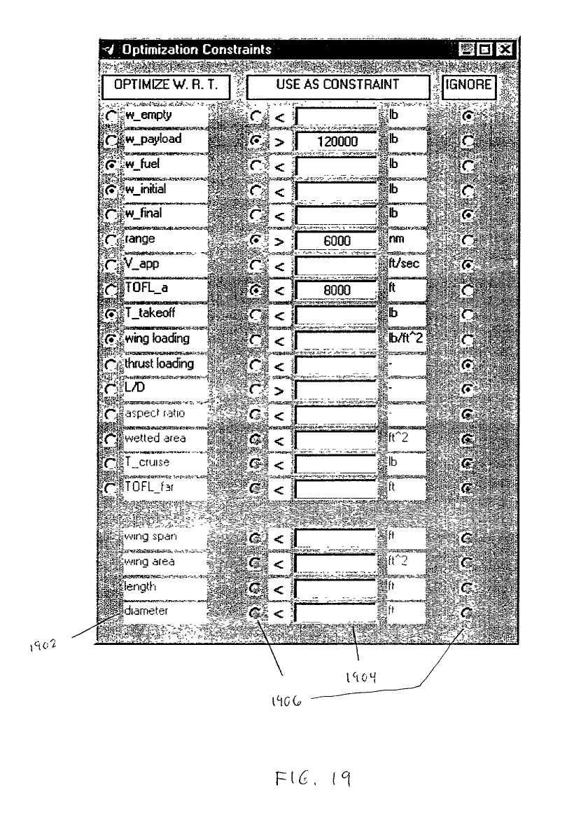

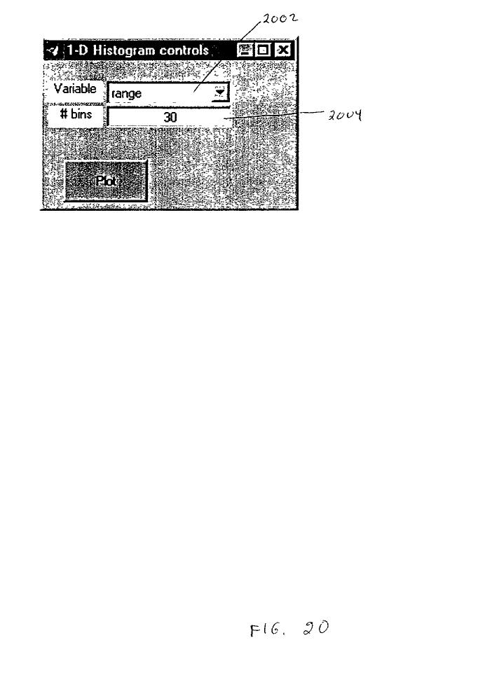

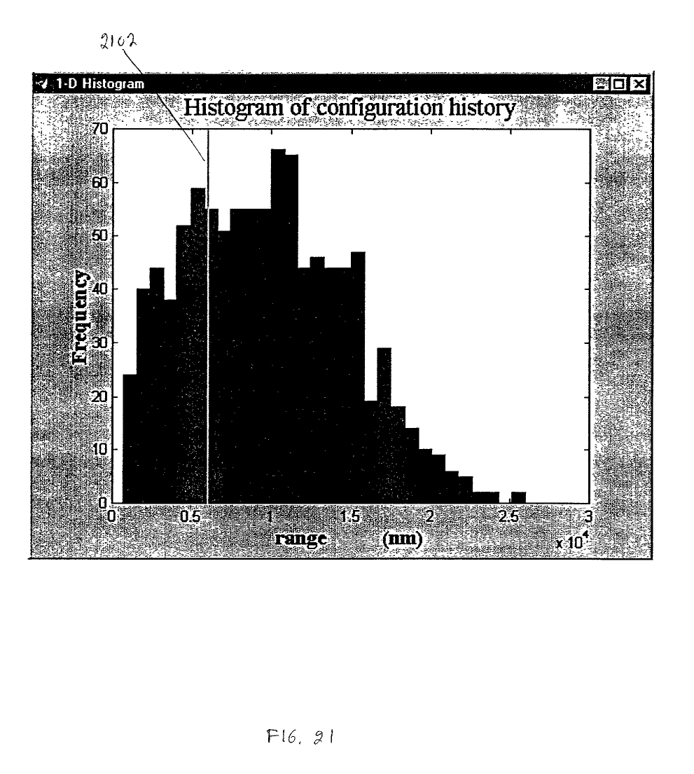

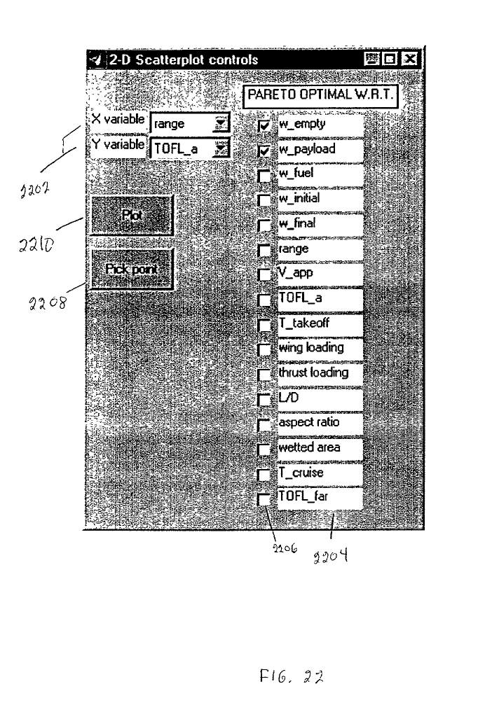

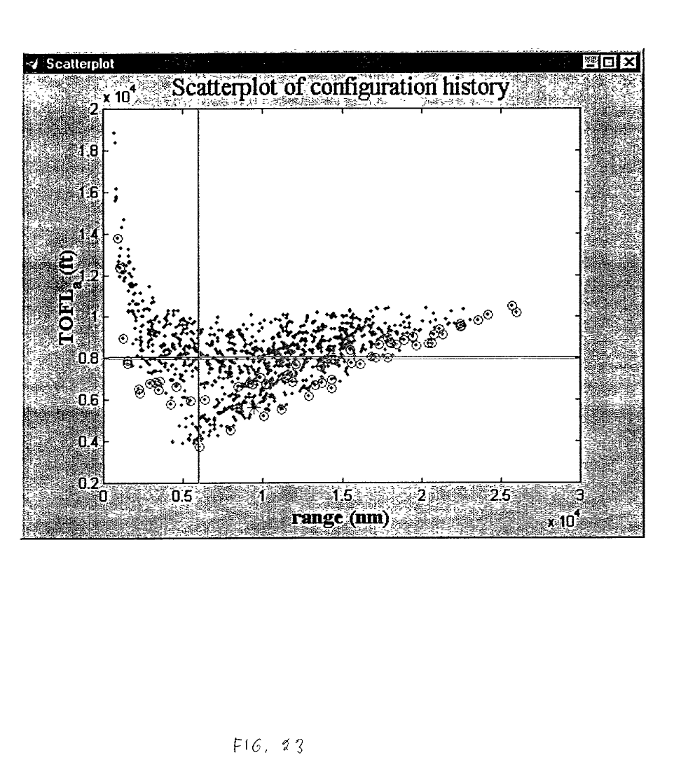

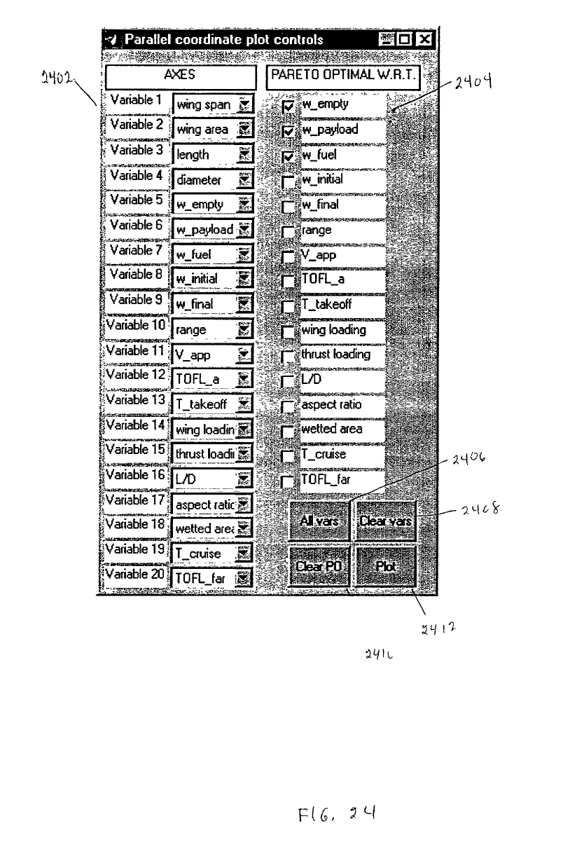

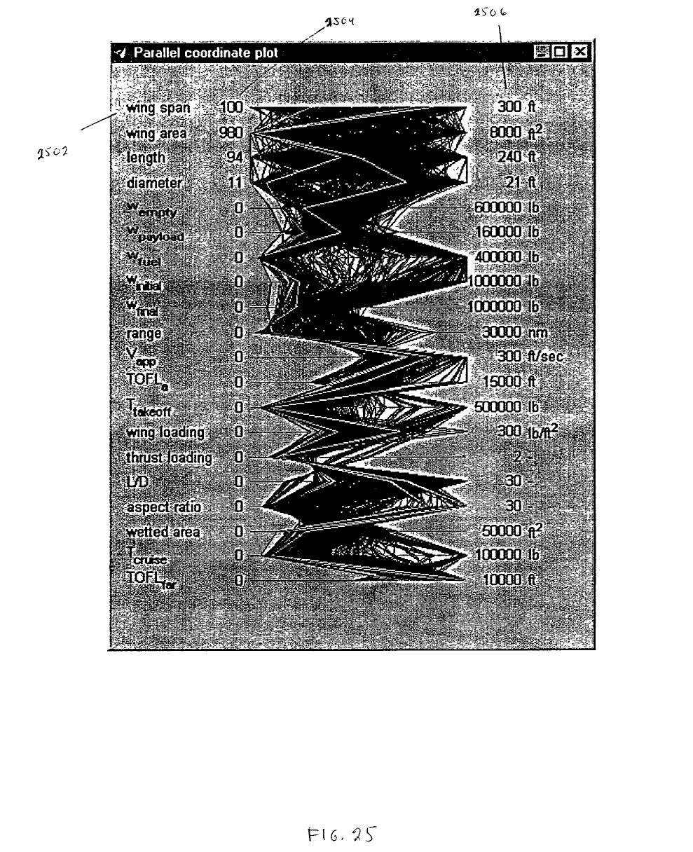

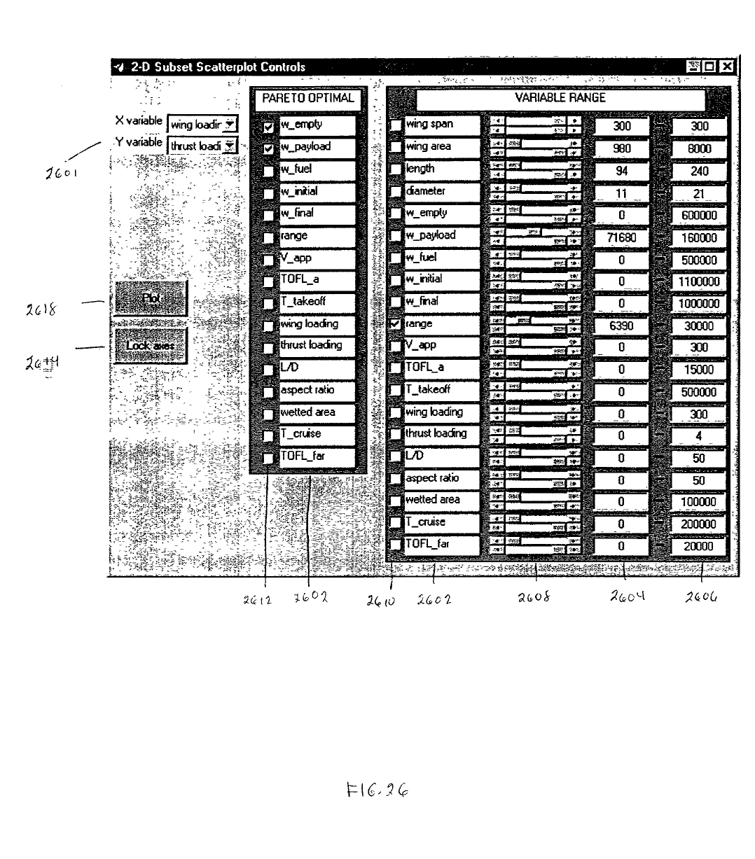

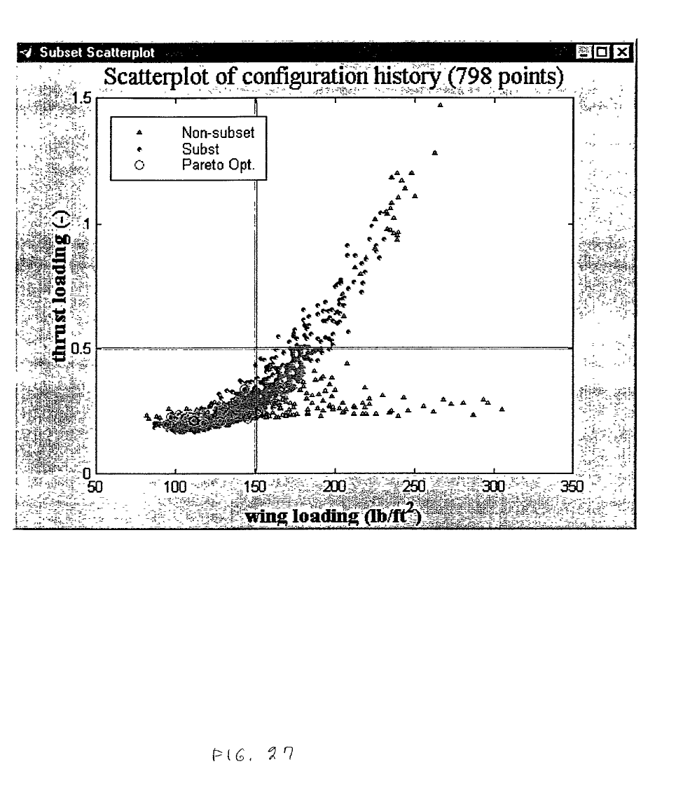

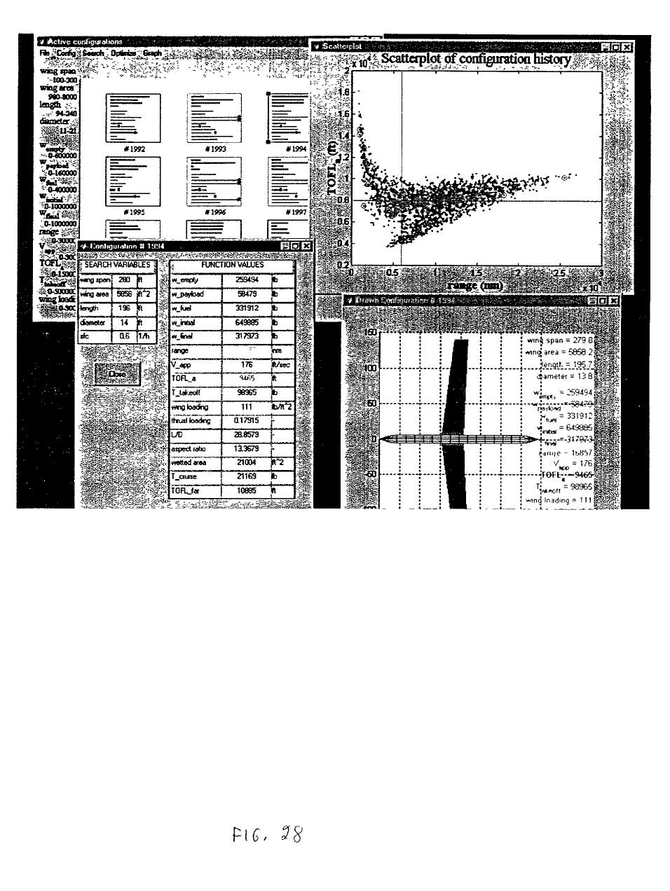

In the second and preferred approach for determining the bases φ={φⱼ} for landscapes illustrated by the flow diagram of FIG. 9, the analysis component 104 of United Sherpa 100 applies independent component analysis to discrete landscapes. Independent component analysis was first applied to visual image as described in, Olshausen, B A and D J Field, Emergence of simple-cell receptive field properties by learning a sparse code for natural images, Nature 381.607-609, 1996, the contents of which are herein incorporated by reference.

In step 902, the sparse bases method 900 randomly initializes φ ( basis. Specifically, the method 900 selects a random value for each element in the matrix with elements Φ_{k,l}=φₖ(x₁). In step 904, for the given φ basis as represented in the matrix Φ, the sparse bases method 900 minimizes the following energy function with respect to all the expansion coefficients a:

$$E ( a , φ \vert f ) = \frac{1}{n} {\sum }_{i = 1}^{n} \{ {\sum }_{\vec{s}} {[ {f}_{i} ( \vec{s} ) - {\sum }_{j} {a}_{j}^{( i )} {φ}_{j} ( \vec{s} ) ]}^{2} + λ {\sum }_{j} S ( {a}_{j}^{( i )} / σ ) \}$$

to determine a, where λ=2βσ².

When minimized, the function S biases the aⱼ⁽ⁱ⁾ towards zero to control the sparsity of the representation. Preferably, S decomposes into a sum over the individual expansion coefficients of the ith landscape. In an alternate embodiment, S is a function of all the expansion coefficients for the ith landscape, S(a^{(l)}). Consequently, the term

$${\sum }_{j} S ( {a}_{j}^{( i )} / σ )$$

forces the coefficients of the ith landscape towards zero. The scale of the aⱼ⁽ⁱ⁾ is set by normalizing them with respect to their variance across the family of landscapes, F.

The sparse bases method 900 balances the sparseness of the representation with the requirement that the selected basis reconstruct the landscapes in the family of landscapes, F as accurately as possible. Specifically, the term:

$${\sum }_{\vec{s}} {[ {f}_{i} ( \vec{s} ) - {\sum }_{j} {a}_{j}^{( i )} {φ}_{j} ( \vec{s} ) ]}^{2}$$

represents a squared error criterion for the reconstruction error. The balance between sparseness and accuracy of the reconstruction is controlled by a parameter λ. Larger values of λ favor more sparse representations while smaller λ favor more accurate reconstructions. In step 906, the sparse bases method 900 updates the basis vectors by updating the matrix Φ with the values of the expansion coefficients a which were determined by step 904. In step 908, the sparse bases method 900 determines whether convergence has been achieved. If convergence has been achieved as determined in step 908, the method 900 terminates in step 910. If convergence has not been achieved as determined in step 908, control returns to step 906.

The mathematical derivation of the energy function used in step 906 was motivated by the desire to balance the sparseness of the representation with the requirement that the selected basis reconstruct the landscapes in the family of landscapes, F as accurately as possible. From a probabilistic perspective, P(φ|F) was determined where φ is compact or sparse. This probability P(φ|F) is written as:

$$P ( φ \vert f ) = \frac{P ( F \vert φ ) P ( φ )}{P ( F )}$$

Given a basis φ, the likelihood of obtaining a landscape f is

P(f|φ)=∫da P(f|a, φ)P(a)

and so,

P(φ|f)≈P(φ)∫da P(f|a, φ)P(a)

Thus, P(φ), P(a) and P(f|a, φ) have to be expressed.

Since the landscapes are identical and independently distributed, the prior P(a) on the expansion coefficients is written as, P(a)=Πᵢ₌₁ⁿ P(a⁽ⁱ⁾). To impose some compression or sparsity, the prior P(a^{(l)}) is written as:

$$P ( {a}^{( i )} ) = {\prod }_{j} \frac{exp ⌊ - β S ( {a}_{j}^{( i )} / {σ}_{j} ) ⌋}{{Z}_{j}} .$$

Alternatively, with a little extra complexity, a different β is used for each basis function φⱼ.

This derivation assumes that the factors contributing to f after the correct basis has been determined are independent. The function S(.) is a function forcing the aⱼ to be as close to zero if possible. Preferably, S(x) is |x|. Alternative choices for S(x) include in [1+x²] and exp[−x²]. If the independence factorization of P(a) is given up, an additional alternative choice for S(x) is the entropy of the distribution Pᵢ=aₗ²/Σₗaᵢ². In an alternate embodiment, S(x) includes a bias in the form of a Gibbs random field.

Since the landscapes are generated by an independent and identically distributed process, the likelihood function can be written:

$$P ( f \vert a , φ ) = {\prod }_{i = 1}^{n} P ( {f}_{1} \vert {a}^{( i )} , φ )$$

where fₗ is the ith landscape in f. Because the basis φ may be overcomplete the likelihood of a landscape fₖ given a basis φ and a set of expansion coefficients a^{(l)} is expressed as

$$P ( {f}_{i} \vert {a}^{( i )} , φ ) = \frac{exp ⌊ - {\sum }_{\vec{s}} {( {f}_{i} ( x ) - {\sum }_{j} {a}_{j}^{( i )} {φ}_{j} ( \vec{s} ) )}^{2} / 2 {σ}^{2} ⌋}{{Z}_{f}}$$

Thus, the coefficients are selected to minimize the least squared error. Further, the maximum likelihood estimate for φ is:

φ*=argmax_{φ}P(f|φ)=argmax₁₀₀ ^{max} ₐP(f|a ,φ)P(a).

The maximum log-likelihood estimate, which is simpler to work with, is:

$$\begin{matrix}{φ}^{*} = {argmax}_{φ} \begin{matrix}max \\ a\end{matrix} ln ( P ( f \vert a , φ ) P ( a ) ) \\ = {argmax}_{φ} \begin{matrix}max \\ a\end{matrix} ln ( {\prod }_{i = 1}^{n} P ( {f}_{i} \vert {a}^{( i )} , φ ) P ( {a}^{( i )} ) ) \\ = {argmax}_{φ} \begin{matrix}max \\ a\end{matrix} ( {\sum }_{i = 1}^{n} ln P ( {f}_{i} \vert {a}^{( i )} , φ ) + ln P ( {a}^{( i )} ) )\end{matrix}$$

Substituting the specific forms for P(a) and P(f|a, φ) reduces to minimizing an energy function which is used in step 904 of the sparse bases method 900 shown in FIG. 9 and is defined by:

$$E ( a , φ \vert f ) = \frac{1}{n} {\sum }_{i = 1}^{n} \{ {\sum }_{\partial } {[ {f}_{i} ( \vec{s} ) - {\sum }_{j} {a}_{j}^{( i )} {φ}_{j} ( \vec{s} ) ]}^{2} + λ {\sum }_{j} S ( {a}_{j}^{( i )} / σ ) \}$$

where λ=2βσ².

Optimization

The analysis component 104 and optimization component 106 of United Sherpa 100 include techniques to identify the regime of a firm's operations management and to modify the firm's operations management to improve its fitness. The identification of a firm's regime characterizes the firm's ability to adapt to failures and changes within its economic web. In other words, the identification of a firm's regime is indicative of a firm's reliability and adaptability.

FIG. 10 shows the flow diagram of an overview of a first technique to identify a firm's regime. In step 1002, a firm conducts changes in its operations management strategy. For instance, a firm could make modifications to the set of processes which it uses to produce complex goods and services. This set of processes is called a firm's standard operating procedures. In addition, a firm could make modifications to its organizational structure. In step 1004, the firm analyzes the sizes of the avalanches of alterations to a firm's operations management which was induced by the initial change.

The definition of avalanches of alterations include a series of changes which follow from an initial change to a firm's operations management. For example, a firm makes an initial change to its operation management to adjust to failures or changes in its economic environment. This initial change may lead to further changes in the firm's operations management. Next, these further changes may lead to even further changes in the firm's operations management.

In the first regime called the ordered regime, the initial change to a firm's operations management causes either no avalanches of induced alterations or a small number of avalanches of induced alterations. Further, the avalanches of induced alterations do not increase in size with an increase in the size of the problem space.

In the second regime called the chaotic regime, the initial change to a firm's operations management causes a range of avalanches of induced alterations which scale in size from small to very large. Further, the avalanches of induced alterations increase in size in proportion to increases in the size of the problem space.

In the third regime called the edge of chaos, the initial change to a firm's operations management causes a power law size distribution of avalanches of induced alterations with many small avalanches and progressively fewer large avalanches. Further, the avalanches of induced alterations increase in size less than linearly with respect to increases in the size of the problem space. The edge of chaos is also called the phase transition regime.

The analysis component 104 and the optimization component 106 of United Sherpa 100 include algorithms to improve the fitness of a firm's operations management. These algorithms modify a firm's operations management in order to achieve the desired improvement. The fitness of a firm's operations management includes long term figures of merit such as unit cost of production, profit, customer satisfaction, etc. These modifications include shakedown cruises. Shakedown cruises are natural experiments including normal variations in a firm's standard operating procedures, the organizational structure, and the distribution of decision making authority within the organizational structure. The modifications also include purposeful experiments.

These algorithms must properly tune the scale of their modifications in order to achieve the desired improvement in the fitness of the firm's operations management. For instance, if the scale of the modifications of the natural experiments or purposeful experiments is too small, the firm will remain frozen in a region of the space of operations management solutions which is too small. Conversely, if the scale of the modifications of the natural experiments or purposeful experiments is too large, the firm will become too chaotic to adapt well to failures and changes in its economic web. However, if the scale of the modifications of the natural experiments or purposeful experiments is well tuned, the firm will search the space of operations management solutions efficiently and will settle into an optimal solution.

The algorithms to improve the fitness of a firm's operations management are applicable to both single objective optimization and multi-objective optimization. For multi-objective optimization with n component fitness functions, the algorithms attempt to attain a Global Pareto Optimal solution. In a Global Pareto Optimal solution, none of the component fitness functions can be improved without adversely effecting one or more other component fitness functions. If the attainment of a Global Pareto Optimal solution is not feasible, the algorithms attempt to find a good Local pareto Optimal solution. In a Local Pareto Optimal solution, none of the component fitness functions can be improved by an incremental modification to a neighboring operations management solution without adversely effecting one or more of the other component fitness functions. The definition of optimal includes good solutions which may not necessarily be the best solution.

An algorithm for improving the fitness of a firm's operations management is described in a co-pending provisional patent application, No. 60/103,128, titled, “A Method and System for Optimization of Operations Management using Production Recipes and Learning Curves” filed Oct. 2, 1998, the contents of which are herein incorporated by reference.

Additional algorithms for improving the fitness of a firm's operations management involving local reinforcement learning with patches, neighborhood definition and limits on the fraction of components (tau) which can change at a particular times are described in co-pending provisional application titled, “Method and system for Dynamic Load-based Control of Routing in Data Communication Networks and of Control of Other Systems” (Attorney Docket Number 9392-0023-888) the contents of which are herein incorporated by references. These algorithms are further described in co-pending provisional application, No. 60/118,174, titled, “A Method and System for Adaptive, Self-Configuring Resource Allocation in Distributed Systems”, the contents of which are herein incorporated by reference.

Fitness landscapes fall into three major categories in accordance with the characteristics of the landscape. FIG. 11 shows the flow diagram of an algorithm 1100 to move a firm's fitness landscape to a favorable category by adjusting the constraints on the firm's operations management. In other words, the algorithm of FIG. 11 makes it easier to find good solutions to a firm's operations management problems.

In the first category, none of the solutions represented on the fitness landscape representation of the operations management problem are acceptable solutions. In the second category, the fitness landscape representation contains isolated areas of acceptable solutions to the operations management problem. The second category is called the isolated peaks category. In the third category, the fitness landscape representation contains percolating connected webs of acceptable solutions. The third category is called the percolating web category.

In step 1102, the landscape adjustment algorithm 1100 identifies the characteristics of the landscape using one of a number of different techniques. For example, the landscape synthesis method 800 of FIG. 8 determines the hyper-parameters Θ=(Θ₁, Θ₂, Θ₃) for the covariance function C(x,x′ Θ). These hyper-parameters supply easily interpretable information about the landscape such as noise levels, the range of correlation, and the scale of fluctuation. Similarly, the sparse bases method 900 of FIG. 9 also characterizes landscape to identify their salient features.

FIG. 12a displays a flow graph of an algorithm which uses the Hausdorf dimension to characterize a fitness landscape. In other words, the algorithm 1200 of FIG. 12a represents the preferred method for performing the operation of step 1102 of the algorithm of FIG. 11. However, the present invention is not limited to the algorithm 1200 of FIG. 12a as alternate algorithms could be used to characterize a fitness landscape. In step 1202, the landscape characterization algorithm 1200 identifies an arbitrary initial point on the landscape representation of the space of operations management configurations. The method 1200 also initializes a neighborhood distance variable, r , and an iteration variable, i, to the distance to a neighboring point on the fitness landscape and to 1 respectively. In step 1204, the landscape characterization algorithm samples a predetermined number of random points at a distance, r * i. Step 1206 determines the fitness of the random points which were sampled in step 1204. Step 1208 counts the number of random points generated in step 1202 having fitness values which exceed a predetermined threshold. In other words, step 1208 counts the number of random points generated in step 1202 which are acceptable solutions. Step 1210 increments the iteration variable, i, by one. Step 1212 determines whether the iteration variable, i, is less than or equal to a predetermined maximum number of iterations. If the iteration variable, i, is greater than the predetermined maximum number of iterations, then control proceeds to step 1214. If the iteration variable, i, is less than or equal to the predetermined maximum number of iterations, then control returns to step 1204 where the algorithm 1200 samples a predetermined number of random points at the next successively higher distance from the initial point on the landscape. Accordingly, successive iterations of the loop of the flow diagram of FIG. 12a, counts the number of acceptable solutions on concentric shells at successively higher distances from the initial point in the landscape.

In step 1214, the method 1200 computes the Hausdorf dimension of the landscape for successive shells from the initial point on the landscape. The Hausdorf dimension is defined as the ratio of the logarithm of the number of acceptable solutions at distance (i+1) to the logarithm of the number of acceptable solutions at distance i.

The method 1200 computes the Hausdorf dimension for a predetermined number of randomly determined initial points on the landscape to characterize the fitness landscape. Specifically, if the Hausdorf dimension is greater than 1.0, then the landscape is in the percolating web category. If the Hausdorf dimension is less than 1.0, then the landscape is in the isolated peaks category.

Alternative techniques could be used to characterize fitness landscapes such as techniques which measure the correlation as a function of distance across the landscape. For example, one such technique samples a random sequence of neighboring points on the fitness landscape, computes their corresponding fitness values and calculates the auto-correlation function for the series of positions which are separated by S steps as S varies from 1 to N, a positive integer. If the correlation falls off exponentially with distance, the fitness landscape is Auto-Regressive 1 (AR1). For fitness landscapes characterized as Auto-Regressive 2 (AR2), there are two correlation lengths which are sometimes oriented in different directions. These approaches for characterizing a landscape generalize to a spectra of correlation points. See Origins of Order.

Exemplary techniques to characterize landscapes further include the assessment of power in the fitness landscape at different generalized wavelengths. As is known in the art, the wavelengths could be Walsh functions.

In step 1104 of the algorithm of FIG. 11, the fitness landscape is moved to a more favorable category by adjusting the constraints on the firm's operations management using the technology graph. For example, if the firm desires to be operating in the percolating web category and step 1102 indicates that the firm is operating in either the first category of landscapes which has no acceptable solutions or the isolated peaks category, step 1104 will modify the firm's operations management to move the firm to the percolating web category. Similarly, if the firm desires to be operating in the isolated peaks category and step 1102 indicates that the firm is operating in either the first category of landscapes or the percolating web regime, step 1104 will modify the firm's operations management to move the firm to the isolated peaks category.

Without limitation, the algorithm of FIG. 11 for moving a firm to more desirable category of operation is described in the illustrative context of moving the firm to the percolating web category. However, it will be apparent to one of ordinary skill in the art that the algorithm of FIG. 11 could also be used to move the firm to the isolated peaks regime within the context of the present invention which includes the creation and landscape representation of the environment, the characterization of the landscape representation, the determination of factors effecting the landscape characterization and the adjustment of the factors to facilitate the identification of an optimal operations management solution. Step 1104 moves the firm to the percolating web category using a variety of different techniques. First, step 1104 eases the constraints on the operations management problem. Specifically, step 1104 increases the maximum allowable makespan for technology graph synthesis. Increasing the allowable makespan leads to the development of redundant construction pathways from the founder set to the terminal objects as explained by the discussion of FIG. 6.

Preferably, step 1104 further includes the synthesis of poly-functional objects. Preferably, step 1104 further includes the selective buffering of founder objects and intermediate objects supplied by other firms. The identification of redundant construction pathways, the synthesis of poly-functional objects and the selective buffering of founder objects and intermediate objects supplied by other firms act to improve the overall fitness of the fitness landscape representation of the operations management problem. In other words, these techniques act to raise the fitness landscape.

Easing constraints and improving the overall fitness for operations management produce a phase transition from the isolated peaks category to the percolating web category as explained by analogy to a physical landscape. Picture the landscape representation as the Alps with a cloud layer which begins at the valley and rises to a particular height. The area above the cloud layer in the sunshine on the Alps corresponds to the subspace of acceptable solutions on the fitness landscape. The area in the cloud layer on the Alps corresponds to the unacceptable solutions on the fitness landscape. Further, assume in the analogy that a hiker is on the Alps. Assume that the hiker remains alive in the sunshine and dies either immediately after entering the cloud layer or after lingering in the cloud layer for a particular time period.

The first category of fitness landscapes corresponds to the situation where the cloud layer rises to a height above Mount Blanc, the highest point on the Alps. In this situation, the hiker cannot leave the cloud layer and dies. Accordingly, there are no acceptable solutions in the first category of fitness landscapes.

Easing constraints and improving the overall fitness for operations management causes a phase transition to the situation where a small number of high peaks on the Alps lies above the cloud layer in the sunshine. In other words the easing of constraints and the improvement of the overall fitness act to lower the cloud layer and raise the landscape in the analogy. In this situation, the hiker lives if he remains on one of the high peaks which lie in the sunshine. However, the hiker cannot travel from one of the high peaks to another of the high peaks because he must pass through the cloud layer to travel between high peaks. Accordingly, the second category of fitness landscapes contains isolated areas of acceptable solutions.

Continued easing of constraints and improvement of the overall fitness for operations management causes a phase transition to the third category of fitness landscapes corresponding to the situation where the cloud layer is sufficiently low and the landscape is sufficiently high to enable the development of connected or percolating pathways in the sunshine among the peaks. Accordingly, the third category of fitness landscapes contains connected pathways of acceptable solutions.

The movement to the third category of fitness landscapes represents a movement to a operations management solution which is more reliable and adaptable to failures and changes in the economic web respectively. For example, suppose that failures and changes in the economic web cause a shift in the fitness landscape underneath the hiker. If the hiker is operating in an isolated peaks category, the hiker will be plunged into a cloud and die. Conversely, if the hiker is operating in a percolating web category, the hiker can adapt to the failures and changes by walking along neighboring points in the sunshine to new peaks.

In the hiker analogy, the hiker represents a firm. The changing landscape represents changes in the economic environment of the firm. A hiker remaining in the sunshine represents a firm that can adapt to failures and changes in the economic environment while a hiker who falls into the clouds represents a firm that does not survive with changes in the economic environment.

The optimization component 106 of United Sherpa 100 comprises a set of heuristics to identify solutions for operations management having minimal cost or energy values. Solutions with low cost and energy values have high fitness values. FIG. 12b displays the flow graph representation of an optimization method 1250 which converts the optimization problem to density estimation and extrapolation. In step 1252, the density estimation and extrapolation method 1250 samples m points from an energy function. The energy function is defined as, f: x ε X→y ε Y where X is the space of solutions and Y is the space of energy values. Accordingly, the space of solutions X and the energy function f define an energy landscape.

Without limitation, the density estimation and extrapolation optimization method 1250 of the optimization component 106 of the present invention is described in the illustrative context of combinatorial optimization in which X is discrete and Y is continuous. However, it is apparent to persons of ordinary skill in the art that the density estimation and extrapolation optimization method 1250 is applicable whether X and Y are discrete or continuous.

In step 1254, the method 1250 represents Y as the union of intervals:

$$Y = {⋃}_{l} {I}_{l}$$

The intervals may overlap. Step 1254 groups the observed data, d={d^{x}, d^{y}} where d^{x} is the ordered set of sample x's and d^{y} is the ordered set of corresponding costs into c intervals where the ith interval i ε└0, . . . , c−1┘ includes energies e+iδ≦e<e+(i+1) δ and δ=(\overline{e}−e)/c. The density estimation and extrapolation optimization method 800 is applicable to both single objective optimization and multi-objective optimization. For multi-objective optimization with n cost functions, the intervals will be n-dimensional regions.

Preferably, step 1254 defines the intervals to smooth the time series of observed data, d={d^{x}, d^{y}}. Preferably, step 1254 slides the intervals with significant overlap to smooth the time series of observed data d={d^{x}, d^{y}}.

In step 1256, the method 1250 estimates the probability density function P_{I}_{ₗ}(x) representing the probability that an x ε X has cost within the ith interval: P_{I}_{ₗ}(x)=Prob{f(x) εIₗ}. Preferably, step 1256 performs parametric density estimation, P_{I}_{ₗ}(x|θ), by setting the parameters θ in accordance with the observed data d={d^{x}, d^{y}} using a learning algorithm.

Representing an input sequence space as x=x₁x₂ xₙ, the density P_{I}(x) can be factored as:

$${P}_{I} ( {x}_{1} … {x}_{n} ) = {\prod }_{i} {P}_{I} ( {x}_{i} \vert \{ {x}_{i} \} )$$

where {xₗ} is the set of variables upon which xₗ depends. The set of variables upon which xₗ depends could be empty. Preferably, step 1256 uses Bayesian network algorithms to learn both the sets {xₗ} and the specific form of the conditional densities P(xₗ|{xₗ}). If the cardinality of each of the sets is less than or equal to 1, then step 1256 executes algorithms with a computational complexity of O(n²) to solve this problem. These algorithms minimize the Kullbakc-Liebler distance between such a singly factored distribution to the distribution estimated from the data. Preferably, for the Bayesian trees, step 1256 represents each of the n conditional distributions in terms of unknown parameters. In the case of binary data, these parameters are pₗ and qₗ. If Pᵢ=P(xᵢ=1|{xᵢ}=0) and qᵢ=P(xₗ=1|{xₗ}=1) then:

P(xᵢ|{xₗ})=[pᵢ^{x}^{ₗ}(1−pₗ)^{1-x}^{ₗ}]^{{x}^{_{l}}}[qᵢ^{x}^{ₗ}(1−qₗ)^{1-x}^{ₗ}]^{1-{x}^{_{l}}}

Such expansions assuming the {xₗ} are typically called Chow expansions.

The approach for estimating the probability density function P(xᵢ|{xᵢ}) of step 1256 is incremental to enable easy improvement of the current estimate as new data becomes available. Further, it is easy to sample from the form of the probability density function P(xᵢ|{xᵢ}) of step 1256. This feature is useful since the discrete fitness landscape synthesis method 1250 needs to determine the x extremizing f.

In step 1258, the discrete fitness landscape synthesis method 1250 extrapolates the parameters θ from the known probability density function P_{I}_{ₗ}(x|d) to the unknown probability density function, P_{I*}(x). Step 1258 uses straightforward regression to extrapolate the parameters θ. The Chow expansion of step 1256 requires a dependency graph as input. If the dependency is assumed not to change across different intervals, then the regression problem becomes one of extrapolating the 2n−1 pₗ and qₗ parameters. Note that there are only 2n−1 parameters since one of the {xₗ} is empty. Preferably, step 1258 uses a standard lag method to do the extrapolation such that:

{pⱼ, qⱼ}_{I}_{ₗ}=F({pⱼ, qⱼ}_{I}_{ₗ₋₁},{pⱼ, qⱼ}_{I}_{ₗ₋₂}, . . . )

The number of lags of the standard lag method of step 1258 can vary. The extrapolation method of step 1258 models the imprecision of the parameters of the probability density function due to the effect of noise. Preferably, the extrapolation method of step 1258 models the imprecision of each parameter as a Gaussian error which is proportional to the number of samples used to estimate that parameter.

In step 1260, the method 1250 determines whether the interval I* contains a solution x ε X having an energy minima which is below a predetermined threshold. If the interval I* contains a solution x ε X having an energy minima which is below the predetermined threshold as determined in step 1260, then control proceeds to step 1262 where the method terminates. If the interval I* does not contain a solution x ε X having an energy minima which is below the predetermined threshold as determined in step 1260, control proceeds to step 1264.

In step 1264, the method 1250 generates data samples from within the interval I*, using the probability density function which was extrapolated for the interval I* in step 1258. After execution of step 1264, control proceeds to step 1258 where the discrete fitness landscape synthesis method 1250 extrapolates the parameters θ to determine the next unknown probability distribution function. Accordingly, the method 1250 iterates to find successively lower energy solutions.

The discrete fitness landscape synthesis method 1250 represents an improvement over conventional genetic algorithms. Conventional genetic algorithms discard data during their operation. For instance, they discard samples having a high cost. Similarly, conventional genetic algorithms use only a portion of the available data during their operation. For instance, the crossover operation of conventional genetic algorithms only uses pairwise combinations of data. In contrast, the discrete fitness landscape synthesis method 1250 uses all the data associated with a population of samples of the energy function to extract their statistical regularities. Next, the method 1250 determines how the regularities vary with cost and extrapolates them to the kind of regularities which are expected for lower cost values. The method 1250 probabilistically generates new points having the desired regularities using the extrapolated model. The method 1250 also uses samples having higher costs to incrementally improve the density estimate for higher intervals instead of simply discarding those samples.

Automated Market

The AM 108 operates to automate the exchange of resources among entities. Further, AMs 108 provide the mechanism by which transactions linking activities in processes are coordinated and algorithmic procedures based on computer models of the state of the firm optimize these transactions.

Without limitation, the Automated Market 108 will be described in the illustrative context of automated techniques for matching buyers and sellers of financial instruments. However, it will be apparent to one of ordinary skill in the art that the aspects of the embodiments of the Automated Market 108, which include defining properties for resources, finding matches among the properties to identify candidate exchanges, evaluating the candidate exchanges and selecting one or more of the candidate exchanges having optional value, are also applicable in other contexts.

Additional exemplary contexts for Automated Markets 108 include the scheduling of painting of automobiles or trucks within an automobile manufacturer as previously explained in the discussion of FIG. 3a and building climate control. Another exemplary context for Automated Markets 108 include the Internet, where economic agents bid in real time to advertise products and services to web surfers.

The AM 108 acts to broker deals based on information and preferences supplied by the participating entities such as economic agents. In one embodiment representing a distributed, dynamic system, the AM 108 includes rules of engagement using methods from game theory which allow for effective, dynamic negotiation in different domains. In this embodiment, the very process of bidding and asking by economic agents establishes the trades. The process of bidding and asking include the double aural auction. Computational agents representing economic agents have internal representations of the conflicting contingent and possibly non-comparable utilities within the economic agent.

In the preferred embodiment, the AM 108 includes computational agents which are programmed to act as surrogates for economic agents including human beings. This preferred embodiment represents the most direct translation from actual marketplaces within an economy to the automated market 108, a market emulation model.

In the preferred embodiment, the computational agents utilize one or more of a variety of techniques to determine optimal buying or selling strategies for the corresponding economic agent. These techniques include fixed algorithms and evolving algorithms. The techniques include algorithms such as genetic algorithms, genetic programming, simulated annealing, and adaptive landscape search algorithms. These algorithms operate in either a fixed strategy space or in an open but algorithmically specifiable strategy space. The algorithms search for buy or sell strategies which optimize either single or multiple utilities within the economic agents.

In the automated market 108, the computational agents representing economic agents can be tuned to rapidly find genuine fundamental price equilibrium. Alternatively, such agents can be tuned to exhibit speculative bubbles. Tuning from fundamental to speculative behavior may be achieved by tuning the mutation rate in the underlying genetic algorithm from low to high.

In the present invention, computational agents searching trade strategy space can be tuned in a variety of means in automated markets 108 to jointly find the analogue of fundamental price or to trade speculatively.

Preferable, the Automated Market 108 includes the ability to bundle orders and resources in order to meet the demand for large transactions. When possible, the Automated Market 108 automatically aggregates small orders to create additional liquidity in the market. This capability is very important for applications involving supply chain management. This capability is also important for other transactional boundaries in economic webs. For example, the Automated Market 108 will uses the bundling ability when a larger company in a supply chain requires more of a commodity than any single supplier can supply.

Similarly, the Automated market 108 will also bundle complementary products which are needed to produce a finished product. Specifically, the AM 108 can automatically bundle many complementary resources such as screws and screw drivers from many different suppliers together. Bundling with the automated market 108 can be thought of as a portfolio trade within the process. For certain exchanges, the automated market 108 performs pooling of suppliers to satisfy one large purchaser. For example, the automated market 108 will perform pooling of suppliers to satisfy one large purchaser in the graded diamond exchange. In contrast, pooling will not be appropriate for other markets. For example, pooling will not be appropriate for most exchanges because the buyers typically want a single point of contact.

In the preferred embodiment, the AM 108 receives trading preferences computed by the economic agents and an optimization engine within the AM 108 finds the trade which maximizes the preferences of the participating economic agents. Specifically, the AM 108 allows economic agents such as organizations and firms to anonymously submit terms of a favorable exchange. Upon receipt of the trading preferences from the economic agents, the AM 108 reconciles compatible buyers and sellers. All of the terms that need to be negotiated are specified privately in a manner that incorporates the flexibility and often non-comparable utilities of the organization. Further, none of the surfaces will be available for inspection or analysis by any other market participant, or any third party. Since the AM 108 has the ability to receive preferences from economic agents which privately specify the range over which they are flexible on various terms, the present invention allows the negotiation process to be automated without publicizing the internal state of the participating economic agents.

For the exchange of goods, these terms include price and quantity. Optionally, the terms could further include exchange location, exchange time, quality/purity descriptors, the current sequence of contracts, sales offers, and purchase offers and the future sequence of contracts, sales offers and purchase offers. For example, in the exchange of crude oil, the terms might include price, volume, delivery point, sulfur content, and specific gravity. The terms could also be contingent on the delivery of other contracts.

For the exchange of services, the terms include at least price and time. Further, the terms could also include other factors which are necessary to specify the service. For example, in the exchange of transportation services, the terms would include price, volume, weight, pickup time and location, and delivery time and location.

The Automated Market 108 receives multi-dimensional preference surfaces from the economic agents in the economy desiring to exchange a good or service. Economic agents use the multi-dimensional preference surface to specify their flexibility on the terms of the exchange. For example, a purchaser will not buy a good or service above a price specified on its multi-dimensional preference surface. Similarly, a seller will not sell a good or service below a price specified on its multi-dimensional preference surface. Accordingly, the multi-dimensional surface captures all the correlations between the terms of the economic agents seeking to participate in the exchange.

In general, there will be more than 3 terms that need to be negotiated on a particular exchange. When there are more than three terms, it will not be easy to visualize the preference surface. In this case, the preference surface is entered into the automated market 108 using multiple two or three-dimensional preference surfaces. Alternatively, the preference surface is entered using an equation or series of equations. In the preferred embodiment, an economic agent's operations management system automatically specifies the economic agent's preference surface by monitoring its status. Specifically, the modeling and simulation component 102, the optimization component 106 and the analysis component 104 of United Sherpa 100 operate to produce preference surfaces for the automated market 108 as shown in FIG. 1.

The automated market 108 matches buyers and sellers at published times. The frequency of this matching process will be at a time scale appropriate for the given market. For example, a market exchange for Boeing 777s will happen less frequently than a market exchange for Ford Taurus brake pads.

Buyer and seller surfaces scheduled for reconciliation at the time of a matching are committed. In other words, each buyer and seller is committed to accept any trade below or above their preference surfaces respectively. The automated market 108 analyzes these committed surfaces for overlapping regions. In general, for an exchange set up with N terms of negotiation, there will be an N-dimensional region of overlap between the surfaces for potential buyers and sellers.

The automated market 108 also has support for assigning priorities to the constituent factors of the preference surfaces. For example, in some market exchanges, the highest volume contracts will be matched up first, while in other market exchanges, the earliest transaction date contracts will be matched up first.

After analysis of a given matching period, the automated market 108 will prepare a list of the N negotiated terms for each match found. Next, the automated market 108 will notify each participant of the deal (if any) resulting from their submitted preference surface. Several different sets of terms may result from one matching period, but each market participant receives at most one match per committed preference surface. The automated market 108 also supports a set of rules governing the participation of the economic agents. For example, one set of rules establishes punitive damages for defaults on committed and reconciled deals.

As previously explained, the automated market 108 of the present invention can match buyers and sellers of stock portfolios. The optimization task is to maximize the joint satisfaction of buyers and sellers of stock portfolios. In other words, the optimization task determines the prices of all stocks involved in the transaction which will maximizing the joint satisfaction of the buyers and sellers. The link trader is the trader initializing a trade whether buying or selling. The contra trader is his partner (the seller if he is buying, or the buyer if he is selling). The Automated Market 108 seeks to achieve an optimal mutual or joint satisfaction of both the link trader S^{L} and the contra trader S^{C} wherein the definition of optimal includes high satisfaction which may not necessarily be the highest satisfaction. The satisfaction of each trader will depend on many terms including the price Pₗ and volume vₗ of each traded stock. If p and v denote n vectors of the traded stocks, the joint satisfaction S(p,v) is defined as:

S(p,v)=S^{L}(p,v)S^{C}(p,v)

In the most general setting we must optimize over many terms including prices p and volumes v to maximize the joint satisfaction. Without limitation, the Automated Market 108 will be described in the simplified illustrative context where it seeks to determine a vector of prices which achieves an optional joint satisfaction and the volumes are given (not to be determined). However, it will be apparent to one of ordinary skill in the art that the aspects of the embodiments of the Automated Market 108 are also applicable in contexts where the joint satisfaction is dependent on many terms. In the simplified context, the joint satisfaction is defined as:

S(p|v)=S^{L}(p|v)S^{C}(p|v) (9)

and the Automated Market 108 seeks to determine the optimal vector of prices achieving an optional joint satisfaction.

Any transaction may involve multiple stocks. If the link trader cares only about total costs, and there are n stocks, the total cost c to the link trader is

$$c = {\sum }_{1 \leq i \leq N} {p}_{i} {v}_{i} = p {}^{t} v .$$

Buying stock corresponds to positive volumes, vᵢ>0, and selling stock corresponds to negative volumes, vₗ<0. The prices, however, are always positive (i.e. Pₗ>0). Since the satisfaction of the link trader is a function of only the cost c

S^{L} (p|v)=S^{L}(c)=S^{L}(p^{t}v) (10)

The satisfaction profile for the link trader can be entered by the user by specifying the satisfaction at a set of m_{L}, distinct points {(C_{α}, S_{α}^{L})|α=1 . . . m} where Greek indices will be used to label input by the user to define profiles and Latin indices will be used for all other purposes. The points are indexed in order of increasing cost so that C_{α}>C_{α}, if α>α′. Piecewise linear interpolation is used to fill in the satisfaction elsewhere

$${S}^{L} ( c ) = {S}_{α}^{L} + \frac{{S}_{α + 1}^{L} - {S}_{α}^{L}}{{c}_{α + 1} - {c}_{α}} ( c - {c}_{α} )$$

points are indexed in order of increasing cost so that C_{α}>C_{α}, if α>α′. Piecewise linear interpolation is used to fill in the satisfaction elsewhere

$${S}^{L} ( c ) = {S}_{α}^{L} + \frac{{S}_{α + 1}^{L} - {S}_{α}^{L}}{{c}_{α + 1} - {c}_{α}} ( c - {c}_{α} )$$

where 1 ≦α≦m_{L} labels the largest cost value less than c. The satisfaction function typically will look like a Fermi function and be bounded between 0 and 1. It will be 1 for low costs, i.e c<c and 0 for high costs, i.e. c>\overline{c}, For c ε[c, \overline{c}], S^{L}(c) decreases monotonically with increasing c, i.e.

∂_{c}S^{L}(c)<0. (11)

The satisfaction of the contra traders is defined next. The Automated Market 108 allows for the possibility that the contra trader is different for each stock involved in the trade. Thus we define n contra satisfaction profiles {Sₗ^{c}|i=1 . . . n}. The satisfaction of the contra trader also depends on the volume of the stock transferred. For example, a seller may be willing to accept a lower price if the volume of stock sold is higher. Consequently, we write Sₗ^{C}(pₗ|vᵢ) to represent the satisfaction of the ith contra trader. The satisfaction profile for this contra trader is also a piecewise linear interpolant of prespecified points {(P_{α},S_{l,α}^{C}(v) )|α=1 . . . m_{C}} and thus, can be written as:

$${S}_{i}^{c} ( p \vert v ) = {S}_{i , α}^{c} ( v ) + \frac{{S}_{i , α + 1}^{c} ( v ) - {S}_{i , α}^{c} ( v )}{{p}_{α + 1} - {p}_{α}} ( p - {p}_{α} )$$

where ≦α≦m labels the largest price less than p. As before, α indexes the user-input points in order of increasing price. If vₗ>0 the contra trader is selling stock so that Sₗ^{C}(pₗ|vₗ>0) always has positive slope, i.e ∂ₚ_{ₗ}Sᵢ^{C}(pₗ|vₗ>0)>0. Similarly, if vᵢ<0 then the contra trader is buying stock so that ∂ₚ_{ₗ}Sₗ^{C}(pₗ|vᵢ<0)<0. In either case Sₗ^{C}(pᵢ|vᵢ) is a monotonic function of Pᵢ and:

Using Eqs. (10) and (13) in Eq. (9), the optimization task is to determine:

$${p}^{*} = arg {max}_{p} {S}^{L} ( p {}^{t} v ) {\prod }_{1 \leq i \leq n} {S}_{i}^{c} ( {p}_{i} \vert {v}_{i} ) .$$

If

S^{L}(p^{t}v)=exp[−s^{L} (p^{t}v)] and Sₗ^{C}(pₗ|vₗ)=exp[−s^{C}(pₗ|vₗ)]

where s^{L}(p^{t}v)=−1n[S^{L}(p^{t}v)] and s^{C}(pᵢ|vₗ)=−1n[S^{C}(pₗ|vₗ)] then

$${p}^{*} = arg {min}_{p} ⌊ {s}^{L} ( p {}^{t} v ) + {\sum }_{1 \leq i \leq n} {s}_{i}^{c} ( {p}_{i} \vert {v}_{i} ) ⌋ ≡ arg {min}_{p} s ( p \vert v ) .$$

In this form it is evident that the only coupling between the Pₗ comes through the first term involving p^{t}v. At a minimum, ∇ₚs(p|v)≡∇s (p)=0 so that

vₗ∂ₚ_{ₗ}s^{L}(p^{t}v)+∂ₚ_{ₗ}sᵢ^{C}(pₗ|vₗ)=0 (14)

From Eqs. (11) and (12):

∂_{c}s^{C}(c)>0 and vᵢ∂ₚ_{ₗ}sᵢ^{L}(pₗ|vₗ)<0

so that a solution ∇ₚS(p|v) always exists. Note that the gradient, Eq. (14), is extremely simple to evaluate. Moreover, the gradient can be found very quickly since all the terms ∂ₚ_{ₗ}Sᵢ^{C}, can be evaluated in parallel.

Next, a possible minimization algorithm based on a decomposition method is described. The joint satisfaction s(p|v)=s^{L}(p^{t}v)+Σ_{1≦i≦N} Sᵢ^{C}(pᵢ|vₗ) can be written as:

$$s ( p \vert v ) = {\sum }_{1 \leq j \leq N + 1} {f}_{j} ( {x}_{j} )$$

where the new coordinates are xⱼ=pⱼ for jε[1, N] and x_{N+1}=Σ1≦j≦Nxⱼvⱼ and the new functions are ƒⱼ(xⱼ)=sⱼ^{C}(xⱼ|vⱼ) for jε[1, N] and ƒ_{N+1}(x_{N+1})=S^{L}(x_{N-1}). Thus, we have a constrained optimization problem:

$$minimize {\sum }_{l \leq j \leq N + 1} {f}_{j} ( {x}_{j} )$$

$$subject to - {x}_{N + 1} + {\sum }_{l \leq j \leq N} {χ}_{j} {v}_{j} = 0.$$

The only coupling between variables comes through the constraint. Introducing a single Lagrange multiplier for the constraint the Lagrangian for this problem is

$$L ( {x}_{j} λ ) = {\sum }_{1 \leq j \leq N + 1} {f}_{j} ( {x}_{j} ) + λ {a}^{t} x ≡ {\sum }_{1 \leq j \leq N + 1} {L}_{i} ( {x}_{i} , λ )$$

where Lₗ(xₗ, λ)=ƒₗ(xₗ)+λaₗxₗ and aᵢ=vᵢ for iε[1, n] and aₗ₊₁=−1. In this form, the problem is ideal for minimization using Lagrangian relaxation.

For a given λ, say λₜ, the minimization of L(x,λₖ) is very easy since it decomposes into N 1-dimensional minimizations: minₓ L (x, λₜ)=Σ_{1≦l≦N}minₓ_{ₗ}Lₗ(Xₗ, λₜ). Moreover, each minimization can be done in parallel. In this way we obtain a solution xₜ=x(λₜ). The dual problem which determines the multiplier λ is:

$${max}_{λ} L ( x ( λ ) , λ ) ≡ {max}_{λ} q ( λ ) .$$

Maximizing this function using steepest ascent requires the gradient of the dual function q(λ):

$${\partial }_{λ} q ( λ ) = a {}^{t} x + {\sum }_{1 \leq j \leq N + 1} ( {\partial }_{{x}_{i}} {f}_{j} ( {x}_{i} ( λ ) ) + λ {a}_{j} ) {\partial }_{λ} {x}_{j} = a {}^{t} x .$$

As noted in the last step since xₗ(λ) minimizes Lᵢ(xₗ, λ) this gradient is zero. Thus using steepest ascent the Lagrange multiplier can be updated as

λₜ₊₁=λₜ+αa^{t}x(λ).

where α is the step size. This algorithm will converge to a local λ peak.

It may be the case that q(λ) is not a convex function, but we know that for the global optimum of the constrained problem the multiplier λ* satisfies

λ*=arg max_{λ}q(λ)

so that a global optimization technique like simulated appealing could be used to determine λ* and thereby the globally optimal x. Note that the dual function q(λ) is not a direct function of λ but indirect through the determination of x(λ). Fortunately, x(λ) can be evaluated extremely rapidly in parallel. Also, it may be the case that q(λ) is convex.

The efficiency of the above method requires quick optimization of Lₗ(xₗ, λ)=ƒₗ(xᵢ)+λaᵢxᵢ. Next, a good analytic estimate for the minimum of Lᵢ as a function of λ* and the satisfaction function is developed. For the case where the satisfaction function represents the preferences of a buyer so that the satisfaction function is a monotonically decreasing function of x.

The satisfaction function of the ith trade is represented analytically as a Fermi function, sᵢ(xᵢ) (exp (βₗ(x−μₗ))+1)⁻¹. The parameters βₗ and μₗ can be related to cₗ and \overline{c}ₗ by μ=(cₗ+\overline{c}ₗ)/2 and βα\overline{c}ₗ−cₗ. With these assumptions,

$${L}_{i} ( {χ}_{i} , λ ) = - ln ⌊ \frac{1}{exp ( {β}_{i} ( {x}_{i} - {μ}_{i} ) ) + 1} ⌋ + λ {a}_{i} .$$

This function is minimized by

$${χ}_{i} = {μ}_{i} + \frac{1}{{β}_{i}} ln ⌊ \frac{λ {a}_{i}}{{β}_{i} - λ {a}_{i}} ⌋ .$$

Once β and μ have been estimated the above formula will serve as a good starting point for a Newton's method.

The next natural extension is the case in which volumes are not fixed but are also optimized along with the price. The problem remains the same except that now the constraint is a quadratic function of the variables. As is known in the art, there are a number of obvious ways to extend Lagrangian relation. In the preferred embodiment, we need to minimize S(p,v) where we have an effective tool to minimize S(p,v) for any fixed volume. Thus, a general technique to solve the general problem might be to initialize some guess for v and then solve for the best prices. At that new point (p,v), calculate the gradient ∇ᵥS(p,v) and update the volumes accordingly, e.g. by steepest descent vₜ₊₁=vₜ−∇ᵥ(pₜ,vₜ). Note that ∇ᵥS(p,v) is very easy to calculate since it only enters into the link trader's satisfaction.

An application of the automated market 108 is to match producers who have an opportunity to move product with distribution service providers. For example, the automated market 108 could be used for a distribution service provider to sell excess trucking capacity (e.g., that available on a return route) at a discount for a petrochemical supply chain.

Allowing for two-way bidding, the automated market 108 receives both service requests from producers and service offers from distribution service providers and clears the market for services at regular, published intervals. A request or an offer is associated with a specific clearing time. The automated market 108 evaluates and ranks various requests and offers. A match-up between requests and offers is automatically conducted in connection with the rankings of the requests and offers.

While the application of the automated market 108 to the exchange of servers will be explained within the context of trucking industry, it is apparent to one of ordinary skill in the art that the automated market 108 can be applied to any request-offer match-ups that would benefit from the consideration of such factors. For example, the automated market 108 is also applicable to other transportation businesses including trains and ships.

FIG. 13a provides a diagram showing the major components of the proposed automated market 108 for matching service requests with service offers. The automated market 108 includes a producer communication system 1301, through which prospective producers communicate their requests, a service provider communication system 111, through which prospective service providers communicate their offers, a central hub 1321, which communicates with the producer communication system 1301 and the service provider communication system 111 to automatically gather information on the preferences associated with the requests and offers, and a storage system 1361.

The storage system 1361 includes a request weighting system 1331, an offer weighting system 1341, and a pricing system 1351. The request weighting system 1331 stores the weighting factors to analyze the preferences associated with a request. Similarly, the offer weighting system 1341 stores the weighting factors to analyze the preferences associated with an offer. All the weighting factors can be updated in response to the changes in the industry. The pricing system 1351 keeps the formula that is used in calculating the price of a service. The formula can also be updated in response to the changes in the industry.

The producer communication system 1301 elicits information from producers by transmitting “request fill-out forms” to a plurality of computer terminals 102. The terminals 1302 display these forms to producers, thereby instructing producers to supply information about their requests. Preferably, the format of the request fill-out forms is specified with the HyperText Markup Language (HTML).

The request fill-out forms displayed at terminals 1302 ask a producer to supply information regarding the preferences associated with a request. For example, a producer might have some volume of product at point A (whose shipment has not yet been contracted), and be able to make money by moving it to points B, E, or F. The preferences would contain, but would not be limited to, the following data:

1. Material type (with check boxes for special handling requirements);

2. Maximum total volume available at point A;

3. Minimum volume to ship from point A;

4. Earliest pickup time from point A (Later, this could be specified as a list of times and volumes available at those times.)

5. For each destination (B, E, F):

a) Minimum worthwhile volume to that destination;

b) Maximize volume to that destination;

c) Latest delivery time for that destination (Again, this could be specified as a list of acceptable delivery times and acceptable volume ranges.)

In addition, the producer would specify the maximum price acceptable for any of the combinations of transportation services that meet the requirements above. Producer prices can be entered as mathematical formulas which depend on several factors, for example:

1. Volume to ship to each destination;

2. Weight to ship to each destination;

3. Pickup time;

4. Delivery time.

The producer communication system 1301 includes a quality controller 1304, which processes the data to ensure date continuity, destination validity, and miscellaneous data accuracy. For example, when a producer inputs departure and arrival dates for a requested shipment, the controller compares the departure date with the arrival date to assure that the producer did not mistakenly specify an arrival date which is prior to the departure date.

The producer communication system 1301 also includes a request locker 1306. After gathering information from a producer, the request locker 1306 sends a request summary review to terminals 1302 for display to the producer. The request summary review provides a summary of all request preferences, including dates, times, destinations, and the maximum price. The producer can modify the request. Once the producer confirms the request, the request locker 1306 activates the request and sends it to the central hub 1321 to prepare for finding a match.

The service provider communication system 111 is similar in structure to the producer communication system 1301. The service provider communication system 111 elicits information from providers by transmitting “offer fill-out forms” to a plurality of computer terminals 1312. The terminals 1312 display these forms to providers, thereby instructing providers to supply information about their offers. Similarly, the format of the offer fill-out forms is preferably specified with HTML.

The offer fill-out forms displayed at terminals 1312 ask a provider to supply information regarding the preferences associated with an offer. For example, a provider would likely specify vehicle capabilities, including volume, weight, special handling capabilities, and state of cleanliness. Also, the provider would specify the time and location to start. When a particular vehicle has prescheduled obligation, the provider would need to specify the time and location the vehicle needs to be. The producer would specify the minimum price acceptable for a particular service. Provider prices can be entered as mathematical formulas which depend on several factors, for example:

1. Volume to ship;

2. Weight to ship;

3. Time to ship;

4. Distance to ship.

Also, when a vehicle is used on a return-route, under consideration are the incremental distance to perform the service (the distance between the place where the vehicle becomes available after satisfying a previous obligation and the place where the current service starts at) and the incremental time to perform the service.

In addition, other factors, such as the number of nights and the number and type of border crossing, could be included for the total journal, the actual shipment, or on an incremental basis.

The service provider communication system 111 includes a quality controller 1314, which processes the data to ensure date continuity, destination validity, and miscellaneous data accuracy. For example, when a provider inputs departure and arrival dates for an offered shipment, the controller compares the departure date with the arrival date to assure that the provider did not mistakenly specify an arrival date which is prior to the departure date.

The service provider communication system 111 also includes an offer locker 1316. After gathering information from a provider, the offer locker 1316 sends an offer summary review to terminals 1312 for display to the provider. The offer summary review provides a summary of all offer preferences, including dates, times, destinations, and the minimum price. The provider can modify the offer. Once the provider confirms the offer, the offer locker 1316 activates the offer and sends it to the central hub 1321 to find a match with a request.

The central hub 1321 includes a request ranking system 1322, an offer selecting system 1324, a matching system 1326, and a contracting system 128. The request ranking system 1322 collects and prioritizes requests by examining the preferences associated with each of the requests against the criteria stored in the request weighting system 1331. The most important criterion may be the maximum price specified in the request. For example, in requesting an identical service, the request with the highest maximum price may receive the highest priority. The maximum price can be defined in terms of price per truck-mile. In this case, the primary ranking criteria, listed in decreasing importance, may be:

1. Price per truck-mile (the higher the price, the higher the priority;)

2. Route length (the longer the length, the higher the priority;) and

3. Time of request submission (the earlier the time, the higher the priority.)

After the examination, the request ranking system 1322 constructs a prioritized list of requests, with the request with the highest priority listed first and the request with the lowest priority listed last. Each request is attempted a match in the order of the priority, starting from the request with the highest priority.

The offer selecting system 1324 collects offers. For a particular request, the offer selecting system 1324 identifies all available offers which satisfy the preferences associated with the request. The availability of an offer includes a list of factors. For example, once being matched with a request, an offer becomes unavailable to other requests. Also, if the minimum price specified in an offer is higher than the maximum price specified in the request, the offer does not satisfy the preferences of the request and is therefore not available for the request.

The matching system 1326 prioritizes the available offers that have been identified to satisfy the preferences of the particular request by examining the preferences associated with each of these offers against several criteria stored in the offer weighting system 1341. The most important criterion may be the minimum price specified in the offer. For example, in offering an identical service, the offer with the lowest minimum price in the preferences may receive the highest priority. The minimum price can be defined in terms of price per truck-mile. In this case, the primary ranking criteria, listed in decreasing importance, may be:

1. Price per truck-mile (the lower the price, the higher the priority;)

2. Route length (the longer the length, the higher the priority;) and

3. Time of request submission (the earlier the time, the higher the priority.)

After examining these offers, the matching system 1326 finds the offer with the highest priority and matches the offer with the particular request. For each matched pair of offer and request, the corresponding provider and producer are contractually bound. The providers and producers who fail to find a match for their offers and requests for the particular clearing time are released of any contractual obligations. They can delete their requests and offers from the system, or they can save and store in the system their requests and offers, which can be used, after necessary modification, for a later clearing time. After being matched with a request, an offer is no longer available for other requests.

The contracting system 1328 determines the contracting price for the matched request and offer concerning the service to render. The contracting price will be set, using an algorithm specified in the pricing system 1351, at a dollar amount that is equal to, or lower than, the maximum price specified by the producer. At the same time, the dollar amount will be equal to, or higher than, the minimum price specified by the provider. The contracting price will be adjusted slightly to allow for a nominal commission for arranging the deal.

FIG. 13b provides a dataflow diagram representing the operation of the automated market 108. When using the automated market 108, a user (a producer or a provider) must login to the system. The automated market 108 performs a user name and password verification as a condition to accessing the system.

After login by a user, the automated market 108 displays a main navigation menu. The main navigation menu includes options to submit a request and to submit an offer. The main navigation menu also includes options to view pending and past requests or offers, to modify a request or an offer, and to repeat a request or an offer. The user initiates a request or an offer submission using an appropriate link on the main navigation menu.

In step 1352, the central hub 1321 sends request fill-out forms to a terminal at the producer communication system 1301. The terminal displays these forms as preferences data collection screens. The terminal then reads the preferences data specified on the screens by the producer. The preferences data include, for example, the maximum price the producer is willing to pay, the type of the material and the amount to ship, and the time, the date and the departure and arrival locations of the service.

Similarly, in step 1354, the central hub 1321 sends offer fill-out forms to a terminal at the provider communication system 111. The terminal displays these forms as preferences data collection screens. The terminal then reads the preferences data specified on the screens by the provider. The preferences data include, for example, the minimum price the provider is willing to accept, the capabilities of the provider's vehicles, and the times, the dates and the locations the vehicles will be available.

In step 1356, the automated market 108 merges the terminals 102, the quality controller 1304, and the request locker 1306. After step 1356, the automated market 108 displays a request summary review at the producer's computer at the producer communication system 1301 for the producer to confirm. At the same time, the automated market 108 displays the errors, if any, in the request. For example, the automated market 108 would warn the producer if the arrive time specified in the request is prior to the departure time. At this point, the producer can confirm or modify the preferences associated with the request.

Similarly, in step 1358, the automated market 108 merges the terminals 1312, the quality controller 1314, and the offer locker 1316. After step 1358, the automated market 108 displays an offer summary review at the provider's computer at the provider communication system 1311 for the provider to confirm. At the same time, the automated market 108 displays the errors, if any, in the offer. For example, the automated market 108 would warn the provider if the arrive time specified in the offer is prior to the departure time. At this point, the provider can confirm or modify the preferences associated with the offer.

In step 1360, the automated market 108 merges the request ranking system 1322 and the request weighting system 1331. The automated market 108 loops through all the requests and sorts the requests into a prioritized list, with the request with the highest priority listed first and the request with the lowest priority listed last. The rating of the priority is based on the preferences associated with the request and the information stored in the producer weighting system 1331 which assign different weighting factors to different specifics in the preferences associated with the request. For example, in requesting an identical service, the request with the highest maximum price may receive the highest priority, because the maximum price is an important preference and is likely to be assigned a significant weighting factor.

In step 1362, the automated market 108 merges the offer selecting system 1324 and the offer weighting system 1341. The automated market 108 loops through the prioritized list of the requests and finds a match for each request, one at a time and in the order of the priority starting from the request with the highest priority. For each particular request, the automated market 108 identifies all available offers that satisfy the preferences associated with the particular request. The availability of an offer includes a list of factors. For example, once being matched with a request, an offer becomes unavailable to other requests. Also, if the minimum price specified in an offer is higher than the maximum price specified in the request, the offer does not satisfy the preferences of the request and is therefore not available for the request. Next, the automated market 108 calculates a priority rating score, in a loop, for each of the available offers identified to satisfy the preferences associated with the particular request. The rating of the priority is based on the preferences associated with each of the offers and the information stored in the offer weighting system 1341 which assigns different weighting factors to different specifics in the preferences associated with an offer. For example, in offering an identical service, the offer with the lowest minimum price may receive the highest priority, because the minimum price is an important preference and is likely to be assigned a significant weighting factor. The offer with the highest priority rating makes the match with the particular request.

After step 1362, the offer that has been matched with a request is no longer “available” to other match attempts. All other offers remain available for the next match attempt.

In step 1364, the automated market 108 merges the contracting system 1328 and the pricing system 1351. For the contract between the producer and provider of the matched request and offer, the automated market 108 calculates the price of the service from factors such as volume to ship, weight to ship, time to ship, and distance to ship, according to the formula stored in the pricing system 1351. The price is to be equal to, or lower than, the maximum price specified by the producer and equal to, or higher than, the minimum price specified by the provider.

User Interface

FIG. 14 is a flow diagram for a method of using the interface 120 to United Sherpa 100 to perform optimization. In step 1202, the user issues a design entry command. The design entry command causes United Sherpa 100 to display a design entry window in step 1404. Execution of step 1404 by United Sherpa 100 yields the design entry window 1405. In step 1406, the user manipulates the design entry controls on the design entry window 1405. Execution of step 1406 yields a definition of variables, objectives and constraints 1407.

In step 1408, the user issues a design output command. Execution of the design output command causes United Sherpa 100 to display the design output window in step 1412. Execution of step 1412 by United Sherpa 100 yields the design output window 1413. In step 1414, the user manipulates the design output controls on the design output window 1413. Execution of step 1414 by the user yields a solution format 1415.

In step 1418, the user issues a display output command 1416. Execution of the display output command causes United Sherpa 100 to display solutions in step 1418. Execution of step 1418 by United Sherpa 100 yields the solutions display 1419.

In step 1420, the user determines whether the solution format 1415 should be changed. If the user determines that the solution format 1415 should be changed in step 1420, control proceeds to step 1422. In step 1422, the user selects a design output window. Execution of step 1422 causes United Sherpa 100 to display the design output window in step 1412.

If the user determines that the solution format 1415 should not be changed in step 1420, control proceeds to step 1424. In step 1424, the user determines whether the definition of variables, objectives and constraints 1407 should be changed. If the user determines that the definition of variables, objectives and constraints 1407 should be changed in step 1424, control proceeds to step 1426. In step 1426, the user selects a design entry window. Execution of step 1426 causes United Sherpa 100 to display the design entry window in step 1404.

Without limitation, the following embodiments of the user interface 120 of United Sherpa 100 including the design entry window 1405, the design output window 1413 and the solutions display 1419 are described in the illustrative context of a commercial passenger jet configuration. However, it will be apparent to persons of ordinary skill in the art that the aspects of United Sherpa 100 and the user interface 120 including the manipulation of design entry controls to define variables, objectives and constrains, optimization, manipulation of design output controls to define a format for the solutions and the display of the solutions are also applicable to any single or multi-objective optimization problem such as supply chain management, job shop scheduling, flow shop management, organizational structure design and logistics.

The commercial passenger jet design problem can include the variables as listed and defined in the following table:

| Variable | Definition |
|---|---|
| wing span | distance from wing tip to wing tip |
| wing area | surface area of wing |
| Length | fuselage length |
| Diameter | fuselage diameter |
| w_empty | empty weight of plane |
| w_payload | maximum payload (passengers + baggage) |
| w_fuel | weight of fuel |
| w_initial | weight at takeoff (empty + fuel + payload) |
| w_final | weight at landing (empty + payload) |
| range | maximum distance plane can travel - in nautical |
| | miles (nm) |
| V_app | minimum velocity at which plane approaches |
| | runway for landing |
| TOFL_a | takeoff field length, minimum runway length |
| | needed for takeoff |
| T_takeoff | thrust per engine needed for takeoff |
| wing loading | maximal force per unit area on wings |
| thrust loading | maximum thrust generated per engine |
| L/D | lift to drag ratio while cruising |
| aspect ratio | ratio of wing span to average wing width |
| wetted area | surface area inducing air friction |
| T_cruise | thrust per engine while cruising |
| TOFL_far | takeoff field length, FAA required runway |
| | takeoff length |
| sfc | specific fuel consumption |

In the context of the commercial jet design problem, the solutions to the optimization problem include different design configurations.

FIG. 15 shows a first sample design entry window 1405. In the preferred embodiment, the first sample design entry window 1405 includes design entry controls to define the design. The design entry controls include fields to identify objectives 1502 and their associated constraints 1504. Constraints 1504 can include lower bounds and upper bounds. For example, FIG. 15 indicates that the objective 1502 w_payload must be greater than 30000 lb. Constraints 1502 may also include goads. In addition to the identification of objectives 1502, the first sample design entry window 1405 could also include fields to identify variables and their associated constraints 1504.

FIG. 16 shows a first sample solutions display 1419 called the active configurations screen. In the preferred embodiment, the active configurations screen includes icons 1602 representing configurations. Exemplary icons 1602 include rectangles as shown in FIG. 16. The center portion of the active configurations screen is initially blank and fills with icons 1602 as the user examines new configurations. The active configurations screen includes a scroll feature to enable the user to examine icons 1602 when their number is too large to fit on one screen.

In the preferred embodiment, the icons 1602 include miniature bar plots where each miniature bar plot represents a different configuration. In an alternate embodiment, the icons 1602 could include scatterplots, tables, drawings, etc. In the preferred embodiment, the active configuration screen displays variables 1604 and objectives 1604 on the left of the screen in the order in which they appear in the icons 1602. The user selects the variables 1604 and objectives 1604 to view on the active configurations screen. The active configurations screen represents values of the variables 1604 and objectives 1604 by the lengths of the bars. The active configuration screen also liststh ranges of the variables 1604 and the objectives 1604 on the left of the screen. An asterisk 1608 on a bar indicates that the value represented by the bar exceeds the range for the corresponding variable 1604 or objective 1604. The active configuration screen also includes indices beneath the icons 1602 for the corresponding configurations.

In the preferred embodiment, the active configurations screen has colors to distinguish variables 1604 and objectives 1604. Colors can further distinguish objectives 1604 meeting constraints from objectives 1604 which do not meet constraints. For example, the color blue could represent a variable 1604. Similarly, the color green could represent an objective 1604 meeting the constraints or an objective 1604 without constraints. The color red could represent objectives 1604 not meeting the constraints. A green border surrounding an icon 1602 indicates that all of the objectives 1604 meet their constraints in the corresponding configuration. A red border surrounding an icon 1602 indicates that at least one of the objectives 1604 does not meet its constraint in the corresponding configuration.

In the preferred embodiment, values of constraints are represented by small black rectangles on corresponding bars. In an alternate embodiment, upper and lower bounds could be represented by arrows pointing right and left respectively.

FIG. 17 shows a second sample design entry window 1405 for entering or viewing a configuration. In the preferred embodiment, the second sample design entry window 1405 includes design entry controls to define the design. The design entry controls include fields to identify variables 1702 and objectives 1704. Colors distinguish objectives 1704 meeting constraints from objectives 1704 which do not meet constraints. For example, the color green could represent an objective 1704 which meets its constraints. Similarly, the color red could represent an objective 1704 which does not meet its constraints.

FIG. 18 shows a second sample solutions display 1419 having a particular drawn configuration. In the context of the commercial jet design problem, the drawn configuration is a simplified representation of an airplane. In the preferred embodiment, the second sample solutions display 1419 displays variables 1802 and objectives 1802. Colors distinguish objectives 1802 meeting constraints from objectives 1802 which do not meed constraints. For example, the color blue could represent a variable 1802. Next, the color green could represent an objective 1802 which either does not have any constraints or meets its constraints. The color red could represent an objective 1802 which does not meet its constraints. Green wings indicate that all of the objectives 1802 of the drawn configuration meet their constraints. A red wing indicates that at least one of the objectives 1802 of the drawn configuration does not meet at least one of its constraints.

FIG. 19 shows a sample window for entering constraints which are used by the optimization component 106 of United Sherpa 100. In the preferred embodiment, this window includes design entry controls to define the constraints 1904 for variables 1902 and objectives 1902. This window also includes design entry controls which are used to specify whether the optimization component 106 should ignore a particular objective 1902, use the objective 1902 as a constraint or optimize with respect to the objective 1902. As shown by the example of FIG. 19, the user has manipulated the design entry controls to optimize the configuration with respect to the T-takeoff and wing loading objectives 1902 subject to constraints 1904: w_payload<120000 lb, range>6000 nm, and TOFL_a<8000 ft. Similarly, this window includes controls to specify whether a variable 1902 or objective 1902 should be maximized or minimized as well as whether a variable 1902 or objective 1902 has an upper bound constraint or a lower bound constraint.

FIG. 20 shows a first sample design output window 1413 having controls for a one-dimensional histogram. In the preferred embodiment, the first samples design output window 1413 includes design output controls to specify a solution format 1415. The design output controls include fields to identify the variable 2002 to be plotted and the number of bins 2004 for the one-dimensional histogram. FIG. 21 shows a third sample solutions display window 1419. The third sample solutions display window 1419 displays a one-dimensional histogram for the variable 2002 and the number of bins 2004 which were specified on the design output window 1413 of FIG. 20. The sample solutions display window 1419 further includes a line 2102 to partition the configurations accordingly to whether or not they meet their constraints. Preferably, the line 2102 is green on the side adjacent to the configurations which meet their constraints and is red on the side adjacent to the configurations which do not meet their constraints.

FIG. 22 shows a second sample design output window 1413 having controls for a two dimensional scatterplot. The second sample design output window 1413 includes design output controls to specify a solution format 1415. The design output controls include fields to identify the variables 2202 to be plotted for the two-dimensional scatterplot. The design output controls include additional fields listing variables 2204 an objectives 2204. The design output controls include boxes 2206 adjacent to the list of variables 2204 and objectives 2204 which are used to specify whether the optimization component 106 should ignore a particular objective 2204 or optimize with respect to the objective 2204. The design output controls further includes a PickPoint control 2208 which enables the user to select a point from the two dimensional scatterplot and either study its values or select it as a configuration for the active configurations screen of FIG. 16. The design output controls include a Plot control 2210 which is selected to generate the two dimensional scatterplot.

FIG. 23 shows a fourth sample solutions display window 1419 of a two-dimensional scatterplot of the variables 2202 specified on the design output window 1413 of FIG. 22. In the preferred embodiment, colors distinguish the points representing configurations on the sample solutions display window 1419. For example, the color green could represent the points of the solutions display window 1419 which are part of the general population of computed configurations. Next, the color blue could represent the points of the solutions display window 1419 which are shown on the active configurations screen of FIG. 16. Finally, red circled points of the solutions display 1419 could represent pareto optimal solutions with respect to the objectives 2204 which were identified on the design output window 1413 of FIG. 22. The sample solutions display window 1419 of the two-dimensional scatterplot further includes at least one line to partition the configurations accordingly to whether or not they meet their constraints. The lines are green on the side adjacent to the configurations which meet their constraints and are red on the side adjacent to the configurations which do not meet their constraints. The third sample solutions display window 1419 also includes design output controls enabling the user to zoom in and out to define a region of interest in the scatterplot.

FIG. 24 shows a third sample design output window having controls for a parallel coordinate plot. A parallel coordinate plot is a representation of high-dimensional data in which each variable is represented by a line and each data point is represented by a zig-zag line that connects corresponding values along each line.

The design output window 1413 of FIG. 24 includes design output controls to specify a solution format 1415. The design output controls include fields to identify the variables 2402 and objectives 2402 to display on the parallel coordinate plot. The design outputs controls also specify the order of the variables 2402 and objectives 2402 which have been identified for display on the parallel coordinate plot. The information which the user can learn from the parallel coordinate plot is affected by the identification of the variables 2402 and objectives 2402 and their order. The design output controls include fields 2404 to identify the objectives to use for computing and showing pareto optimal points. In the example shown in FIG. 24,the user has manipulated the design output controls to show the pareto optimal points with respect to the objectives: w-empty, w-payload and w-fuel. The design output controls further includes an Allvars control 2406 to set the fields to contain the variables 2402 in order. The design output controls includes a Clearvars control 2408 to clear all the fields containing variables 2402 and objectives 2402. The design output controls includes a ClearPO control 2410 to clear the fields 2404 used to identify the objectives 2402 to use for showing the pareto optimal lines. The design output controls includes a Plot control 2412 which is selected to generate the parallel coordinate plot.

FIG. 25 shows a fifth sample solutions display 1419 of a parallel coordinate plot. In the preferred embodiment, the fifth sample solutions display 1419 includes a list of variables 2502 and objectives 2502. The display 1419 also includes a range for each variable 2502 and objective 2502. The range includes a lower bound 2504 and an upper bound 2506. The fifth sample solution display 1419 further includes a design output control for indicating whether to display either the entire population of configurations or only the configurations meeting the constraints on the parallel coordinate plot.

In the preferred embodiment, colors distinguish lines on the parallel coordinate plot representing pareto optimal solutions with respect to the objectives 2402 specified on the design output window 1413 of FIG. 24. For example, black lines could represent the general population of solutions while the red lines could represent pareto optimal solutions. Colors also distinguish the objectives 2502 which were selected for use in computing pareto optimal solutions on the design output window 1413 of FIG. 24. For example, the color red could be used to identify the objectives 2502 which were selected for use in computing pareto optimal solutions on the design output window 1413.

FIG. 26 shows a fourth sample design output window 1413 having controls for a subset scatterplot. The fourth sample design output window 1413 includes design output controls to specify a solution format 1415. The design output controls include fields to identify the variables 2601 to be plotted for the two-dimensional scatterplot. The fourth sample design output window 1413 identifies the points to add or remove from the scatterplot of FIG. 27 based on whether the points satisfy arbitrary boundary conditions. The design output controls include additional fields to specify boundary conditions for identified variables 2602 and objectives 2602. The boundary conditions include a lower bound and an upper bound. The design output controls include a lower bound edit box 2604 and an upper bound edit box 2606. The design output controls also include slider boxes 2608 for the specification of boundary conditions.

The design output controls also include check-boxes 2610 adjacent to the list of variables 2602 and objectives 2602 to indicate whether the corresponding boundary conditions should be used to generate the scatterplot of FIG. 27. For the example of FIG. 26, the check in the check-box 2610 corresponding to the objective 2602 range indicates that the boundary condition for range should be used to generate the scatterplot of FIG. 27.

The design output controls also include pareto optimal check-boxes 2612 adjacent to a second list of variables 2612 and objectives 2612 to identify the objectives to use for computing and showing pareto optimal points. In the example shown in FIG. 26, the user has manipulated the design output controls to show the pareto optimal points with respect to the objectives: w-empty and w-payload.

The design output controls further includes a LockAxes control 2614 to lock or unlock the axes in the scatterplot of FIG. 27 such that further plots will retain the same range for the identified variables 2601. Clicking the LockAxes control 2614 toggles the selection between the lock and the unlock settings. The design output controls includes a Plot control 2618 which is selected to generate the scatterplot of FIG. 27.

FIG. 27 shows a sixth sample solutions display 1419 of a subset scatterplot for the variables 2601 and the boundary conditions specified on the design output window 1413 of FIG. 26. In the preferred embodiment, colors distinguish the points representing configurations on the sample solutions display window 1419. For example, green circles could represent the points of the solutions display window 1419 which meet the specified boundary conditions. Black triangles could represent the points of the solutions display window 1419 which do not meet all the specified boundary conditions. Red circled points of the solutions display 1419 could represent pareto optimal solutions with respect to the objectives 2602 which were selected with the pareto optimal check-boxes 2612 on the design output window 1413 of FIG. 26. The sample solutions display window 1419 of the two-dimensional scatterplot further includes at least one line to partition the configurations accordingly to whether or not they meet goal constraints. The lines are green on the side adjacent to the configurations which meet the goal constraints and are red on the side adjacent to the configurations which do not meet the goal constraints. The sample solutions display window 1419 of FIG. 27 also includes design output controls enabling the user to zoom in and out to define a region of interest in the scatterplot.

In alternative embodiments, the design output window 1413 includes design output controls to specify a solution format 1415 for other types of plots including bar graphs, one-dimensional histograms and parallel coordinate plots.

Using the sample design output window 1413 of FIG. 26, the user of United Sherpa 100 can interactively display the effects of modifications of boundary conditions of the variables 2602 and objectives 2602 or modifications in the objectives 2602 which were identified to use for computing pareto optimal points on the sample solutions display 1419 of FIG. 27.

FIG. 28 shows a simultaneous display of several design entry window and solutions. Specifically, FIG. 28 shows the active configurations screen of FIG. 16, the design entry window 1405 for entering or viewing a configuration of FIG. 17, the second sample solutions display 1419 having a particular drawn configuration of FIG. 18, and the subset scatterplot for specified variables and boundary conditions of FIG. 27.

FIG. 29 discloses a representative computer system 2910 in conjunction with which the embodiments of the present invention may be implemented. Computer system 2910 may be a personal computer, workstation, or a larger system such as a minicomputer. However, one skilled in the art of computer systems will understand that the present invention is not limited to a particular class or model of computer.

As shown in FIG. 29,representative computer system 2910 includes a central processing unit (CPU) 2912, a memory unit 2914, one or more storage devices 2916, an input device 2918, an output device 2920, and communication interface 2922. A system bus 2924 is provided for communications between these elements. Computer system 2910 may additionally function through use of an operating system such as Windows, DOS, or UNIX. However, one skilled in the art of computer systems will understand that the present invention is not limited to a particular configuration or operating system.

Storage devices 2916 may illustratively include one or more floppy or hard disk drives, CD-ROMs, DVDs, or tapes. Input device 2918 comprises a keyboard, mouse, microphone, or other similar device. Output device 2920 is a computer monitor or any other known computer output device. Communication interface 2922 may be a modem, a network interface, or other connection to external electronic devices, such as a serial or parallel port

While the above invention has been described with reference to certain preferred embodiments, the scope of the present invention is not limited to these embodiments. One skill in the art may find variations of these preferred embodiments which, nevertheless, fall within the spirit of the present invention, whose scope is defined by the claims set forth below.

1. A system for performing operations management in an environment of entities and resources comprising:
a plurality of resource objects characterizing the resources;
at least one selection operation for selecting one or more of said resource objects;
at least one transformation operation for combining said selected objects for forming at least one new resource in the environment; and
at least one graph operation for creating a graph representing the resources and said at least one transformation operation.

2. A system for performing operations management in an environment of entities and resources as in claim 1 wherein said plurality of objects comprise:
a plurality of offer objects characterizing offers of the resources; and
a plurality of request objects characterizing requests for the objects.

3. A system for performing operations management in an environment of entities and resources as in claim 2 wherein said plurality of request objects comprise a plurality of request attributes, rⱼ, j=1 . . . N, representing requested characteristics.

4. A system for performing operations management in an environment of entities and resources as in claim 3 wherein said plurality of offer objects comprise a plurality of offer attributes, oₖ, k=1 . . . M, representing offered characteristics.

5. A system for performing operations management in an environment of entities and resources as in claim 4 wherein said selection operation comprises the steps of:
identifying matching ones of said request attributes, rⱼ, j=1 . . . N, with said offer attributes, oₖ, k=1 . . . M to form a plurality of matching groups of said request objects and said offer objects;
evaluating said matching groups by computing how well said request attributes match said offer attributes; and
selecting at least one of said matching groups that are optimal with respect to said evaluation.

6. A system for performing operations management in an environment of entities and resources as in claim 5 wherein said request objects further comprise a plurality of attribute weights, wⱼ, j=1 . . . N, corresponding to said plurality of request attributes, rⱼ, j=1 . . . N, each of said weights, w, indicating an importance of said corresponding request attribute, rⱼ.

7. A system for performing operations management in an environment of entities and resources as in claim 6 wherein said matching groups are evaluated with respect to an evaluation function,
$${\sum }_{j = 1}^{N} {w}_{j} f ( {r}_{j} )$$
wherein:
f(rⱼ)=1 if said request attribute rⱼ matches one of said offer attributes, oₖ, k=1 . . . M, and
f(rⱼ)=1 otherwise.

8. A system for performing operations management in an environment of entities and resources as in claim 5 wherein said offer objects further comprise a plurality of attribute values corresponding to said plurality of offer attributes, oₖ, k=1 . . . M, each of said attribute values indicating how often said corresponding offer attribute had matched said plurality of request attributes, rⱼ, j=1 . . . N.

9. A system for performing operations management in an environment of entities and resources as in claim 8 wherein said offer objects further comprise a composite value defined as a sum of said plurality of attribute values.

10. A system for performing operations management in an environment of entities and resources as in claim 4 wherein said plurality of request attributes and said plurality of offer attributes are affordances.

11. A system for performing operations management in an environment of entities and resources as in claim 4 wherein said plurality of request attributes and said plurality of offer attributes comprise contract terms.

12. A system for performing operations management in an environment of entities and resources as in claim 4 wherein said plurality of offer attributes are selected from the group consisting of isa, hasa, and doesa.

13. A system for performing operations management in an environment of entities and resources as in claim 3 wherein said plurality of request attributes comprise needsa.

14. A system for performing operations management in an environment of entities and resources as in claim 1 further comprising at least one resource bus for receiving said offer objects and said request objects.

15. A system for performing operations management in an environment of entities and resources as in claim 14 further comprising at least one request broker for exchanging said offer objects and said request objects among said at least one resource bus.

16. A system for performing operations management in an environment of entities and resources as in claim 1 wherein said graph comprises a set of vertices, V, corresponding to the resources and a set of edges, E, corresponding to said at least one transformation operation.

17. A system for performing operations management in an environment of entities and resources as in claim 16 wherein said at least one graph operation comprises the steps of:
creating one or more vertices, vₒ₁, vₒ₂, corresponding to said one or more selected resource objects;
creating at least one vertex vₜₗ corresponding to said at least one new resource formed by said at least one transformation operation; and
creating at least one edge e corresponding to said at least one transformation operation wherein said at least one edge e has one or more origins corresponding to said one or more vertices, vₒ₁, Vₒ₂, and has at least one terminus corresponding to said at least one vertex vₜ₁ corresponding to said at least one new resource.

18. A system for performing operations management in an environment of entities and resources as in claim 16 further comprising:
at least one graph analysis operation comprising the steps of:
identifying a plurality of paths Pᵢ, i=1 . . . M through said graph; and
searching for at least one vertex vₚ of said set of vertices, V, that is incident on two or more of said plurality of paths, Pₗ, i=1 . . . M to identify at least one corresponding polyfunctional resource.

19. A system for performing operations management in an environment of entities and resources as in claim 18 wherein said at least one graph analysis operation further comprises the step of accumulating the at least one corresponding polyfunctional resource.

20. A system for performing operations management in an environment of entities and resources as in claim 1 further comprising at least one model for representing a corresponding one of the entities.

21. A system for performing operations management in an environment of entities and resources as in claim 20 wherein said at least one model comprises:
a plurality of decision making objects to represent a corresponding plurality of decision making units within the entities; and
a plurality of connections among said plurality of decision making objects to represent a corresponding plurality of communication links among the decision making units.

22. A system for performing operations management in an environment of entities and resources as in claim 21 wherein said decision making objects comprise a plurality of attributes.

23. A system for performing operations management in an environment of entities and resources as in claim 22 wherein said plurality of attributes of said decision making objects comprise at least one line of sight indicator.

24. A system for performing operations management in an environment of entities and resources as in claim 22 wherein said plurality of attributes of said decision making objects comprise at least one authority indicator.

25. A system for performing operations management in an environment of entities and resources as in claim 21 further comprising:
at least one simulator for simulating said at least one model to determine the performance of the corresponding entity; and
at least one optimizer for determining values of said attributes of said structural objects and for determining said connections among said plurality of decision making objects to achieve an optimal performance of the corresponding entity.

26. A method for performing operations management in an environment of entities and resources comprising the steps of:
characterizing the resources with a plurality of resource objects;
selecting one or more of said resource objects;
combining said selected objects for forming at least one new resource in the environment with at least one transformation operation; and
creating a graph representing the resources and said at least one transformation operation.

27. A method for performing operations management in an environment of entities and resources as in claim 26 wherein said characterizing the resources step comprises the steps of:
characterizing offers of the resources with a plurality of offer objects; and
characterizing requests for the objects with a plurality of request objects.

28. A method for performing operations management in an environment of entities and resources as in claim 27 wherein said characterizing requests step comprises the step of representing requested characteristics with a plurality of request attributes, rⱼ, j=1 . . . N.

29. A method for performing operations management in an environment of entities and resources as in claim 28 wherein said characterizing offers step comprises the step of representing offered characteristics with a plurality of offer attributes, oₖ, k=1 . . . M.

30. A method for performing operations management in an environment of entities and resources as in claim 29 wherein said selecting one or more of said resource objects step comprises the steps of:
identifying matching ones of said request attributes, rⱼ, j=1 . . . N, with said offer attributes, oₖ, k=1 . . . M to form a plurality of matching groups of said request objects and said offer objects;
evaluating said matching groups by computing how well said request attributes match said offer attributes; and
selecting at least one of said matching groups that are optimal with respect to said evaluation.

31. A method for performing operations management in an environment of entities and resources as in claim 30 wherein said characterizing requests step further comprises the step of indicating an importance of said plurality of request attributes, rⱼ, j=1 . . . N with a corresponding plurality of attribute weights, wⱼ, j=1 . . . N.

32. A method for performing operations management in an environment of entities and resources as in claim 31 wherein said matching groups are evaluated with respect to an evaluation function,
$${\sum }_{j = 1}^{N} {w}_{j} f ( {r}_{j} )$$
wherein:
f(rⱼ)=1 if said request attribute r_{J} matches one of said offer attributes, oₖ, k=1 . . . M, and
f(rⱼ)=1 otherwise.

33. A method for performing operations management in an environment of entities and resources as in claim 30 wherein said characterizing offers step further comprises the step of indicating how often each of said plurality of offer attributes match said plurality of request attributes, rⱼ, j=1 . . . N with a plurality of attribute values.

34. A method for performing operations management in an environment of entities and resources as in claim 33 wherein said characterizing offers step further comprises the step of defining a composite value for said offer objects as a sum of said plurality of attribute values.

35. A method for performing operations management in an environment of entities and resources as in claim 29 wherein said plurality of request attributes and said plurality of offer attributes are affordances.

36. A method for performing operations management in an environment of entities and resources as in claim 29 wherein said plurality of request attributes and said plurality of offer attributes comprise contract terms.

37. A method for performing operations management in an environment of entities and resources as in claim 29 wherein said plurality of offer attributes are selected from the group consisting of isa, hasa, and doesa.

38. A method for performing operations management in an environment of entities and resources as in claim 28 wherein said plurality of request attributes comprise needsa.

39. A method for performing operations management in an environment of entities and resources as in claim 26 further comprising the step of receiving said offer objects and said request objects with at least one resource bus.

40. A method for performing operations management in an environment of entities and resources as in claim 39 further comprising the step of exchanging said offer objects and said request objects among said at least one resource bus with at least one request broker.

41. A method for performing operations management in an environment of entities and resources as in claim 26 wherein said graph comprises a set of vertices, V, corresponding to the resources and a set of edges, E, corresponding to said at least one transformation operation.

42. A method for performing operations management in an environment of entities and resources as in claim 41 wherein said creating a graph step comprises the steps of:
creating one or more vertices, vₒ₁, Vₒ₂, corresponding to said one or more selected resource objects;
creating at least one vertex vₜ₁ corresponding to said at least one new resource formed by said at least one transformation operation; and
creating at least one edge e corresponding to said at least one transformation operation wherein said at least one edge e has one or more origins corresponding to said one or more vertices,vₒ₁, vₒ₂, and has at least one terminus corresponding to said at least one vertex Vₜ₁ corresponding to said at least one new resource.

43. A method for performing operations management in an environment of entities and resources as in claim 41 further comprising the steps of:
identifying a plurality of paths P₁, i=1 . . . M through said graph; and
searching for at least one vertex vₚ of said set of vertices, V, that is incident on two or more of said plurality of paths, Pᵢ, i=1 . . . M to identify at least one corresponding polyfunctional resource.

44. A method for performing operations management in an environment of entities and resources as in claim 43 further comprising the step of accumulating the at least one corresponding polyfunctional resource.

45. A method for performing operations management in an environment of entities and resources as in claim 26 further comprising the step of representing at least one of the entities with at least one corresponding model.

46. A method for performing operations management in an environment of entities and resources as in claim 36 wherein said representing at least one of the entities with at least one corresponding model step comprises the steps of:
representing a plurality of decision making units within the entities with a corresponding plurality of decision making objects; and
representing a corresponding plurality of communication links among the decision making units with a plurality of connections among said plurality of decision making objects.

47. A method for performing operations management in an environment of entities and resources as in claim 46 wherein said decision making objects comprise a plurality of attributes.

48. A method for performing operations management in an environment of entities and resources as in claim 47 wherein said plurality of attributes of said decision making objects comprise at least one line of sight indicator.

49. A method for performing operations management in an environment of entities and resources as in claim 47 wherein said plurality of attributes of said decision making objects comprise at least one authority indicator.

50. A method for performing operations management in an environment of entities and resources as in claim 46 further comprising the steps of:
simulating said at least one model to determine the performance of the corresponding entity; and
determining values of said attributes of said structural objects and determining said connections among said plurality of decision making objects to achieve an optimal performance of the corresponding entity.

51. A method for performing operations management in an environment of entities and resources as in claim 43 wherein said searching for at least one vertex vₚ of said set of vertices, V, that is incident on two or more of said plurality of paths, P₁, i=1 . . . M to identify at least one corresponding polyfunctional resource step comprises the steps of:
selecting a first subset V′ of said set of vertices V;
determining at least two paths P₁, P₂ of said set of paths P₁, i=1 . . . m terminating at said subset of vertices V′; and
performing an intersection of said at least two paths P₁, P₂ to identify at least one vertex vₚ corresponding to the at least one polyfunctional resource.

52. Computer executable software code stored on a computer readable medium, the code for performing operations management in an environment of entities and resources, the code comprising:
code to characterize the resources with a plurality of resource objects;
code to select one or more of said resource objects; code to combine said selected objects for forming at least one new resource in the environment with at least one transformation operation; and
code to create a graph representing the resources and said at least one transformation operation.

53. Computer executable software code stored on a computer readable medium, the code for performing operations management in an environment of entities and resources as in claim 52, the code further comprising:
code to characterize offers of the resources with a plurality of offer objects; and
code to characterize requests for the objects with a plurality of request objects.

54. Computer executable software code stored on a computer readable medium, the code for performing operations management in an environment of entities and resources as in claim 53, wherein the code to characterize requests further comprises code to represent requested characteristics with a plurality of request attributes, rⱼ, j=1 . . . N.

55. Computer executable software code stored on a computer readable medium, the code for performing operations management in an environment of entities and resources as in claim 54, wherein the code to characterize offers further comprises code to represent offered characteristics with a plurality of offer attributes, oₖ, k=1 . . . M.

56. Computer executable software code stored on a computer readable medium, the code for performing operations management in an environment of entities and resources as in claim 52, wherein said graph comprises a set of vertices, V, corresponding to the resources and a set of edges, E, corresponding to said at least one transformation operation.

57. Computer executable software code stored on a computer readable medium, the code for performing operations management in an environment of entities and resources as in claim 56, wherein the code to create a graph further comprises:
code to create one or more vertices,vₒ₁, vₒ₂, corresponding to said one or more selected resource objects;
code to create at least one vertex vₜ₁ corresponding to said at least one new resource formed by said at least one transformation operation; and
code to create at least one edge e corresponding to said at least one transformation operation wherein said at least one edge e has one or more origins corresponding to said one or more vertices, vₒ₁, V,ₒ₂, and has at least one terminus corresponding to said at least one vertex vₜ₁ corresponding to said at least one new resource.

58. Computer executable software code stored on a computer readable medium, the code for performing operations management in an environment of entities and resources as in claim 56, the code further comprising:
code to identify a plurality of paths P₁, i=1 . . . M through said graph; and
code to search for at least one vertex vₚ of said set of vertices, V, that is incident on two or more of said plurality of paths, P₁, i=1 . . . M to identify at least one corresponding polyfunctional resource.

59. A programmed computer system for performing operations management in an environment of entities and resources comprising at least one memory having at least one region storing computer executable program code and at least one processor for executing the program code stored in said memory, wherein the program code includes
code to characterize the resources with a plurality of resource objects;
code to select one or more of said resource objects;
code to combine said selected objects for forming at least one new resource in the environment with at least one transformation operation; and
code to create a graph representing the resources and said at least one transformation operation.

60. A programmed computer system for performing operations management in an environment of entities and resources comprising at least one memory having at least one region storing computer executable program code and at least one processor for executing the program code stored in said memory as in claim 59, wherein the program code further includes:
code to characterize offers of the resources with a plurality of offer objects; and
code to characterize requests for the objects with a plurality of request objects.

61. A programmed computer system for performing operations management in an environment of entities and resources comprising at least one memory having at least one region storing computer executable program code and at least one processor for executing the program code stored in said memory as in claim 60, wherein the code to characterize requests further includes code to represent requested characteristics with a plurality of request attributes, rⱼ, j=1 . . . N.

62. A programmed computer system for performing operations management in an environment of entities and resources comprising at least one memory having at least one region storing computer executable program code and at least one processor for executing the program code stored in said memory as in claim 61, wherein the code to characterize offers further includes code to represent offered characteristics with a plurality of offer attributes, oₖ, k=1 . . . M.

63. A programmed computer system for performing operations management in an environment of entities and resources comprising at least one memory having at least one region storing computer executable program code and at least one processor for executing the program code stored in said memory as in claim 59 wherein said graph comprises a set of vertices, V, corresponding to the resources and a set of edges, E, corresponding to said at least one transformation operation.

64. A programmed computer system for performing operations management in an environment of entities and resources comprising at least one memory having at least one region storing computer executable program code and at least one processor for executing the program code stored in said memory as in claim 63, wherein the code to create a graph further includes:
code to create one or more vertices,vₒ₁, vₒ₂, corresponding to said one or more selected resource objects;
code to create at least one vertex vₜ₁ corresponding to said at least one new resource formed by said at least one transformation operation; and
code to create at least one edge e corresponding to said at least one transformation operation wherein said at least one edge e has one or more origins corresponding to said one or more vertices,vₒ₁, vₒ₂, and has at least one terminus corresponding to said at least one vertex vₜ₁ corresponding to said at least one new resource.

65. A programmed computer system for performing operations management in an environment of entities and resources comprising at least one memory having at least one region storing computer executable program code and at least one processor for executing the program code stored in said memory as in claim 64, wherein the code further includes:
code to identify a plurality of paths P₁, i=1 . . . M through said graph; and
code to search for at least one vertex vₚ of said set of vertices, V, that is incident on two or more of said plurality of paths, Pᵢ, i=1 . . . M to identify at least one corresponding polyfunctional resource.

66. A method for exchanging a plurality of resources among a plurality of entities comprising the steps of:
defining a plurality of properties for the resources;
finding at least one match among said properties of the resources to identify a plurality of candidate exchanges; and
selecting at least one exchange from said plurality of candidate exchanges.

67. A method for exchanging a plurality of resources among a plurality of entities as in claim 66 wherein said selecting at least one exchange from said plurality of candidate exchanges step comprises the steps of:
defining a joint satisfaction as at least one function of said plurality of properties to measure a mutual satisfaction of said candidate exchanges; and
optimizing said joint satisfaction to identify one or more of said candidate exchanges having an optimal mutual satisfaction; and
selecting said one or more of said candidate exchanges having an optimal mutual satisfaction.

68. A method for exchanging a plurality of resources among a plurality of entities as in claim 67 wherein said optimizing said joint satisfaction step comprises the steps of:
decomposing the joint satisfaction to minimize
$${\sum }_{1 ⪯ j ⪯ N + 1} {f}_{j} ( {χ}_{j} )$$
subject to at least one constraint,
$$- {χ}_{N + 1} + {\sum }_{1 ⪯ j ⪯ N} {χ}_{j} {v}_{j} = 0$$
wherein:
Xⱼ=Pⱼ and X_{N+1}=Σ1≦j≦N^{x}^{ⱼ}^{v}^{ⱼ} are new coordinates for jε[1,N] and j=N+1 respectively;
fⱼ (Xⱼ)=s^{C}ⱼ(Xⱼ|vⱼ) and f_{N+1}(X_{N+1})=S^{L}(X_{N+1}) are new functions for jε[1,N] and j=N+1 respectively;
s^{C}ⱼ(X_{j|v}ⱼ) is a satisfaction of one of the entities participating in said candidate exchange and s^{L}(X_{N+1}) is a satisfaction of another of the entities participating in said candidate exchange.

69. A method for exchanging a plurality of resources among a plurality of entities as in claim 68 further comprising the step of:
introducing at least one Lagrange multiplier for said at least one constraint to form at least one Lagrangian,
$$L ( {x}_{1} λ ) = {\sum }_{1 ⪯ j ⪯ N + 1} {f}_{j} ( {χ}_{j} ) + λ {a }^{t} x ≡ {\sum }_{1 ⪯ j ⪯ N + 1} {L}_{i} ( {χ}_{j} , λ )$$
wherein
Lᵢ(Xᵢ,λ)=fₗ(Xᵢ)+λaᵢXₗ and aᵢ=vₗ for iε[1,n]; and
and aₗ₊₁=−1.

70. A method for exchanging a plurality of resources among a plurality of entities as in claim 69 further comprising the step of minimizing said Lagrangian.

71. A method for exchanging a plurality of resources among a plurality of entities as in claim 70 wherein said step of minimizing said Lagrangian uses Lagrangian relaxation.

72. A method for exchanging a plurality of resources among a plurality of entities as in claim 71 further comprising the step of:
decomposing said Lagrangian into N 1-dimensional minimizations minₓ L(x, λₜ)=Σ_{1≦i≦N} min _{X}_{ₗ}Lᵢ(Xₗ,λₜ) to obtain a solution xₜ=x(λₜ).

73. A method for exchanging a plurality of resources among a plurality of entities as in claim 72 wherein said N 1-dimensional minimizations are performed in parallel.

74. A method for exchanging a plurality of resources among a plurality of entities as in claim 73 further comprising the step of determining said at least one Lagrangian multiplier using a dual function,
q(λ)
within an expression,
$${max}_{λ} L ( x ( λ ) , λ ) ≡ {max}_{λ} q ( λ ) .$$

75. A method for exchanging a plurality of resources among a plurality of entities as in claim 74 wherein said determining said at least one Lagrangian multiplier step comprises the step of maximizing said dual function,
q(λ).

76. A method for exchanging a plurality of resources among a plurality of entities as in claim 75 wherein said maximizing said expression step uses steepest ascent.

77. A method for exchanging a plurality of resources among a plurality of entities as in claim 76 wherein said maximizing said expression step using steepest ascent comprises the step of computing the gradient of said dual function as:
$${\partial }_{λ} q ( λ ) = a {}^{t} x + {\sum }_{1 ⪯ j ⪯ N + 1} ( {\partial }_{χ i} {f}_{j} ( {χ}_{i} ( λ ) ) + λ {a}_{j} ) {\partial }_{λ} {x}_{j} = a {}^{t} x .$$

78. A method for exchanging a plurality of resources among a plurality of entities as in claim 77 wherein said maximizing said expression step using steepest ascent comprises the step of updating said Lagrangian multiplier as:
λₜ₊₁=λₜ+αa^{t}x(λ).
wherein α is a step size to determine at least one local peak for said Lagrangian multiplier.

79. A method for exchanging a plurality of resources among a plurality of entities as in claim 66 wherein said selection step comprises the step of conducting an auction among the entities.

80. A method for exchanging a plurality of resources among a plurality of entities as in claim 79 wherein said auction is a double oral auction.

81. A method for exchanging a plurality of resources among a plurality of entities as in claim 66 wherein said plurality of properties comprise at least one attribute.

82. A method for exchanging a plurality of resources among a plurality of entities as in claim 66 wherein said plurality of properties comprise at least one behavior.

83. A method for exchanging a plurality of resources among a plurality of entities as in claim 66 wherein said plurality of properties comprise at least one affordance.

84. A method for exchanging a plurality of Oresources among a plurality of entities as in claim 66 wherein said plurality of properties comprise at least one contract term.

85. A method for exchanging a plurality of resources among a plurality of entities as in claim 84 wherein said at least one contract term comprises an exchange time.

86. A method for exchanging a plurality of resources among a plurality of entities as in claim 84 wherein said at least one contract term comprises a quantity.

87. A method for exchanging a plurality of resources among a plurality of entities as in claim 84 wherein said at least one contract term comprises a price.

88. Computer executable software code stored on a computer readable medium, the code for exchanging a plurality of resources among a plurality of entities, the code comprising:
code to define a plurality of properties for the resources;
code to find at least one match among said properties of the resources to identify a plurality of candidate exchanges; and
code to select at least one exchange from said plurality of candidate exchanges.

89. Computer executable software code stored on a computer readable medium, the code for exchanging a plurality of resources among a plurality of entities as in claim 88, wherein the code to select at least one exchange further comprises:
code to define a joint satisfaction as at least one function of said plurality of properties to measure a mutual satisfaction of said candidate exchanges;
code to optimize said joint satisfaction to identify one or more of said candidate exchanges having an optimal mutual satisfaction; and
code to select said one or more of said candidate exchanges having an optimal mutual satisfaction.

90. Computer executable software code stored on a computer readable medium, the code for exchanging a plurality of resources among a plurality of entities as in claim 89, wherein the code to optimize said joint satisfaction further comprises:
code to decompose the joint satisfaction to minimize
$${\sum }_{1 ⪯ j ⪯ N + 1} {f}_{j} ( {χ}_{j} )$$
subject to at least one constraint,
$$- {χ}_{N + 1} + {\sum }_{1 ⪯ j ⪯ N} {χ}_{j} {v}_{j} = 0$$
wherein:
Xⱼ=Pⱼ and X_{N+1}=Σ1≦j≦N^{x}^{ⱼ}^{v}^{ⱼ} are new coordinates for jε[1,N] and j=N+1 respectively;
fⱼ (Xⱼ)=s^{C}ⱼ(Xⱼ|vⱼ) and f_{N+1}(X₊₁)=s^{L}(X_{N+1}) are new functions for jε[1,N] and j=N+1 respectively;
s^{C}ⱼ(Xⱼ|vⱼ) is a satisfaction of one of the entities participating in said candidate exchange and S^{L}(X_{N+1}) is a satisfaction of another of the entities participating in said candidate exchange.

91. A programmed computer for exchanging a plurality of resources among a plurality of entities, comprising at least one memory having at least one region storing computer executable program code and at least one processor for executing the program code stored in said memory, wherein the program code includes:
code to define a plurality of properties for the resources;
code to find at least one match among said properties of the resources to identify a plurality of candidate exchanges; and
code to select at least one exchange from said plurality of candidate exchanges.

92. A programmed computer for exchanging a plurality of resources among a plurality of entities, comprising at least one memory having at least one region storing computer executable program code and at least one processor for executing the program code stored in said memory as in claim 91, wherein the code to select at least one exchange further includes:
code to define a joint satisfaction as at least one function of said plurality of properties to measure a mutual satisfaction of said candidate exchanges;
code to optimize said joint satisfaction to identify one or more of said candidate exchanges having an optimal mutual satisfaction; and
code to select said one or more of said candidate exchanges having an optimal mutual satisfaction.

93. A programmed computer for exchanging a plurality of resources among a plurality of entities, comprising at least one memory having at least one region storing computer executable program code and at least one processor for executing the program code stored in said memory as in claim 91, wherein the code to optimize said joint satisfaction further includes:
code to decompose the joint satisfaction to minimize
$${\sum }_{l ⪯ j ⪯ N + 1} {f}_{j} ( {χ}_{j} )$$
subject to at least one constraint,
$$- {χ}_{N + 1} + {\sum }_{1 ⪯ j ⪯ N} {χ}_{j} {v}_{j} = 0$$
wherein:
Xⱼ=Pⱼ and X_{N+1}=Σ1≦j≦N^{X}^{ⱼ}^{v}^{ⱼ} are new coordinates for jε[1,N] and j=N+1 respectively;
fⱼ(Xⱼ)=s^{C}ⱼ(Xⱼ|vⱼ) and f_{N+1}(X_{N+1})=S^{L}(X_{N+1}) are new functions for jε[1,N] and j=N+1 respectively;
s^{C}ⱼ (Xⱼ|vⱼ) is a satisfaction of one of the entities participating in said candidate exchange and s^{L}(X_{N+1}) is a satisfaction of another of the entities participating in said candidate exchange.

94. A system for matching service requests with service offers comprising:
a request input device for receiving a plurality of service request preferences;
an offer input device for receiving a plurality of service offer preferences;
a computer storage system for storing evaluation criteria; and
a matching module configured to communicate with said request input device, said offer input device and said computer storage system for matching one or more of the service requests with one or more of the service offers.

95. A system for matching service requests with service offers as in claim 94 wherein said evaluation criteria comprise:
request evaluation criteria and
offer evaluation criteria.

96. A system for matching service requests with service offers as in claim 95 wherein said matching module comprises:
a first ranking module for ranking the service requests with respect to said request evaluation criteria and for selecting at least one of the service requests having a maximal rank;
an identification module for identifying one or more of the service offers that are compatible with said at least one of the service requests having a maximal rank;
a second ranking module for ranking said compatible service offers with respect to said offer evaluation criteria and for selecting at least one of said compatible service offers having a maximal rank; and
a price calculation module for setting a price for an exchange of said at least one selected service request and said at least one selected service offer.

97. A system for matching service requests with service offers as in claim 94 wherein said plurality of service request preferences are specified by at least one producer who has an opportunity to move one or more products.

98. A system for matching service requests with service offers as in claim 94 wherein said plurality of service offer preferences are specified by at least one distribution service provider.

99. A system for matching service requests with service offers as in claim 94 wherein said plurality of service request preferences comprise a maximum price.

100. A system for matching service requests with service offers as in claim 99 wherein said plurality of service request preferences further comprise a departure time and an arrival time.

101. A system for matching service requests with service offers as in claim 100 wherein said plurality of service request preferences further comprise a departure location and an arrival location.

102. A system for matching service requests with service offers as in claim 95 wherein said request evaluation criteria comprise a plurality of first weighting factors corresponding to said plurality of service request preferences.

103. A system for matching service requests with service offers as in claim 95 wherein said offer evaluation criteria comprise a plurality of second weighting factors corresponding to said plurality of service offer preferences.

104. A system for matching service requests with service offers as in claim 96 wherein said price calculation module comprises at least one price calculation expression.

105. A system for matching service requests with service offers as in claim 104 wherein said at least one price calculation expression comprises a plurality of shipping factors.

106. A system for matching service requests with service offers as in claim 105 wherein said shipping factors comprise shipping material, shipping volume, shipping weight, shipping time and shipping location.

107. A method for matching service requests with service offers comprising the steps of:
receiving a plurality of service request preferences with a request input device;
receiving a plurality of service offer preferences an offer input device;
storing evaluation criteria with a computer storage system; and
matching one or more of the service requests with one or more of the service offers with a matching module configured to communicate with said request input device, said offer input device and said computer storage system.

108. A method for matching service requests with service offers as in claim 107 wherein said evaluation criteria comprise:
request evaluation criteria and
offer evaluation criteria.

109. A method for matching service requests with service offers as in claim 108 wherein said matching one or more of the service requests with one or more of the service offers comprises the steps of:
ranking the service requests with respect to said request evaluation criteria;
selecting at least one of the service requests having a maximal rank;
identifying one or more of the service offers that are compatible with said at least one of the service requests having a maximal rank;
ranking said compatible service offers with respect to said offer evaluation criteria;
selecting at least one of said compatible service offers having a maximal rank; and
setting a price for an exchange of said at least one selected service request and said at least one selected service offer.

110. A method for matching service requests with service offers as in claim 107 wherein said plurality of service request preferences are specified by at least one producer who has an opportunity to move one or more products.

111. A method for matching service requests with service offers as in claim 107 wherein said plurality of service offer preferences are specified by at least one distribution service provider.

112. A method for matching service requests with service offers as in claim 107 wherein said plurality of service request preferences comprise a maximum price.

113. A method for matching service requests with service offers as in claim 112 wherein said plurality of service request preferences further comprise a departure time and an arrival time.

114. A method for matching service requests with service offers as in claim 113 wherein said plurality of service request preferences further comprise a departure location and an arrival location.

115. A method for matching service requests with service offers as in claim 114 wherein said plurality of service request preferences further comprise an arrival location.

116. A method for matching service requests with service offers as in claim 109 wherein said request evaluation criteria comprise a plurality of first weighting factors corresponding to said plurality of service request preferences.

117. A method for matching service requests with service offers as in claim 109 wherein said offer evaluation criteria comprise a plurality of second weighting factors corresponding to said plurality of service offer preferences.

118. A method for matching service requests with service offers as in claim 110 wherein said setting a price for an exchange step comprises the step of evaluating at least one price calculation expression.

119. A method for matching service requests with service offers as in claim 118 wherein said at least one price calculation expression comprises a plurality of shipping factors.

120. A method for matching service requests with service offers as in claim 119 wherein said shipping factors comprise shipping material, shipping volume, shipping weight, shipping time and shipping location.

121. Computer executable software code stored on a computer readable medium, the code for matching service requests with service offers, the code comprising:
code to receive a plurality of service request preferences with a request input device;
code to receive a plurality of service offer preferences an offer input device;
code to store evaluation criteria with a computer storage system; and
code to match one or more of the service requests with one or more of the service offers with a matching module configured to communicate with said request input device, said offer input device and said computer storage system.

122. Computer executable software code stored on a computer readable medium, the code for matching service requests with service offers as in claim 121 wherein said evaluation criteria comprise:
request evaluation criteria and
offer evaluation criteria.

123. Computer executable software code stored on a computer readable medium, the code for matching service requests with service offers as in claim 122 wherein said code to match one or more of the service requests with one or more of the service offers further comprises:
code to rank the service requests with respect to said request evaluation criteria;
code to select at least one of the service requests having a maximal rank;
code to identify one or more of the service offers that are compatible with said at least one of the service requests having a maximal rank;
code to rank said compatible service offers with respect to said offer evaluation criteria;
code to select at least one of said compatible service offers having a maximal rank; and
code to set a price for an exchange of said at least one selected service request and said at least one selected service offer.

124. A programmed computer for matching service requests with service offers, comprising at least one memory having at least one region storing computer executable program code and at least one processor for executing the program code stored in said memory, wherein the code comprises:
code to receive a plurality of service request preferences with a request input device;
code to receive a plurality of service offer preferences an offer input device;
code to store evaluation criteria with a computer storage system; and
code to match one or more of the service requests with one or more of the service offers with a matching module configured to communicate with said request input device, said offer input device and said computer storage system.

125. A programmed computer for matching service requests with service offers, comprising at least one memory having at least one region storing computer executable program code and at least one processor for executing the program code stored in said memory as in claim 124, wherein said evaluation criteria comprise:
request evaluation criteria and
offer evaluation criteria.

126. A programmed computer for matching service requests with service offers, comprising at least one memory having at least one region storing computer executable program code and at least one processor for executing the program code stored in said memory as in claim 125, wherein said code to match one or more of the service requests with one or more of the service offers further comprises:
code to rank the service requests with respect to said request evaluation criteria;
code to select at least one of the service requests having a maximal rank;
code to identify one or more of the service offers that are compatible with said at least one of the service requests having a maximal rank;
code to rank said compatible service offers with respect to said offer evaluation criteria;
code to select at least one of said compatible service offers having a maximal rank; and
code to set a price for an exchange of said at least one selected service request and said at least one selected service offer.

127. A method for optimizing a system by constructing a fitness landscape for the system from observed data comprising the steps of:
defining an N-dimensional search space with an input vector x of N variables, N is a natural number;
defining a distance between values of said input vector;
defining at least one output y;
defining a covariance function of said distance,
said covariance function having a plurality of hyperparameters; and
learning values of said plurality of hyperparameters from the observed data.

128. A method for optimizing a system by constructing a fitness landscape for the system from observed data as in claim 127 further comprising the steps of:
characterizing the fitness landscape from said values of said hyperparameters; and
selecting at least one optimization technique that is suited to said characterization.

129. A method for optimizing a system by constructing a fitness landscape for the system from observed data as in claim 127 wherein one or more of said N variables are discrete.

130. A method for optimizing a system by constructing a fitness landscape for the system from observed data as in claim 129 wherein said covariance function has N first hyperparameters ρₗ, i=1 . . . N corresponding to the N dimensions of said search space, each of said first hyperparameters representing the degree of correlation along said corresponding dimension in the fitness landscape.

131. A method for optimizing a system by constructing a fitness landscape for the system from observed data as in claim 129 wherein said covariance function comprises at least one stationary term.

132. A method for optimizing a system by constructing a fitness landscape for the system from observed data as in claim 131 wherein said covariance function is defined as:
C(x^{(l)},x^{(j)},Θ)=Θ₁Cₛ(x^{(l)},x^{(j)})+Θ₂+δ_{i,j}Θ₃
wherein
$${C}_{s} ( {x}^{( i )} , {x}^{( j )} ) = {\prod }_{1 \leq k \leq N} {ϱ}_{k}^{{x}_{k}^{( i )} ⩓ {x}_{k}^{( j )}}$$
Cₛ (x^{(l)}, x^{(j)}) is said at least one stationary term;
Θ= (Θ₁, Θ₂, Θ₃) are second hyperparameters;
x ^{(l)}, x⁽³⁾ are values of said input vector x; and Λ evaluates to one if symbols at position k differ and evaluates to zero otherwise.

133. A method for optimizing a system by constructing a fitness landscape for the system from observed data as in claim 132 wherein said learning step comprises the steps of:
simulating the system with a plurality of values of the input vector x;
observing the value of the output, y corresponding to said plurality of values of the inputs vectors x to generate the observed data, D={x⁽¹⁾, y⁽¹⁾, . . . , x^{(d)}, y^{(d)}} wherein x^{(l)}, y^{(l)} are values of the input vector x and the output y respectively.

134. A method for optimizing a system by constructing a fitness landscape for the system from observed data as in claim 133 wherein said learning step further comprises the step of generating a covariance matrix C_{d}(Θ) from the observed data D={x⁽¹⁾, y⁽¹⁾, . . . , x^{(d)}, y^{(d)}} and said covariance function.

135. A method for optimizing a system by constructing a fitness landscape for the system from observed data as in claim 134 wherein the (i,j) elements of said covariance matrix is defined as C(x^{(l)}, x^{(j)}, Θ).

136. A method for optimizing a system by constructing a fitness landscape for the system from observed data as in claim 135 wherein said learning step further comprises the step of defining at least one likelihood function L(Θ) that expresses the probability of the observed data D={x⁽¹⁾, y⁽¹⁾, . . . , x^{(d)}, y^{(d)}} for different values of said hyperparameters.

137. A method for optimizing a system by constructing a fitness landscape for the system from observed data as in claim 136 wherein said learning step further comprises the step of determining values of the hyperparameters that maximize the logarithm of said likelihood function.

138. A method for optimizing a system by constructing a fitness landscape for the system from observed data as in claim 137 wherein the logarithm of said likelihood function is defined as: L(Θ)=−½log det C_{d}(Θ)−½Y C_{d}⁻¹(Θ) wherein log det C_{d}(Θ) is the determinant of C_{d}(Θ).

139. A method for optimizing a system by constructing a fitness landscape for the system from observed data as in claim 136 wherein said learning step further comprises the steps of:
defining at least one prior probability density function for said hyperparameters expressing probabilities of said possible values of said hyperparameters from the prior knowledge of the system; and
defining at least one posterior probability density function as a product of said at least one prior probability density function and said at least one likelihood function L(Θ) wherein said posterior probability density function express the probabilities of possible values of said hyperparameters from the prior knowledge of the system and the observed data, D={x⁽¹⁾, y⁽¹⁾, . . . , x^{(d)}, y^{(d)}}.

140. A method for optimizing a system by constructing a fitness landscape for the system from observed data as in claim 139 wherein said learning step further comprises the step of selecting one or more of the values of said hyperparameters having the greatest probability.

141. A method for optimizing a system by constructing a fitness landscape for the system from observed data as in claim 139 wherein said at least one prior probability density function is tunable.

142. A method for optimizing a system by constructing a fitness landscape for the system from observed data as in claim 139 wherein said at least one prior probability density function for said second hyperparameters is the gamma distribution.

143. A method for optimizing a system by constructing a fitness landscape for the system from observed data as in claim 139 wherein said at least one prior probability density function for said second hyperparameters is the inverse gamma distribution.

144. A method for optimizing a system by constructing a fitness landscape for the system from observed data as in claim 139 wherein said at least one prior probability density function for said first hyperparameters is a beta distribution.

145. A method for optimizing a system by constructing a fitness landscape for the system from observed data as in claim 139 wherein said at least one prior probability density function for said first hyperparameters is a modified beta distribution to include the possibility of negative values for said first hyperparameters.

146. A method for optimizing a system by constructing a fitness landscape for the system from observed data as in claim 129 wherein said discrete variables are binary variables.

147. A method for optimizing a system by constructing a fitness landscape for the system from observed data as in claim 146 wherein said distance between values of said binary variables is the Hamming distance.

148. Computer executable software code stored on a computer readable medium, the code for optimizing a system by constructing a fitness landscape for the system from observed data, the code comprising:
code to define an N-dimensional search space with an input vector x of N variables, N is a natural number;
code to define a distance between values of said input vector;
code to define at least one output y;
code to define a covariance function of said distance, said covariance function having a plurality of hyperparameters; and
code to learn values of said plurality of hyperparameters from the observed data.

149. Computer executable software code stored on a computer readable medium, the code for optimizing a system by constructing a fitness landscape for the system from observed data as in claim 148, the code further comprising:
code to characterize the fitness landscape from said values of said hyperparameters; and
code to select at least one optimization technique that is suited to said characterization.

150. A programmed computer for optimizing a system by constructing a fitness landscape for the system from observed data, comprising at least one memory having at least one region storing computer executable program code and at least one processor for executing the program code stored in said memory, wherein the program code includes:
code to define an N-dimensional search space with an input vector x of N variables, N is a natural number;
code to define a distance between values of said input vector;
code to define at least one output y;
code to define a covariance function of said distance, said covariance function having a plurality of hyperparameters; and
code to learn values of said plurality of hyperparameters from the observed data.

151. A programmed computer for optimizing a system by constructing a fitness landscape for the system from observed data, comprising at least one memory having at least one region storing computer executable program code and at least one processor for executing the program code stored in said memory as in claim 150, wherein the program code further includes:
code to characterize the fitness landscape from said values of said hyperparameters; and
code to select at least one optimization technique that is suited to said characterization.

152. A method for optimizing a system by constructing a fitness landscape for the system from observed data comprising the steps of:
defining an N-dimensional search space with an input vector x of N variables, N is a natural number;
defining a distance between values of said input vector;
defining an M-dimensional one output vector t;
defining a M×M matrix of covariance function across said M-dimensional output vector t, each of said covariance functions having a plurality of hyperparameters; and
learning values of said plurality of hyperparameters from the observed data.

153. A method for optimizing a system by constructing a fitness landscape for the system from observed data as in claim 152 further comprising the steps of:
characterizing the fitness landscape from said values of said hyperparameters; and
selecting at least one optimization technique that is suited to said characterization.

154. A method for optimizing a system by constructing a fitness landscape for the system from observed data as in claim 152 wherein one or more of said N variables are discrete.

155. A method for optimizing a system by constructing a fitness landscape for the system from observed data as in claim 152 wherein said covariance functions have N first hyperparameters ρₗ, i=1 . . . N corresponding to the N dimensions of said search space, each of said first hyperparameters representing the degree of correlation along said corresponding dimension in the fitness landscape.

156. A method for optimizing a system by constructing a fitness landscape for the system from observed data as in claim 152 wherein said covariance function comprises at least one stationary term.

157. Computer executable software code stored on a computer readable medium, the code for optimizing a system by constructing a fitness landscape for the system from observed data, the code comprising:
code to define an N-dimensional search space with an input vector x of N variables;
code to define a distance between values of said input vector;
code to define an M-dimensional output vector t;
code to define an M×M matrix of covariance functions across said M-dimensional output vector t, each of said covariance functions having a plurality of hyperparameters; and
code to learn values of said plurality of hyperparameters from the observed data.

158. Computer executable software code stored on a computer readable medium, the code for optimizing a system by constructing a fitness landscape for the system from observed data as in claim 157, the code further comprising:
code to characterize the fitness landscape from said values of said hyperparameters; and
code to select at least one optimization technique that is suited to said characterization.

159. A programmed computer for optimizing a system by constructing a fitness landscape for the system from observed data, comprising at least one memory having at least one region storing computer executable program code and at least one processor for executing the program code stored in said memory, wherein the program code includes:
code to define an N-dimensional search space with an input vector x of N variables;
code to define a distance between values of said input vector;
code to define an M-dimensional output vector t;
code to define an M×M matrix of covariance functions across said M-dimensional output vector t, each of said covariance functions having a plurality of hyperparameters; and
code to learn values of said plurality of hyperparameters from the observed data.

160. A programmed computer for optimizing a system by constructing a fitness landscape for the system from observed data, comprising at least one memory having at least one region storing computer executable program code and at least one processor for executing the program code stored in said memory as in claim 159, wherein the program code further includes:
code to characterize the fitness landscape from said values of said hyperparameters; and
code to select at least one optimization technique that is suited to said characterization.

161. A method for performing operations management in an environment of entities and resources comprising the steps of:
creating a discrete landscape representation for the operations management in the environment;
determining a sparse representation of said discrete landscape to identify at least one salient feature of said discrete landscape;
selecting at least one optimization algorithm from a set of optimization algorithms by matching said salient features to said set of optimization algorithms; and
executing said selected optimization algorithm to identify at least one good operations management solution over said landscape representation.

162. A method for performing operations management in an environment of entities and resources as in claim 161 wherein said determining a sparse representation of said discrete landscape step further comprises the steps of:
initializing a basis for said sparse representation;
defining an energy function comprising at least one error term to measure the error of said sparse representation and comprising at least one sparseness term to measure the degree of sparseness of said sparse representation; and
modifying said basis by minimizing said energy function such that said sparse representation has a minimal error and a maximal degree of sparseness.

163. A method for performing operations management in an environment of entities and resources as in claim 162 wherein said energy function is defined as:
$$E ( a , φ \vert f ) = \frac{1}{n} {\sum }_{i = 1}^{n} \{ {\sum }_{\vec{s}} {[ {f}_{i} ( \vec{s} ) - {\sum }_{j} {a}_{j}^{( i )} {φ}_{j} ( \vec{s} ) ]}^{2} + λ {\sum }_{j} S ( {a}_{j}^{( i )} / σ ) \} .$$

164. Computer executable software code stored on a computer readable medium, the code for performing operations management in an environment of entities and resources, the code comprising:
code to create a discrete landscape representation for the operations management in the environment;
code to determine a sparse representation of said discrete landscape to identify at least one salient feature of said discrete landscape;
code to select at least one optimization algorithm from a set of optimization algorithms by matching said salient features to said set of optimization algorithms; and
code to execute said selected optimization algorithm to identify at least one good operations management solution over said landscape representation.

165. A programmed computer for performing operations management in an environment of entities and resources comprising at least one memory having at least one region storing computer executable program code and at least one processor for executing the program code stored in said memory, wherein the program code includes:
code to create a discrete landscape representation for the operations management in the environment;
code to determine a sparse representation of said discrete landscape to identify at least one salient feature of said discrete landscape;
code to select at least one optimization algorithm from a set of optimization algorithms by matching said salient features to said set of optimization algorithms; and
code to execute said selected optimization algorithm to identify at least one good operations management solution over said landscape representation.

166. A method for performing operations management in an environment of entities and resources comprising the steps of:
creating a landscape representation of the operations management in the environment;
characterizing said landscape representation;
determining at least one factor effecting said characterization of said landscape representation;
adjusting said at least one factor to facilitate an identification of at least one acceptable operations management solution over said landscape representation; and
identifying said at least one acceptable operations management solution.

167. A method for performing operations management as in claim 166 wherein said characterizations of said landscape representation comprise a first category wherein said landscape representations belonging to said first category do not contain any of said acceptable operations management solutions.

168. A method for performing operations management as in claim 167 wherein said characterizations of said landscape representation comprise a second category wherein said landscape representations belonging to said second category contain isolated areas of said acceptable operations management solutions.

169. A method for performing operations management as in claim 168 wherein said characterizations of said landscape representation comprise a third category wherein said landscape representations belonging to said second category contain connected webs of said acceptable operations management solutions.

170. A method for performing operations management as in claim 166 wherein said factors effecting said characterization of said landscape representation comprise at least one constraint.

171. A method for performing operations management as in claim 170 wherein said at least one constraint comprises a maximum allowable makespan.

172. A method for performing operations management as in claim 170 wherein said adjusting said at least one factor to facilitate an identification of at least one acceptable operations management solution step comprises the step of easing said at least one constraint.

173. A method for performing operations management as in claim 171 wherein said adjusting said at least one factor to facilitate an identification of at least one acceptable operations management solution step comprises the step of increasing said maximum allowable makespan.

174. A method for performing operations management as in claim 171 wherein said characterizing said landscape representation step comprises the steps of:
(a) selecting an initial point on said landscape representation;
(b) initializing a sampling distance;
(c) sampling said landscape representation at a plurality of points at said sampling distance from said initial point;
(d) computing the percentage of said sampled points qualifying as said at least one acceptable operations management solution;
(e) incrementing said sampling distance;
(f) repeating steps (c)-(e) for a plurality of iterations to compute a corresponding plurality of said percentages of acceptable operations management solutions;
(g) selecting one of said plurality of iterations;
(h) computing the logarithm of the ratio of said percentage of acceptable operations management solutions at said selected iteration to said percentage of acceptable operations management solutions at said iteration preceding said selected iteration;
(i) repeating said steps (g)-(h) for each of said plurality of iterations to compute a corresponding plurality of said ratios;
(j) repeating steps (a)-(i) for a plurality of said initial points to compute said plurality of said ratios for each of said initial points; and
(k) characterizing said landscape representation according to said ratios of said acceptable operations management solutions.

175. Computer executable software code stored on a computer readable medium, the code for performing operations management in an environment of entities and resources, the code comprising:
code to create a landscape representation of the operations management in the environment;
code to characterize said landscape representation;
code to determine at least one factor effecting said characterization of said landscape representation;
code to adjust said at least one factor to facilitate an identification of at least one acceptable operations management solution over said landscape representation; and
code to identify said at least one acceptable operations management solution.

176. A programmed computer for performing operations management in an environment of entities and resources comprising at least one memory having at least one region storing computer executable program code and at least one processor for executing the program code stored in said memory, wherein the program code includes:
code to create a landscape representation of the operations management in the environment;
code to characterize said landscape representation;
code to determine at least one factor effecting said characterization of said landscape representation;
code to adjust said at least one factor to facilitate an identification of at least one acceptable operations management solution over said landscape representation; and
code to identify said at least one acceptable operations management solution.

177. A method for performing multi-objective optimization comprising the steps of:
creating an n dimensional energy function having a domain and a codomain to define a landscape representation wherein n is a natural number;
sampling said n dimensional energy function at a plurality of points x ε X from the domain to determine a corresponding plurality of sampled energy values from the codomain;
grouping said plurality of sampled energy values into c intervals Iᵢ, i=0 . . . c−1 wherein c is a natural number;
estimating at least one probability density functions P_{I}_{ₗ} corresponding to said c intervals Iₗ, i=0 . . . c−1 from said plurality of sampled energy values; and
searching for at least one low energy solution having a value from the codomain below a predetermined threshold by extrapolating from said estimated probability density functions P_{I}_{ₗ}.

178. A method for performing multi-objective optimization as in claim 177 wherein said sampling said n dimensional energy function step comprises the steps of:
noting a lowest sampled energy value e; and
noting a highest sampled energy value \overline{e}.

179. A method for performing multi-objective optimization as in claim 178 wherein each of said c intervals Iᵢ, i=0 . . . c−1 include a portion of said energy values falling within an energy interval definition:
e+iδ≦e<e+(i+1)δ
wherein
δ=(\overline{e}−e)/c.

180. A method for performing multi-objective optimization as in claim 177 wherein said c intervals, Iₗ, i=0 . . . c−1 overlap.

181. A method for performing multi-objective optimization as in claim 180 wherein said grouping said plurality of observed energy values step comprises the steps of:
identifying subsets of said c intervals Iᵢ, i=0 . . . c−1 having an overlap greater than a predetermined threshold; and
sliding said overlapping subsets to smooth the time series corresponding to said plurality of sampled energy values.

182. A method for performing multi-objective optimization as in claim 177 wherein said at least one estimated probability density function P_{I}_{ₗ} comprises at least one parameter θ.

183. A method for performing multi-objective optimization as in claim 182 wherein said estimating at least one probability density function P_{I}_{ₗ} step comprises the step of estimating said at least one parameter θ from said plurality of sampled energy values.

184. A method for performing multi-objective optimization as in claim 183 wherein said at least one parameter θ is estimated using a learning algorithm.

185. A method for performing multi-objective optimization as in claim 177 wherein said searching for at least one low energy solution step comprises the steps of:
(a) initializing a set of known probability density functions to said plurality of estimated probability density functions P_{I}_{ₗ};
(b) identifying at least one low energy interval I_{※} by extrapolating from said set of known probability density functions wherein said at least one low energy interval I_{※} contains at least one energy value which is lower than said plurality of sampled energy values;
(c) determining at least one low energy probability density function P_{I}_{_{※}} corresponding to said at least one low energy interval I_{※} by extrapolating from said set of known probability density functions;
(d) adding said at least one low energy probability density function P_{I}_{_{※}} to said set of known probability density functions; and
(e) repeating steps (b)-(d) until said at least one low energy interval I_{※} contains said at least one low energy solution.

186. A method for performing multi-objective optimization as in claim 185 wherein said at least one low energy probability density function P_{I}_{_{※}} comprises said at least one parameter θ.

187. A method for performing multi-objective optimization as in claim 186 wherein said determining at least one low energy probability density function P_{I}_{_{※}} step comprises the step of extrapolating said at least one parameter θ from said known probability density functions.

188. Computer executable software code stored on a computer readable medium, the code for performing multi-objective optimization, the code comprising:
code to create an n dimensional energy function having a domain and a codomain to define a landscape representation wherein n is a natural number;
code to sample said n dimensional energy function at a plurality of points x ε X from the domain to determine a corresponding plurality of sampled energy values from the codomain;
code to group said plurality of sampled energy values into c intervals Iₗ, i=0 . . . c−1 wherein c is a natural number;
code to estimate at least one probability density functions P_{I}_{ₗ} corresponding to said c intervals Iᵢ, i=0 . . . c−1 from said plurality of sampled energy values; and
code to search for at least one low energy solution having a value from the codomain below a predetermined threshold by extrapolating from said estimated probability density functions P_{I}_{ₗ}.

189. A programmed computer for performing multi-objective optimization comprising at least one memory having at least one region storing computer executable program code and at least one processor for executing the program code stored in said memory, wherein the program code includes:
code to create an n dimensional energy function having a domain and a codomain to define a landscape representation wherein n is a natural number;
code to sample said n dimensional energy function at a plurality of points x ε X from the domain to determine a corresponding plurality of sampled energy values from the codomain;
code to group said plurality of sampled energy values into c intervals Iₗ, i=0 . . . c−1 wherein c is a natural number;
code to estimate at least one probability density functions P_{I}_{ₗ} corresponding to said c intervals Iᵢ, i=0 . . . c−1 from said plurality of sampled energy values; and
code to search for at least one low energy solution having a value from the codomain below a predetermined threshold by extrapolating from said estimated probability density functions P_{I}_{ₗ}.

190. A method for interacting with a computer to perform multi-objective optimization comprising the steps of:
executing an application which includes at least one design entry command to define a plurality of variables and a plurality of objectives and at least one design output command to produce and to display at least one solution;
issuing said at least one design entry command from the application to cause the application to display at least one design window including a plurality of design entry controls;
manipulating said design entry controls on said design window to define said plurality of variables and said plurality of objectives; and
issuing said at least one design output command from the application to cause the application to produce and to display said at least one solution.

191. A method for interacting with a computer to perform multi-objective optimization as in claim 190 further comprising the step of:
adjusting said design entry controls on said design entry window to form at least one modification to zero or more of said variables and to zero or more of said objectives.

192. A method for interacting with a computer to perform multi-objective optimization as in claim 191 further comprising the step of:
reissuing said at least one design output command to cause the application to produce and to display at least one effect of said at least one modification on said at least one solution.

193. A method for interacting with a computer to perform multi-objective optimization as in claim 190 wherein said manipulating said design entry controls step also defines zero or more constraints on at least one of said variables and on at least one of said objectives.

194. A method for interacting with a computer to perform multi-objective optimization as in claim 193 wherein said issuing said at least one design output command from the application step causes the application to display at least one design output window including a plurality of design output controls.

195. A method for interacting with a computer to perform multi-objective optimization as in claim 194 further comprising the step of:
manipulating said design output controls on said design output window to define at least one format for said at least one solution.

196. A method for interacting with a computer to perform multi-objective optimization as in claim 195 further comprising the step of:
issuing at least one display output command from the application to cause the application to display said at least one solution in said at least one format.

197. A method for interacting with a computer to perform multi-objective optimization as in claim 193 wherein said zero or more constraints comprises at least one allowable range on said at least one variable and on said at least one objective.

198. A method for interacting with a computer to perform multi-objective optimization as in claim 197 wherein said at least one displayed solution comprises:
at least one variable representation corresponding to said at least one variable;
at least one objective representation corresponding to said at least one objective; and
zero or more constraint representations corresponding to said zero or more constraints.

199. A method for interacting with a computer to perform multi-objective optimization as in claim 198 wherein said at least one variable representation and said at least one objective representation are bar representations.

200. A method for interacting with a computer to perform multi-objective optimization as in claim 199 wherein
said at least one objective representation is a first color or a second color when said at least one corresponding objective is satisfied or said at least one corresponding objective is not satisfied respectively.

201. A method for interacting with a computer to perform multi-objective optimization as in claim 200 wherein
said at least one constraint representation is a mark on said at least one objective representation.

202. A method for interacting with a computer to perform multi-objective optimization as in claim 197 wherein said manipulating said design entry controls step further comprises the step of:
selecting at least one of said plurality of objectives for optimization.

203. A method for interacting with a computer to perform multi-objective optimization as in claim 202 wherein said issuing said at least one design output command from the application step causes the application to optimize said at least one solution with respect to said selected objectives.

204. A method for interacting with a computer to perform multi-objective optimization as in claim 195 wherein said manipulating said design output controls on said design output window to define at least one format step comprises the steps of:
identifying at least one of said objectives to plot in at least one histogram; and
specifying at least one number of bins corresponding to said at least one histogram.

205. A method for interacting with a computer to perform multi-objective optimization as in claim 204 wherein said issuing said at least one design output command from the application step causes the application to display said at least one solution comprising said at least one histogram having said corresponding number of bins.

206. A method for interacting with a computer to perform multi-objective optimization as in claim 205 wherein said at least one solution is partitioned in said at least one histogram according to whether or not said at least one solution meets said at least one constraint.

207. A method for interacting with a computer to perform multi-objective optimization as in claim 195 wherein said manipulating said design output controls on said design output window to define at least one format step comprises the steps of:
identifying at least one of said objectives to use for pareto optimization; and
selecting two or more of said variables and objectives to plot on at least one scatterplot.

208. A method for interacting with a computer to perform multi-objective optimization as in claim 207 wherein said issuing said at least one design output command from the application step causes the application to perform pareto optimization with respect to said identified objectives.

209. A method for interacting with a computer to perform multi-objective optimization as in claim 208 wherein said issuing at least one design output command step causes the application to display said at least one scatterplot having at least one point corresponding to said at least one solution.

210. A method for interacting with a computer to perform multi-objective optimization as in claim 209 wherein said issuing said at least one design output command from the application step causes the application to identify zero or more of said solutions which are pareto optimal.

211. A method for interacting with a computer to perform multi-objective optimization as in claim 210 wherein
said manipulating said design output controls on said design output window to define at least one format step further comprises the step of:
specifying at least one allowable range for at least one of said variables and said objectives.

212. A method for interacting with a computer to perform multi-objective optimization as in claim 211 wherein said design output controls further comprise at least one slider labels for specifying said at least one allowable range for at least one of said variables and said objectives.

213. A method for interacting with a computer to perform multi-objective optimization as in claim 211 wherein said issuing at least one design output command from the application step causes the application to identify zero or more of said solutions on said at least one scatterplot which satisfy said at least one allowable range for at least one of said variables and said objectives.

214. A method for interacting with a computer to perform multi-objective optimization as in claim 213 wherein said manipulating said design output controls on said design output window to define at least one format step further comprises the step of:
adjusting said at least one allowable range for at least one of said variables and said objectives.

215. A method for interacting with a computer to perform multi-objective optimization as in claim 214 wherein said issuing at least one design output command from the application step causes the application to interactively display at least one effect of said adjusting said at least one allowable range for at least one of said variables and said objectives step on said at least one solution.

216. A method for interacting with a computer to perform multi-objective optimization as in claim 195 wherein said manipulating said design output controls on said design output window to define at least one format step comprises the steps of:
identifying at least one of said objectives to use for pareto optimization; and
selecting two or more of said variables and objectives to plot on at least one parallel coordinate plot.

217. A method for interacting with a computer to perform multi-objective optimization as in claim 216 wherein said issuing at least one design output command from the application step causes the application to display said at least one parallel coordinate plot having at least one line corresponding to said at least one solution.

218. A method for interacting with a computer to perform multi-objective optimization as in claim 217 wherein
said issuing at least one design output command from the application step causes the application to identify zero or more of said solutions which are pareto optimal.
